(19) United States
(12) Patent Application Publication
(10) Pub. No.: US 2022/0190319 A1
(43) Pub. Date: Jun. 16, 2022

(54) POSITIVE ELECTRODE ACTIVE MATERIAL AND SECONDARY BATTERY

(71) Applicant: SEMICONDUCTOR ENERGY LABORATORY CO., LTD., ATSUGI-SHI, KANAGAWA-KEN (JP)

(72) Inventors: Kazuhei NARITA, Ota, Tokyo (JP); Mayumi MIKAMI, Atsugi, Kanagawa (JP); Yohei MOMMA, Isehara, Kanagawa (JP); Teruaki OCHIAI, Atsugi, Kanagawa (JP); Jo SAITO, Atsugi, Kanagawa (JP)

(21) Appl. No.: 17/438,645

(22) PCT Filed: Mar. 19, 2020
(86) PCT No.: PCT/IB2020/052493

§ 371 Date: Sep. 13, 2021

(30) Foreign Application Priority Data
Mar. 29, 2019 (JP) 2019-066730
Oct. 4, 2019 (JP) 2019-183435

(51) Int. Cl. H01M 4/36; H01M 4/525; H01M 10/0525

(52) U.S. Cl. CPC H01M 4/364; H01M 2004/028; H01M 10/0525; H01M 4/525

(57) ABSTRACT

A positive electrode active material for a lithium-ion secondary battery and with high capacity and excellent charging and discharging cycle performance is provided. The positive electrode active material contains lithium, cobalt, nickel, aluminum, and oxygen, and the spin density attributed to one or more of a divalent nickel ion, a trivalent nickel ion, a divalent cobalt ion, and a tetravalent cobalt ion is within a predetermined range. It is preferable that the positive electrode active material further contain magnesium. An appropriate magnesium concentration is represented by a concentration with respect to cobalt. It is preferable that the positive electrode active material further contain fluorine.

### TECHNICAL FIELD

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a secondary battery, and an electronic device including a secondary battery.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

Electronic devices in this specification and the like mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, tablets, and laptop computers; portable music players; digital cameras; medical equipment; next-generation clean energy vehicles (hybrid electric vehicles (HEVs), electric vehicles (EVs), plug-in hybrid electric vehicles (PHEVs), and the like); and the like. The lithium-ion secondary batteries are essential as rechargeable energy supply sources for today's information society.

The performance required for lithium-ion secondary batteries includes much higher energy density, improved cycle performance, safety under a variety of operation environments, improved long-term reliability, and the like.

Thus, improvement of a positive electrode active material has been studied to improve the cycle performance and increase the capacity of lithium-ion secondary batteries (Patent Document 1 and Patent Document 2). In addition, a crystal structure of a positive electrode active material also has been studied (Non-Patent Document 1 to Non-Patent Document 3).

X-ray diffraction (XRD) is one of methods used for analysis of a crystal structure of a positive electrode active material. With the use of the ICSD (Inorganic Crystal Structure Database) described in Non-Patent Document 5, XRD data can be analyzed.

Patent Document 3 describes the Jahn-Teller effect in nickel-based layered oxide.

Patent Document 4 discloses a positive electrode active material with a small change in the crystal structure between a charged state and a discharged state.

Non-Patent Document 6 describes correction of van der Waals forces in calculation of lithium cobalt oxide.

### REFERENCE

### Patent Document

[Patent Document 1] Japanese Published Patent Application No. 2002-216760
[Patent Document 2] Japanese Published Patent Application No. 2006-261132
[Patent Document 3] Japanese Published Patent Application No. 2017-188466
[Patent Document 4] PCT International Publication No. 2018/211375

### Non-Patent Document

[Non-Patent Document 1] Toyoki Okumura et al, “Correlation of lithium ion distribution and X-ray absorption near-edge structure in O3- and O2-lithium cobalt oxides from first-principle calculation”, Journal of Materials Chemistry, 2012, 22, p. 17340-17348
[Non-Patent Document 2] Motohashi, T. et al, “Electronic phase diagram of the layered cobalt oxide system Li_{X}CoO₂ (0.0≤X≤1.0)”, Physical Review B, 80 (16); 165114
[Non-Patent Document 3] Zhaohui Chen et al, “Staging Phase Transitions in LixCoO₂”, Journal of The Electrochemical Society, 2002, 149 (12) A1604-A1609
[Non-Patent Document 4] W. E. Counts et al, Journal of the American Ceramic Society, (1953) 36 [1] 12-17. Fig. 01471
[Non-Patent Document 5] Belsky, A. et al., “New developments in the Inorganic Crystal Structure Database (ICSD): accessibility in support of materials research and design”, Acta Cryst., (2002) B58, 364-369.
[Non-Patent Document 6] Muratahan Aykol, et al., “van der Waals Interactions in Layered Lithium Cobalt Oxides”, the Journal of physical chemistry, 2015, 119, 19053-19058.

### SUMMARY OF THE INVENTION

### Problems to be Solved by the Invention

An object of one embodiment of the present invention is to provide a positive electrode active material for a lithium-ion secondary battery and with high capacity and excellent charging and discharging cycle performance, and a manufacturing method thereof. Another object is to provide a manufacturing method of a positive electrode active material with high productivity. Another object of one embodiment of the present invention is to provide a positive electrode active material that suppresses a decrease in capacity in charging and discharging cycles when used for a lithium-ion secondary battery. Another object of one embodiment of the present invention is to provide a high-capacity secondary battery. Another object of one embodiment of the present invention is to provide a secondary battery with excellent charge and discharge characteristics. Another object is to provide a positive electrode active material in which elution of a transition metal such as cobalt is inhibited even when a state being charged with high voltage is held for a longtime. Another object of one embodiment of the present invention is to provide a highly safe or reliable secondary battery.

Alternatively, an object of one embodiment of the present invention is to provide a novel material, novel active material particles, a novel power storage device, or a manufacturing method thereof.

Note that the description of these objects does not preclude the existence of other objects. Note that one embodiment of the present invention does not have to achieve all the objects. Note that other objects can be taken from the description of the specification, the drawings, and the claims.

### Means for Solving the Problems

One embodiment of the present invention is a positive electrode active material containing lithium, cobalt, nickel, aluminum, and oxygen. A spin density attributed to one or more of a divalent nickel ion, a trivalent nickel ion, a divalent cobalt ion, and a tetravalent cobalt ion is preferably greater than or equal to 2.0×10¹⁷ spins/g and less than or equal to 1.0×10²¹ spins/g.

In the above positive electrode active material, it is preferable that the concentration of nickel with respect to the number of cobalt atoms be greater than or equal to 0.01 atomic % and less than or equal to 10 atomic %.

In the above positive electrode active material, it is preferable that the concentration of aluminum with respect to the number of cobalt atoms be greater than or equal to 0.01 atomic % and less than or equal to 10 atomic %.

It is preferable that the above positive electrode active material further contain magnesium and the concentration of magnesium with respect to the number of cobalt atoms be greater than or equal to 0.1 atomic % and less than or equal to 6.0 atomic %.

It is preferable that the above positive electrode active material further contain fluorine.

In the above positive electrode active material, it is preferable that the lattice constant of an a-axis be greater than or equal to 2.8155×10⁻¹⁰ m and 2.8175×10⁻¹⁰ m and the lattice constant of a c-axis be greater than or equal to 14.045×10⁻¹⁰ m and less than or equal to 14.065×10⁻¹⁰ m.

One embodiment of the present invention is a secondary battery including a positive electrode containing the above positive electrode active material and a negative electrode.

### Effect of the Invention

According to one embodiment of the present invention, a positive electrode active material for a lithium-ion secondary battery and with high capacity and excellent charging and discharging cycle performance, and a manufacturing method thereof can be provided. Furthermore, a manufacturing method of a positive electrode active material with high productivity can be provided. Furthermore, a positive electrode active material that suppresses a decrease in capacity in charging and discharging cycles when used for a lithium-ion secondary battery can be provided. Furthermore, a high-capacity secondary battery can be provided. Furthermore, a secondary battery with excellent charge and discharge characteristics can be provided. Furthermore, a positive electrode active material in which elution of a transition metal such as cobalt is inhibited even when a state being charged with high voltage is held for a long time can be provided. Furthermore, a highly safe or reliable secondary battery can be provided. Furthermore, a novel material, novel active material particles, a novel power storage device, or a manufacturing method thereof can be provided.

### BRIEF DESCRIPTION OF THE DRAWINGS

FIG. 1A and FIG. 1B are schematic views illustrating structures of a positive electrode active material.

FIG. 2A and FIG. 2B are schematic views illustrating structures of a positive electrode active material.

FIG. 3A and FIG. 3B are schematic views illustrating structures of a positive electrode active material.

FIG. 4 is a diagram illustrating a charge depth and crystal structures of a positive electrode active material of one embodiment of the present invention.

FIG. 5 is a diagram illustrating a charge depth and crystal structures of a positive electrode active material as a comparative example.

FIG. 6 is a diagram showing XRD patterns calculated from crystal structures.

FIG. 7A is a diagram showing a crystal structure of a positive electrode active material. FIG. 7B is a diagram illustrating magnetism of a positive electrode active material.

FIG. 8 is a diagram illustrating magnetism of a positive electrode active material.

FIG. 9A is a diagram illustrating a crystal structure of a positive electrode active material as a comparative example. FIG. 9B is a diagram illustrating magnetism of a positive electrode active material as a comparative example.

FIG. 10A and FIG. 10B are diagrams showing crystal structures used for calculation.

FIG. 11A to FIG. 11D are diagrams showing crystal structures used for calculation.

FIG. 12 is a diagram illustrating an example of a manufacturing method.

FIG. 13 is a diagram illustrating an example of a manufacturing method.

FIG. 14 is a diagram illustrating an example of a manufacturing method.

FIG. 15A and FIG. 15B are cross-sectional views of an active material layer in the case of using a graphene compound as a conductive additive.

FIG. 16A and FIG. 16B are diagrams illustrating examples of a secondary battery.

FIG. 17A and FIG. 17B are diagrams illustrating an example of a secondary battery.

FIG. 18A, FIG. 18B, and FIG. 18C are diagrams illustrating an example of a secondary battery.

FIG. 19A and FIG. 19B are diagrams illustrating an example of a secondary battery.

FIG. 20A, FIG. 20B, and FIG. 20C are diagrams illustrating a coin-type secondary battery.

FIG. 21A, FIG. 21B, FIG. 21C, and FIG. 21D are diagrams illustrating a cylindrical secondary battery.

FIG. 22A and FIG. 22B are diagrams illustrating an example of a secondary battery.

FIG. 23A1, FIG. 23A2, FIG. 23B1, and FIG. 23B2 are diagrams illustrating examples of a secondary battery.

FIG. 24A and FIG. 24B are diagrams illustrating examples of a secondary battery.

FIG. 25 is a diagram illustrating an example of a secondary battery.

FIG. 26A, FIG. 26B, and FIG. 26C are diagrams illustrating a laminated secondary battery.

FIG. 27A and FIG. 27B are diagrams illustrating a laminated secondary battery.

FIG. 28 is an external view of a secondary battery.

FIG. 29 is an external view of a secondary battery.

FIG. 30A, FIG. 30B, and FIG. 30C are diagrams illustrating a manufacturing method of a secondary battery.

FIG. 31A, FIG. 31B1, FIG. 31B2, FIG. 31C, and FIG. 31D are diagrams illustrating a bendable secondary battery.

FIG. 32A and FIG. 32B are diagrams illustrating a bendable secondary battery.

FIG. 33A and FIG. 33B are diagrams illustrating a secondary battery and an example of its manufacturing method.

FIG. 34A, FIG. 34B, FIG. 34C, FIG. 34D, FIG. 34E, FIG. 34F, FIG. 34G, and FIG. 34H are diagrams illustrating examples of electronic devices.

FIG. 35A, FIG. 35B, and FIG. 35C are diagrams illustrating an example of an electronic device.

FIG. 36 is a diagram illustrating examples of electronic devices.

FIG. 37A, FIG. 37B, and FIG. 37C are diagrams illustrating examples of vehicles.

FIG. 38 is a diagram showing results of ESR analysis.

FIG. 39 is a diagram showing results of ESR analysis.

FIG. 40 is a diagram showing results of ESR analysis.

FIG. 41 is a diagram showing results of ESR analysis.

FIG. 42A and FIG. 42B are diagrams showing dependence of a spin density on a measurement temperature of ESR analysis.

FIG. 43A and FIG. 43B are diagrams showing spin densities.

FIG. 44A is a diagram showing dependence of a spin density on the addition amount of magnesium, and FIG. 44B is a diagram showing dependence of a spin density on the addition amount of nickel.

FIG. 45A and FIG. 45B are diagrams showing cycle performance.

FIG. 46A and FIG. 46B are diagrams showing cycle performance.

FIG. 47A and FIG. 47B are diagrams showing cycle performance.

FIG. 48A and FIG. 48B are diagrams showing cycle performance.

FIG. 49 is a diagram showing capacity retention rates.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, crystal planes and orientations are indicated by the Miller index. In the crystallography, a bar is placed over a number in the expression of crystal planes and orientations; however, in this specification and the like, crystal planes and orientations are in some cases expressed by placing a minus sign (−) at the front of a number instead of placing the bar over the number because of expression limitations in patent application. Furthermore, an individual direction which shows an orientation in a crystal is denoted by “[ ]”, a set direction which shows all of the equivalent orientations is denoted by “< >”, an individual plane which shows a crystal plane is denoted by “( )”, and a set plane having equivalent symmetry is denoted by “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like refers to a region from a surface to a depth of approximately 10 nm. A plane generated by a crack may also be referred to as a surface. In addition, a region in a deeper position than a surface portion of a particle is referred to as an inner portion of the particle.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, a pseudo-spinel crystal structure of a composite oxide containing lithium and a transition metal refers to the space group R-3m, which is not a spinel crystal structure but a crystal structure in which oxygen is hexacoordinated to an ion of cobalt, magnesium, or the like, and the cation arrangement has symmetry similar to that of the spinel crystal structure. Note that in the pseudo-spinel crystal structure, oxygen is tetracoordinated to a light element such as lithium in some cases. Also in that case, the ion arrangement has symmetry similar to that of the spinel crystal structure.

The pseudo-spinel crystal structure can also be regarded as a crystal structure that contains lithium between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure generally.

In this specification and the like, the charge depth obtained when all lithium that can be inserted and extracted is inserted is 0, and the charge depth obtained when all lithium that can be inserted and extracted and is contained in a positive electrode active material is extracted is 1.

Anions of a layered rock-salt crystal and anions of a rock-salt crystal have cubic closest packed structures (face-centered cubic lattice structures). Anions of a pseudo-spinel crystal are also presumed to have cubic closest packed structures. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the pseudo-spinel crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic closest packed structures composed of anions in the layered rock-salt crystal, the pseudo-spinel crystal, and the rock-salt crystal are aligned is referred to as a state where crystal orientations are substantially aligned in some cases.

Substantial alignment of the crystal orientations in two regions can be judged from a transmission electron microscopy (TEM) image, a scanning transmission electron microscopy (STEM) image, a high-angle annular dark-field scanning transmission electron microscopy (HAADF-STEM) image, an annular bright-field scanning transmission electron microscopy (ABF-STEM) image, or the like. X-ray diffraction (XRD), electron diffraction, neutron diffraction, and the like can also be used for judging. In the TEM image and the like, alignment of cations and anions can be observed as repetition of bright lines and dark lines. When the orientations of cubic closest packed structures in the layered rock-salt crystal and the rock-salt crystal are aligned, a state where an angle made by the repetition of bright lines and dark lines in the layered rock-salt crystal and the rock-salt crystal is less than or equal to 5°, further preferably less than or equal to 2.5° can be observed. Note that in the TEM image and the like, a light element typified by oxygen or fluorine cannot be clearly observed in some cases; however, in such a case, alignment of orientations can be judged by arrangement of metal elements.

In this specification and the like, theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, charge refers to transfer of lithium ions from a positive electrode to a negative electrode in a battery and transfer of electrons from a negative electrode to a positive electrode in an external circuit. For a positive electrode active material, extraction of lithium ions is called charge. Moreover, a positive electrode active material with a charge depth of greater than or equal to 0.74 and less than or equal to 0.9, more specifically, a charge depth of greater than or equal to 0.8 and less than or equal to 0.83 is referred to as a high-voltage charged positive electrode active material. Thus, for example, LiCoO₂ charged to 219.2 mAh/g is a high-voltage charged positive electrode active material. In addition, LiCoO₂ that is subjected to constant current charging in an environment at 25° C. and charging voltage of higher than or equal to 4.525 V and lower than or equal to 4.65 V (in the case of a lithium counter electrode), and then subjected to constant voltage charging until the current value becomes 0.01 C or approximately ⅕ to 1/100 of the current value at the time of the constant current charging is also referred to as a high-voltage charged positive electrode active material.

Similarly, discharge refers to transfer of lithium ions from a negative electrode to a positive electrode in a battery and transfer of electrons from a positive electrode to a negative electrode in an external circuit. Discharge of a positive electrode active material refers to insertion of lithium ions. Furthermore, a positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

### Embodiment 1

In this embodiment, a positive electrode active material of one embodiment of the present invention is described.

One embodiment of the present invention is a positive electrode active material containing lithium, cobalt, nickel, aluminum, and oxygen. In the positive electrode active material of one embodiment of the present invention, nickel and aluminum are preferably contained at a concentration that does not considerably change the crystallinity of lithium cobalt oxide (LiCoO₂). By containing nickel and aluminum, the positive electrode active material of one embodiment of the present invention has a more stable crystal structure in a high-voltage charged state, for example, in some cases.

It is preferable that the positive electrode active material of one embodiment of the present invention further contain magnesium. A crystal structure containing magnesium is stable, which can inhibit breakage of the crystal structure due to repeated charge and discharge.

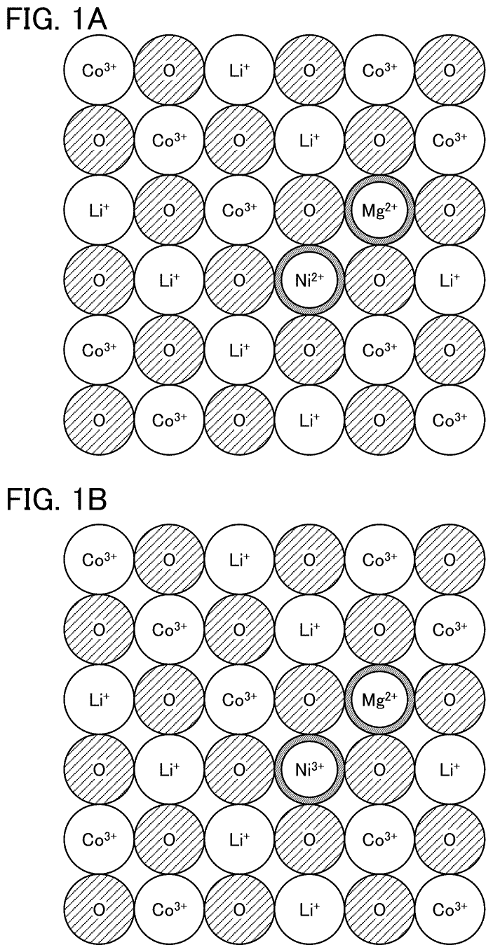

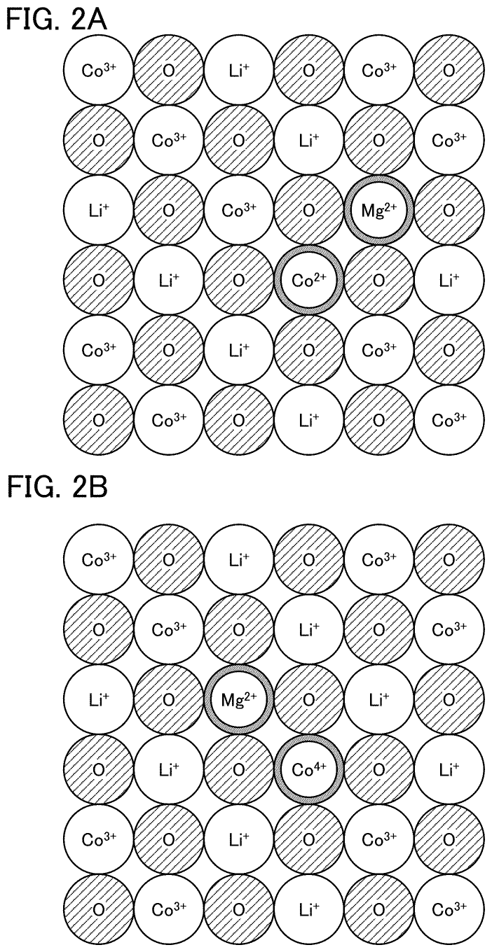

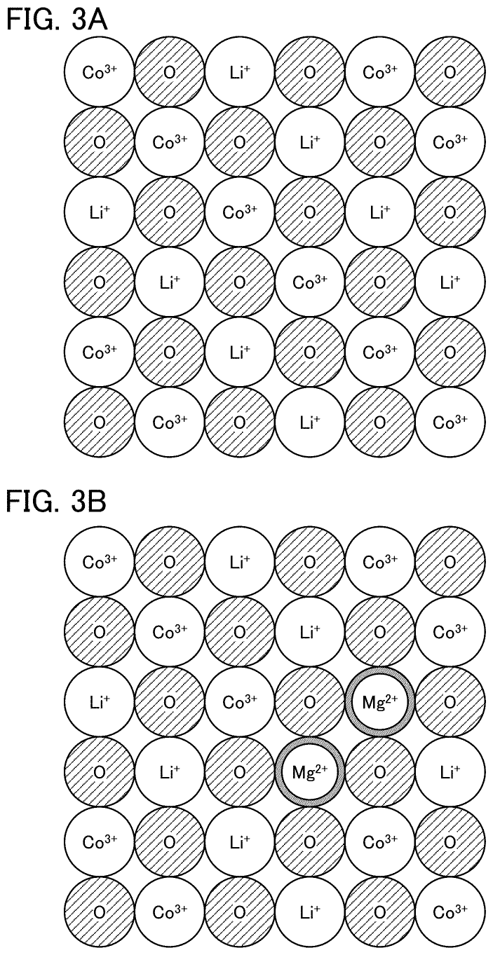

In the positive electrode active material of one embodiment of the present invention, Ni²⁺ is substituted for part of Co³⁺ and Mg²⁺ is substituted for part of Li⁺ in lithium cobalt oxide (LiCoO₂) (see FIG. 1A and FIG. 3A). Furthermore, accompanying the substitution of Mg²⁺ for Li⁺, the Ni²⁺ might be reduced to be Ni³⁺ (see FIG. 1B). In addition, in the positive electrode active material of one embodiment of the present invention, Mg²⁺ is substituted for part of Li⁺ in lithium cobalt oxide (LiCoO₂), and accordingly Co³⁺ in the vicinity of Mg²⁺ is reduced to be Co²⁺ (see FIG. 2A and FIG. 3A). In addition, Mg²⁺ is substituted for part of Co³⁺, and accordingly Co³⁺ in the vicinity of Mg²⁺ is oxidized to be Co⁴⁺ (see FIG. 2B and FIG. 3A).

Thus, the positive electrode active material of one embodiment of the present invention contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably greater than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺ (see FIG. 3B). The use of the positive electrode active material of one embodiment of the present invention for a secondary battery enables the secondary battery to have excellent cycle performance and rate characteristics.

The spin density of a positive electrode active material can be analyzed by electron spin resonance (ESR), for example. In addition, the average value of the nickel concentration, the average value of the aluminum concentration, and the average value of the magnesium concentration in the whole particle of the positive electrode active material can be analyzed by inductively coupled plasma mass spectrometry (ICP-MS), for example.

The concentration of nickel with respect to the number of cobalt atoms in the positive electrode active material is preferably greater than or equal to 0.01 atomic % and less than or equal to 10 atomic %, further preferably greater than or equal to 0.05 atomic % and less than or equal to 2 atomic %, still further preferably greater than or equal to 0.1 atomic % and less than or equal to 1 atomic %. Note that the nickel concentration described above may be a value obtained by element analysis on the whole particle of the positive electrode active material using ICP-MS or the like, or may be a value based on the ratio of the raw materials mixed in the process of forming the positive electrode active material, for example.

The concentration of aluminum with respect to the number of cobalt atoms in the positive electrode active material is preferably greater than or equal to 0.01 atomic % and less than or equal to 10 atomic %, further preferably greater than or equal to 0.05 atomic % and less than or equal to 2 atomic %, still further preferably greater than or equal to 0.1 atomic % and less than or equal to 0.5 atomic %. Note that the aluminum concentration described above may be a value obtained by element analysis on the whole particle of the positive electrode active material using ICP-MS or the like, or may be a value based on the ratio of the raw materials mixed in the process of forming the positive electrode active material, for example.

The concentration of magnesium with respect to the number of cobalt atoms in the positive electrode active material is preferably greater than or equal to 0.1 atomic % and less than or equal to 6.0 atomic %, further preferably greater than or equal to 0.5 atomic % and less than or equal to 5.0 atomic %, still further preferably greater than or equal to 1.0 atomic % and less than or equal to 4.0 atomic %. Note that the magnesium concentration described above may be a value obtained by element analysis on the whole particle of the positive electrode active material using ICP-MS or the like, or may be a value based on the ratio of the raw materials mixed in the process of forming the positive electrode active material, for example.

When the magnesium concentration is higher than a predetermined value, the effect of stabilizing a crystal structure becomes small in some cases. This is probably because magnesium enters the cobalt sites in addition to the lithium sites.

As the magnesium concentration in the positive electrode active material of one embodiment of the present invention increases, the capacity of the positive electrode active material decreases in some cases. As an example, one possible reason is that the amount of lithium that contributes to charge and discharge decreases when magnesium enters the lithium sites. Furthermore, excess magnesium sometimes generates a magnesium compound that does not contribute to charge and discharge. When the positive electrode active material of one embodiment of the present invention contains nickel in addition to magnesium, the capacity per weight and per volume can be increased in some cases. When the positive electrode active material of one embodiment of the present invention contains aluminum in addition to magnesium, the capacity per weight and per volume can be increased in some cases. When the positive electrode active material of one embodiment of the present invention contains nickel and aluminum in addition to magnesium, the capacity per weight and per volume can be increased in some cases.

It is preferable that the positive electrode active material of one embodiment of the present invention further contain fluorine. When fluorine is contained together with magnesium, magnesium can be easily distributed in the whole particle in a step of forming the positive electrode active material as described later. With fluorine, corrosion resistance to hydrofluoric acid generated by electrolyte decomposition can be improved.

The concentrations of the elements of the positive electrode active material can be measured by X-ray photoelectron spectroscopy (XPS), for example. The average magnesium concentration in the whole particle can be analyzed by inductively coupled plasma mass spectrometry (ICP-MS), for example.

### <Structure of Positive Electrode Active Material>

A material with a layered rock-salt crystal structure is known to have a high discharge capacity and excel as a positive electrode active material of a secondary battery. Examples of the material with a layered rock-salt crystal structure include lithium cobalt oxide (LiCoO₂), LiNiO₂, and LiMnO₂.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charge and discharge are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

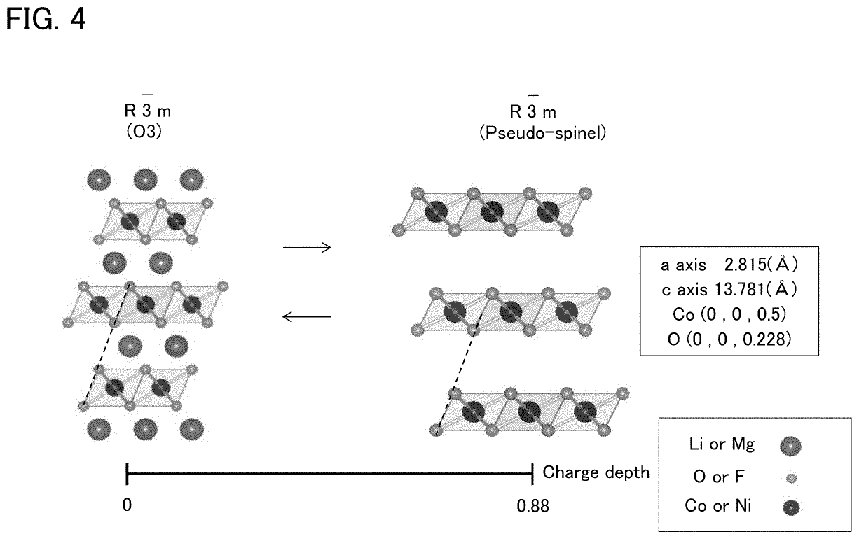

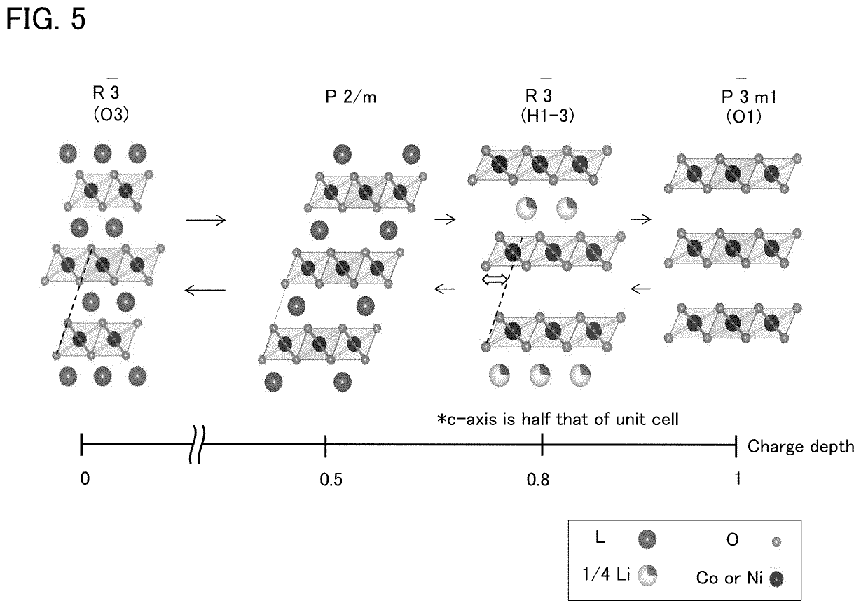

A positive electrode active material 100 of one embodiment of the present invention and a positive electrode active material as a comparative example are explained using FIG. 4 and FIG. 5, and differences between the materials are described. With FIG. 4 and FIG. 5, the case of using cobalt as a transition metal contained in the positive electrode active material is described. FIG. 4 shows the positive electrode active material 100 of one embodiment of the present invention. FIG. 5 shows the positive electrode active material as the comparative example. The positive electrode active material as the comparative example shown in FIG. 5 is simple lithium cobalt oxide (LiCoO₂) not subjected to processing such as adding an element other than lithium, cobalt, and oxygen to an inner portion of the positive electrode active material or coating a surface portion of a particle thereof with such an element.

In the positive electrode active material of one embodiment of the present invention, a deviation in the CoO₂ layers can be small in repeated high-voltage charge and discharge. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high-voltage charged state. Thus, in the positive electrode active material of one embodiment of the present invention, a short circuit is unlikely to occur while the high-voltage charged state is maintained, in some cases. Such a case is preferable because the safety is further improved.

### [Inner Portion of Particle]

The positive electrode active material 100 of one embodiment of the present invention has a small crystal-structure change and a small volume difference per the same number of transition metal atoms between a sufficiently discharged state and a high-voltage charged state (with a charge depth greater than or equal to 0.8 and less than or equal to 0.83).

FIG. 4 illustrates the crystal structures of the positive electrode active material 100 before and after being charged and discharged. The positive electrode active material 100 of one embodiment of the present invention is a composite oxide containing lithium and cobalt. Moreover, the positive electrode active material 100 preferably contains nickel and aluminum in addition to the above. Furthermore, in addition to the above, the positive electrode active material 100 preferably contains magnesium. Furthermore, the positive electrode active material 100 preferably contains halogen such as fluorine or chlorine in addition to the above.

The crystal structure with a charge depth of 0 (the discharged state) illustrated in FIG. 4 is R-3m (O3), which is the same as that in FIG. 5. In contrast, the positive electrode active material 100 of one embodiment of the present invention has a crystal with a structure different from that in FIG. 5 when it is sufficiently charged to a charge depth of approximately 0.88. This structure belongs to the space group R-3m, and is not a spinel crystal structure but a structure in which oxygen is hexacoordinated to an ion of cobalt, magnesium, or the like and the cation arrangement has symmetry similar to that of the spinel crystal structure. This structure is thus referred to as the pseudo-spinel crystal structure in this specification and the like. Note that although the indication of lithium is omitted in the diagram of the pseudo-spinel crystal structure illustrated in FIG. 4 to explain the symmetry of cobalt atoms and the symmetry of oxygen atoms, approximately 10 atomic % to 20 atomic % lithium with respect to cobalt practically exists between the CoO₂ layers. In addition, in both the O3-type crystal structure and the pseudo-spinel crystal structure, a slight amount of magnesium preferably exists between the CoO₂ layers, i.e., in lithium sites. In addition, a slight amount of halogen such as fluorine preferably exists in oxygen sites at random.

Note that in the pseudo-spinel crystal structure, oxygen is tetracoordinated to a light element such as lithium in some cases. In that case, the ion arrangement locally has symmetry similar to that of the spinel crystal structure. However, the pseudo-spinel crystal structure is a trigonal crystal (the space group R-3m) and is different from a spinel crystal structure which is a cubic crystal.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure generally.

The positive electrode active material 100 has a smaller crystal-structure change than LiCoO₂ as the comparative example when releasing a large amount of lithium in high-voltage charge. As indicated by the dotted lines in FIG. 4, for example, there is a very little deviation in the CoO₂ layers between the crystal structures.

In the positive electrode active material 100, a difference in the volume per unit cell between the O3-type crystal structure with a charge depth of 0 and the pseudo-spinel crystal structure with a charge depth of 0.88 is less than or equal to 2.5%, more specifically, less than or equal to 2.2%.

For example, in a region of charging voltages that make the positive electrode active material as the comparative example have the H1-3 type crystal structure, for example, at a voltage of approximately 4.6 V with reference to the potential of lithium metal, the R-3m (O3) crystal structure can be maintained. Moreover, in a higher charging voltage region, for example, at voltages of approximately 4.65 V to 4.7 V with reference to the potential of lithium metal, the pseudo-spinel crystal structure can be obtained. At a much higher charging voltage, the H1-3 type crystal is eventually observed in some cases. In the case where graphite, for instance, is used as a negative electrode active material in a secondary battery, the R-3m (O3) crystal structure can be maintained in a region of charging voltages of the secondary battery from 4.3 V to 4.5 V, for example. In a higher charging voltage region, for example, at voltages of 4.35 V to 4.55 V, the pseudo-spinel crystal structure can be obtained.

Thus, in the positive electrode active material 100, the crystal structure is unlikely to be broken even when charge and discharge are repeated at high voltage.

Note that in the unit cell of the pseudo-spinel crystal structure, coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers. Thus, when magnesium exists between the CoO₂ layers, the pseudo-spinel crystal structure is likely to be formed. In addition, magnesium is preferably distributed in the whole particle of the positive electrode active material 100. To distribute magnesium in the whole particle, heat treatment is preferably performed in a manufacturing process of the positive electrode active material 100.

However, cation mixing occurs when the heat treatment temperature is excessively high, so that magnesium is highly likely to enter the cobalt sites. Magnesium in the cobalt sites results in a small effect of maintaining the R-3m structure in some cases. Furthermore, an excessively high heat treatment temperature might cause adverse effects such as instability of a layered rock-salt structure and evaporation of lithium.

In view of the above, a halogen compound such as a fluorine compound is preferably added to lithium cobalt oxide before the heat treatment for distributing magnesium in the whole particle. The addition of the halogen compound decreases the melting point of lithium cobalt oxide. The decrease in the melting point makes it easier to distribute magnesium in the whole particle at a temperature at which the cation mixing is unlikely to occur. Here, hydrofluoric acid generated by electrolyte decomposition might corrode the positive electrode active material. The positive electrode active material 100 of one embodiment of the present invention containing fluorine can have increased corrosion resistance to hydrofluoric acid generated by electrolyte decomposition.

Note that in this specification and the like, an electrolyte means a substance having electric conductivity. The electrolyte is not limited to liquid and may be a gelled one or solid. An electrolyte in a liquid state is referred to as an electrolyte solution in some cases, and an electrolyte solution can be made by dissolving a solute in a solvent. An electrolyte in a solid state is referred to as a solid electrolyte in some cases.

Note that although the case where the positive electrode active material 100 is a composite oxide containing lithium, cobalt, and oxygen is described so far, nickel may be contained in addition to cobalt. When a high-voltage charged state is held for a long time, elution of the transition metal into the electrolyte solution from the positive electrode active material occurs, and the crystal structure might be broken. However, when the positive electrode active material 100 that is one embodiment of the present invention contains nickel at the above-described concentration, elution of the transition metal from the positive electrode active material 100 can be inhibited in some cases.

Since the positive electrode active material 100 of one embodiment of the present invention contains nickel, charging and discharging voltages decrease, and thus, charge and discharge can be executed at a lower voltage in the case of the same capacity; as a result, elution of the transition metal and decomposition of the electrolyte solution might be inhibited. Here, the charging and discharging voltages are, for example, voltages within the range from a charge depth of 0 to a predetermined charge depth.

### [Surface Portion of Particle]

Magnesium is preferably distributed in the whole particle of the positive electrode active material 100, and further preferably, the magnesium concentration in the surface portion of the particle is higher than the average in the whole particle. The magnesium concentration in the surface portion of the particle can be measured by X-ray photoelectron spectroscopy (XPS), for example. The average magnesium concentration in the whole particle can be measured by inductively coupled plasma mass spectrometry (ICP-MS) or glow discharge mass spectrometry (GDMS), for example. The entire surface of the particle is a kind of crystal defects and lithium is extracted from the surface of the particle during charge; thus, the lithium concentration in the surface of the particle tends to be lower than that in the inner portion of the particle. Therefore, the surface of the particle tends to be unstable and its crystal structure is likely to be broken. The higher the magnesium concentration in the surface portion of the particle is, the more effectively the crystal structure change can be inhibited. In addition, a high magnesium concentration in the surface portion of the particle expects to improve the corrosion resistance to hydrofluoric acid generated by the decomposition of the electrolyte solution.

In addition, the concentration of halogen such as fluorine in the surface portion of the particle of the positive electrode active material 100 is preferably higher than the average concentration of halogen such as fluorine in the particle. When halogen exists in the surface portion of the particle which is a region in contact with the electrolyte solution, the corrosion resistance to hydrofluoric acid can be effectively improved.

In this manner, the surface portion of the particle of the positive electrode active material 100 preferably has higher concentrations of magnesium and fluorine than those in the inner portion of the particle and a composition different from that in the inner portion of the particle. In addition, the surface portion of the particle preferably has a composition that enables the crystal structure to be stable at normal temperature. Thus, the surface portion of the particle may have a crystal structure different from that of the inner portion of the particle. For example, at least part of the surface portion of the particle of the positive electrode active material 100 may have a rock-salt crystal structure. Furthermore, in the case where the surface portion of the particle and the inner portion of the particle have different crystal structures, the orientations of crystals in the surface portion of the particle and the inner portion of the particle are preferably substantially aligned.

Note that in the surface portion of the particle where only MgO is contained or MgO and CoO(II) forma solid solution, it is difficult to insert and extract lithium. Thus, the surface portion of the particle should contain at least cobalt, and further contain lithium in the discharged state to have a path through which lithium is inserted and extracted. In addition, the concentration of cobalt is preferably higher than that of magnesium.

### [Crystal Grain Boundary]

A slight amount of magnesium or halogen contained in the positive electrode active material 100 may randomly exist in the inner portion of the particle, but part of the element is further preferably segregated at a crystal grain boundary.

In other words, the magnesium concentration in the crystal grain boundary and its vicinity of the positive electrode active material 100 is preferably higher than that in the other regions in the inner portion of the particle. In addition, the halogen concentration in the crystal grain boundary and its vicinity is also preferably higher than that in the other regions in the inner portion.

Like the particle surface, the crystal grain boundary is also a plane defect. Tus, the crystal grain boundary tends to be unstable and its crystal structure easily starts to change. Therefore, the higher the magnesium concentration in the crystal grain boundary and its vicinity is, the more effectively the change in the crystal structure can be inhibited.

Even when cracks are generated along the crystal grain boundary of the particle of the positive electrode active material 100, high concentrations of magnesium and halogen in the crystal grain boundary and its vicinity increase the concentrations of magnesium and halogen in the vicinity of a surface generated by the cracks. Thus, the positive electrode active material after the cracks are generated can also have increased corrosion resistance to hydrofluoric acid.

Note that in this specification and the like, the vicinity of the crystal grain boundary refers to a region of approximately 10 nm from the crystal grain boundary.

### [Particle Diameter]

Too large a particle diameter of the particle of the positive electrode active material 100 causes problems such as difficulty in lithium diffusion and too much surface roughness of an active material layer in coating to a current collector. In contrast, too small a particle diameter of the particle causes problems such as difficulty in loading of the active material layer in coating to the current collector and overreaction with an electrolyte solution. Therefore, the average particle diameter (D50) is preferably greater than or equal to 1 pm and less than or equal to 100 pm, further preferably greater than or equal to 2 pm and less than or equal to 40 pm, still further preferably greater than or equal to 5 pm and less than or equal to 30 sm.

Note that the average particle diameter (D50) in this specification and the like means a particle diameter when the cumulative percentage reaches 50% on the volumetric basis. The average particle diameter (D50) is referred to as a median diameter in some cases.

### [Analysis Method]

Whether or not a positive electrode active material is the positive electrode active material 100 of one embodiment of the present invention that has the pseudo-spinel crystal structure when charged with high voltage can be determined by analyzing a high-voltage charged positive electrode using XRD, electron diffraction, neutron diffraction, electron spin resonance (ESR), nuclear magnetic resonance (NMR), magnetization measurement, or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described so far, the positive electrode active material 100 of one embodiment of the present invention has a feature of a small crystal structure change between the high-voltage charged state and the discharged state. A material where 50 wt % or more of the crystal structure largely changes between the high-voltage charged state and the discharged state is not preferable because the material cannot withstand the high-voltage charge and discharge. In addition, it should be noted that an objective crystal structure is not obtained in some cases only by addition of impurity elements. For example, although the positive electrode active material that is lithium cobalt oxide containing magnesium and fluorine is a commonality, the positive electrode active material has 60 wt % or more the pseudo-spinel crystal structure in some cases, and has 50 wt % or more the H1-3 type crystal structure in other cases, when charged with high voltage. Furthermore, at a predetermined voltage, the pseudo-spinel crystal structure accounts for almost 100 wt %, and with an increase in the predetermined voltage, the H1-3 type crystal structure is generated in some cases. Thus, analysis of the crystal structure, including XRD, is needed to determine whether or not the positive electrode active material is the positive electrode active material 100 of one embodiment of the present invention.

Note that a positive electrode active material in the high-voltage charged state or the discharged state sometimes causes a change in the crystal structure when exposed to the air. For example, the pseudo-spinel crystal structure changes into the H1-3 type crystal structure in some cases. Thus, all samples are preferably handled in an inert atmosphere such as an argon atmosphere.

### [XRD]

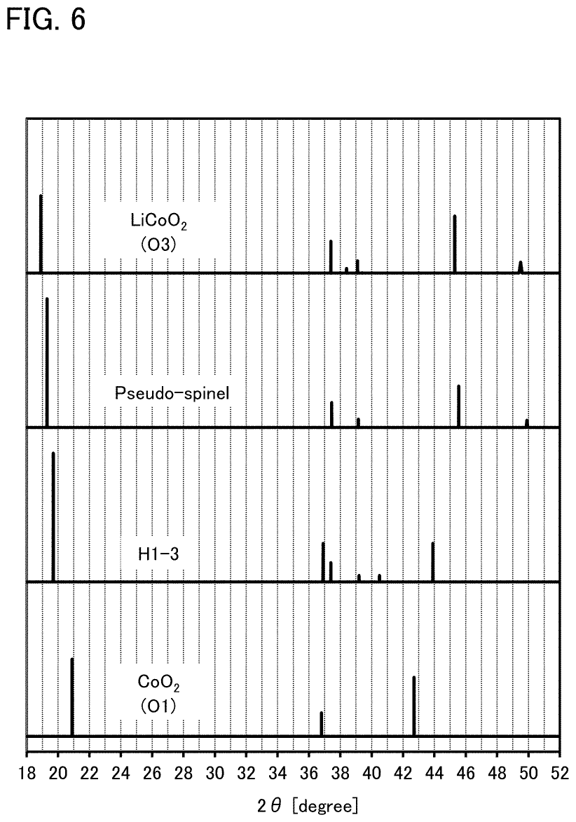

FIG. 6 shows ideal powder XRD patterns with CuKα1 rays that are calculated from models of a pseudo-spinel crystal structure and an H1-3 type crystal structure. In addition, for comparison, FIG. 6 also shows ideal XRD patterns calculated from the crystal structures of LiCoO₂ (O3) with a charge depth of 0 and CoO₂ (O1) with a charge depth of 1. Note that the patterns of LiCoO₂ (O3) and CoO₂ (O1) were made from crystal structure data obtained from ICSD (Inorganic Crystal Structure Database) (see Non-Patent Document 5) using Reflex Powder Diffraction, which is a module of Materials Studio (BIOVIA). The range of 26 was from 15° to 75°, Step size was 0.01, the wavelength λ1 was 1.540562×10⁻¹⁰ m, λ2 was not set, and Monochromator was a single monochromator. The pattern of the H1-3 type crystal structure was made from the crystal structure data described in Non-Patent Document 3 in a similar manner. The pattern of the pseudo-spinel crystal structure was estimated from the XRD pattern of the positive electrode active material of one embodiment of the present invention, the crystal structure was fitted with TOPAS ver. 3 (crystal structure analysis software manufactured by Bruker Corporation), and XRD patterns were made in a manner similar to those of other structures.

As shown in FIG. 6, in the pseudo-spinel crystal structure, diffraction peaks appear at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.100 (greater than or equal to 19.20° and less than or equal to 19.40°) and 2θ of 45.55±0.05° (greater than or equal to 45.50° and less than or equal to 45.60°). However, in the H1-3 type crystal structure and CoO₂ (P-3m1, O1), peaks at these positions do not appear. Thus, the peaks at 2θ of 19.2810.60° and 2θ of 45.55±0.20° in the high-voltage charged state can be the features of the positive electrode active material 100 of one embodiment of the present invention.

It can also be said that the positions where the XRD diffraction peaks appear are close in the crystal structure with a charge depth of 0 and the crystal structure in the high-voltage charged state. More specifically, a difference in the positions of two or more, further preferably three or more of the main diffraction peaks between both of the crystal structures is 2θ of less than or equal to 0.7, further preferably 26 of less than or equal to 0.5.

Note that although the positive electrode active material 100 of one embodiment of the present invention has the pseudo-spinel crystal structure when being charged with high voltage, not all the particles necessarily have the pseudo-spinel crystal structure. The particles may have another crystal structure, or some of the particles may be amorphous. Note that when the XRD patterns are analyzed by the Rietveld analysis, the pseudo-spinel crystal structure preferably accounts for more than or equal to 50 wt %, further preferably more than or equal to 60 wt %, still further preferably more than or equal to 66 wt %. The positive electrode active material in which the pseudo-spinel crystal structure accounts for more than or equal to 50 wt %, further preferably more than or equal to 60 wt %, still further preferably more than or equal to 66 wt % can have sufficiently good cycle performance.

Even after 100 or more cycles of charge and discharge, the pseudo-spinel crystal structure preferably accounts for more than or equal to 35 wt %, further preferably more than or equal to 40 wt %, still further preferably more than or equal to 43 wt % when the Rietveld analysis is performed.

The crystallite size of the pseudo-spinel structure included in the positive electrode active material particle does not decrease to less than approximately one-tenth that of LiCoO₂ (O3) in the discharged state. Thus, a clear peak of the pseudo-spinel crystal structure can be observed after the high-voltage charge even under the same XRD measurement conditions as those of a positive electrode before the charge and discharge. In contrast, simple LiCoO₂ has a small crystallite size and a broad small peak even when it can have a structure part of which is similar to the pseudo-spinel crystal structure. The crystallite size can be calculated from the half width of the XRD peak.

The layered rock-salt crystal structure included in the positive electrode active material particle in the discharged state, which can be estimated from the XRD patterns, preferably has a small lattice constant of the c-axis. The lattice constant of the c-axis increases when a foreign element is substituted at the lithium site or cobalt enters an oxygen-tetracoordinated site (A site), for example. For this reason, the positive electrode active material with excellent cycle performance probably can be manufactured by forming a composite oxide having a layered rock-salt crystal structure with few defects such as foreign element substitutions and C₃O₄ having the spinel crystal structure and then mixing a magnesium source and a fluorine source with the composite oxide and inserting magnesium into the lithium site.

In the crystal structure of the positive electrode active material in a discharged state, it is preferable that the lattice constant of the a-axis be greater than or equal to 2.8155×10⁻¹⁰ m and 2.8175×10⁻¹⁰ m, and the lattice constant of the c-axis be greater than or equal to 14.045×10⁻¹⁰ m and less than or equal to 14.065×10⁻¹⁰ m.

In order to set the lattice constant of the c-axis within the above range, the amount of impurities is preferably as small as possible. In particular, the amount of a transition metal other than cobalt, manganese, and nickel is preferably as small as possible. Specifically, the concentration of a transition metal other than cobalt, manganese, and nickel is preferably less than or equal to 3000 ppm (weight), further preferably less than or equal to 1500 ppm (weight). In addition, cation mixing between lithium and cobalt, manganese, and nickel is preferably unlikely to occur.

Note that features that are apparent from the XRD pattern are features of the inner structure of the positive electrode active material. In a positive electrode active material with an average particle diameter (D50) of approximately 1 μm to 100 pm, the volume of a surface portion of a particle is negligible compared with that of an inner portion; therefore, even when the surface portion of the particle of the positive electrode active material 100 has a crystal structure different from that of the inner portion of the particle, the crystal structure of the surface portion of the particle is highly unlikely to appear in the XRD pattern.

### [ESR]

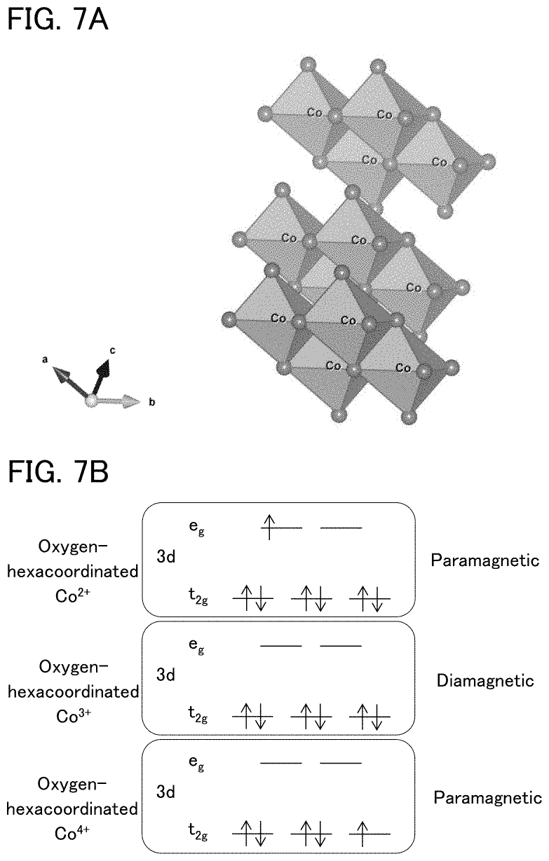

Here, the case in which the difference between the pseudo-spinel crystal structure and another crystal structure is determined using ESR is described using FIG. 7 to FIG. 9. Specifically, the difference between the positive electrode active material of one embodiment of the present invention that can have the pseudo-spinel crystal structure after 4.6-V charge with reference to the potential of lithium metal and a positive electrode active material as a comparative example that does not have the pseudo-spinel structure is described.

In the pseudo-spinel crystal structure, cobalt exists in the oxygen-hexacoordinated site, as illustrated in FIG. 4 and FIG. 7A. In oxygen-hexacoordinated cobalt, a 3d orbital is split into an e_{g} orbital and a t_{2g} orbital as shown in FIG. 7B. In the oxygen-hexacoordinated cobalt, the t_{2g} orbital that is an orbital located aside from the direction in which oxygen exists has low energy compared with the e_{g} orbital that is an orbital in the direction in which oxygen exists, and the t_{2g} orbital is in the ground state. Part of cobalt existing in the oxygen-hexacoordinated site is Co³⁺, and Co³⁺ in the ground state is diamagnetic Co³⁺ in which the entire t_{2g} orbital is filled (the spin quantum number S=0). However, the other part of cobalt existing in the oxygen-hexacoordinated site may be Co²⁺or Co⁴⁺, and Co²⁺ or Co⁴⁺ in the ground state is paramagnetic (the spin quantum number S=1/2). Co²⁺ and Co⁴⁺ of the paramagnetic cobalt both have one unpaired electron (the spin quantum number S=1/2), and thus cannot be distinguished by ESR

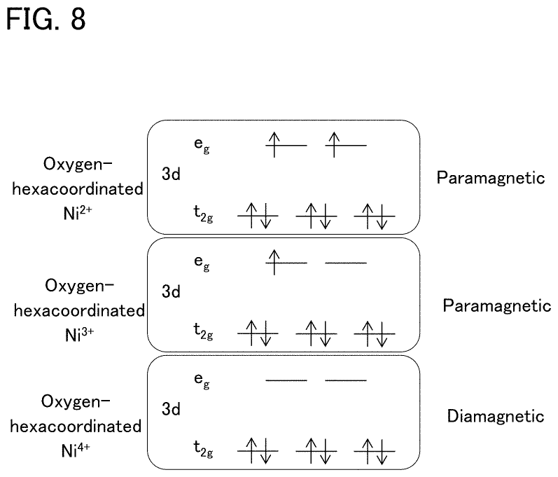

The positive electrode active material of one embodiment of the present invention can have the pseudo-spinel crystal structure after 4.6-V charge with reference to the potential of lithium metal and contains nickel. In such a positive electrode active material, nickel substituted for cobalt exists in the oxygen-hexacoordinated site. As illustrated in FIG. 8, part of nickel existing in the oxygen-hexacoordinated site is Ni²⁺, and Ni²⁺ in the ground state is paramagnetic (the spin quantum number S=1). Furthermore, another part of nickel existing in the oxygen-hexacoordinated site may be Ni³⁺, and Ni³⁺ in the ground state is paramagnetic (the spin quantum number S=1/2). Furthermore, another part of nickel existing in the oxygen-hexacoordinated site may be Ni⁴⁺, and Ni⁴⁺ in the ground state is diamagnetic (the spin quantum number S=0).

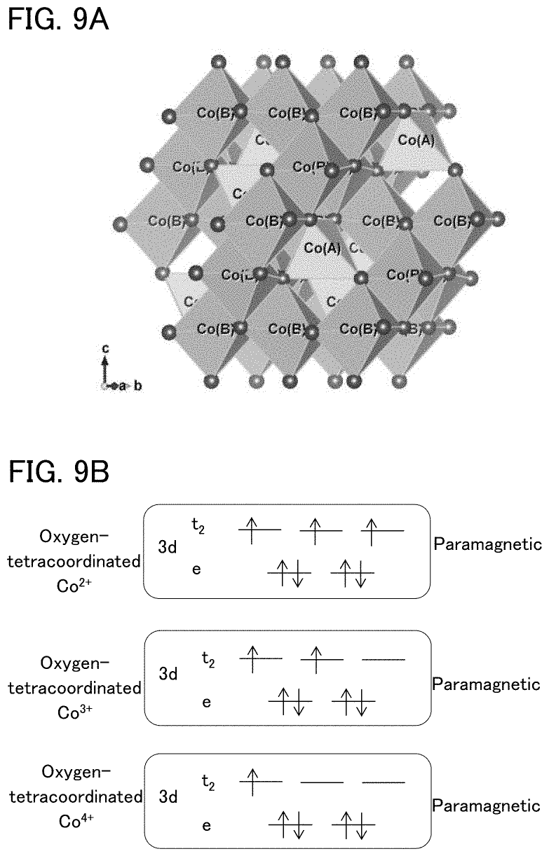

In contrast, a positive electrode active material as a comparative example is reported to be able to have a spinel crystal structure that does not contain lithium in the surface portion of the particle in a charged state. In that case, the positive electrode active material contains Co₃O₄ having a spinel crystal structure illustrated in FIG. 9A.

When the spinel is represented by a general formula A[B₂]O₄, the element A is oxygen-tetracoordinated and the element B is oxygen-hexacoordinated. Thus, in this specification and the like, the oxygen-tetracoordinated site is referred to as an A site, and the oxygen-hexacoordinated site is referred to as a B site in some cases.

In Co₃O₄ having the spinel crystal structure, cobalt exists not only in the oxygen-hexacoordinated B site but also in the oxygen-tetracoordinated A site. As shown in FIG. 9B, of the e orbital and the t₂ orbital split from the 3d orbital of the oxygen-tetracoordinated cobalt, the e orbital has lower energy, and the e orbital is in the ground state. Thus, oxygen-tetracoordinated Co²⁺, Co³⁺, and Co⁴⁺ each include an unpaired electron in the ground state and thus are paramagnetic. Accordingly, when the particles that contain a sufficient amount of Co₃O₄ having the spinel crystal structure are analyzed by ESR or the like, signals attributed to paramagnetic oxygen-tetracoordinated Co²⁺ (the spin quantum number S=3/2), Co³⁺ (the spin quantum number S=1), or Co⁴⁺ (the spin quantum number S=1/2) should be observed.

However, in the positive electrode active material 100 of one embodiment of the present invention, signals attributed to oxygen-tetracoordinated paramagnetic cobalt are too small to observe. Thus, unlike the normal spinel crystal structure, the pseudo-spinel crystal structure in this specification and the like does not contain a sufficient amount of oxygen-tetracoordinated cobalt to be detected by ESR Therefore, signals that are attributed to Co₃O₄ having the spinel crystal structure and can be detected by ESR or the like in the positive electrode active material 100 of one embodiment of the present invention are small or too few to be observed as compared to those in the positive electrode active material as the comparative example, in some cases. Co₃O₄ having the spinel crystal structure does not contribute to the charge and discharge reactions; thus, the amount of Co₃O₄ having the spinel crystal structure is preferably as small as possible. It can be determined also from the ESR analysis that the positive electrode active material 100 is different from the positive electrode active material as the comparative example.

The positive electrode active material of one embodiment of the present invention contains one or more of Ni²⁺, Ni³⁺, Co²⁺, and Co⁴⁺. In addition, in the positive electrode active material of one embodiment of the present invention, the spin density attributed to one or more of Ni²⁺, Ni³⁺, Co²⁺, and Co⁴⁺, which is observed through ESR analysis, is preferably greater than or equal to 2.0×10¹⁷ spins/g and less than or equal to 1.0×10²¹ spins/g, further preferably greater than or equal to 4.0×10¹⁷ spins/g and less than or equal to 5.0×10²⁰ spins/g, still further preferably greater than or equal to 6.0×10¹⁷ spins/g and less than or equal to 1.0×10²⁰ spins/g, yet still further preferably greater than or equal to 1.0×10¹⁸ spins/g and less than or equal to 5.0×10¹⁹ spins/g. The spin density of the positive electrode active material can be evaluated by ESR analysis, for example. In addition, the ESR signal attributed to one or more of Ni²⁺, Ni³⁺, Co²⁺, and Co⁴⁺ is observed at a g-factor of around 2.15. The above spin density represents a value obtained from ESR analysis at room temperature (300 K), and is the number of spins per weight of the positive electrode active material. The above spin density can be calculated by dividing the number of spins obtained from ESR analysis by the weight of a sample used for the ESR analysis.

In the positive electrode active material of one embodiment of the present invention, the spin density attributed to one or more of Ni²⁺, Ni³⁺, Co²⁺, and Co⁴⁺ is preferably greater than or equal to 3.5×10⁻⁵ spins/Co atom and less than or equal to 1.6×10⁻¹ spins/Co atom, further preferably greater than or equal to 6.8×10⁻⁵ spins/Co atom and less than or equal to 8.2×10⁻² spins/Co atom, still further preferably greater than or equal to 1.0×10⁻⁴ spins/Co atom and less than or equal to 1.6×10⁻² spins/Co atom, yet still further preferably greater than or equal to 1.7×10⁻⁴ spins/Co atom and less than or equal to 8.2×10⁻³ spins/Co atom. The above spin density represents a value obtained from ESR analysis at room temperature (300 K), and is the number of spins per cobalt atom of the positive electrode active material. The above spin density can be calculated by dividing the number of spins obtained from ESR analysis by the number of cobalt atoms in the positive electrode active material used for the ESR analysis. The number of cobalt atoms in the positive electrode active material in the case of, for example, lithium cobalt oxide with a composition of LiCoO₂ can be calculated from the molecular weight of 97.87 and the weight of the positive electrode active material used for the ESR analysis.

The positive electrode active material having the above spin density has a stable crystal structure, which can inhibit breakage of the crystal structure due to repeated charge and discharge. In addition, the use of the positive electrode active material of one embodiment of the present invention for a secondary battery enables the secondary battery to have excellent cycle performance and rate characteristics. Furthermore, the positive electrode active material having the above spin density sometimes has the pseudo-spinel crystal structure in a charged state.

### [XPS]

A region from the surface to a depth of approximately 2 nm to 8 nm (normally, approximately 5 nm) can be analyzed by X-ray photoelectron spectroscopy (XPS); thus, the concentration of each element in approximately half of the surface portion of the particle can be quantitatively analyzed. In addition, the bonding states of the elements can be analyzed by narrow scanning analysis. Note that the quantitative accuracy of XPS is approximately ±1 atomic % in many cases, and the detection lower limit depends on the element but is approximately 1 atomic %.

When the positive electrode active material 100 is analyzed by XPS and the cobalt concentration is set to 1, the relative value of the magnesium concentration is preferably greater than or equal to 0.4 and less than or equal to 1.5, further preferably greater than or equal to 0.45 and less than 1.00. Furthermore, the relative value of the concentration of halogen such as fluorine is preferably greater than or equal to 0.05 and less than or equal to 1.5, further preferably greater than or equal to 0.3 and less than or equal to 1.00.

When the positive electrode active material 100 is analyzed by XPS, a peak indicating the bonding energy of fluorine with another element is preferably higher than or equal to 682 eV and lower than 685 eV, further preferably approximately 684.3 eV. This value is different from both of the bonding energy of lithium fluoride, which is 685 eV, and the bonding energy of magnesium fluoride, which is 686 eV. That is, when the positive electrode active material 100 contains fluorine, bonding other than bonding of lithium fluoride and magnesium fluoride is preferable.

Furthermore, when the positive electrode active material 100 is analyzed by XPS, a peak indicating the bonding energy of magnesium with another element is preferably higher than or equal to 1302 eV and lower than 1304 eV, further preferably approximately 1303 eV. This value is different from the bonding energy of magnesium fluoride, which is 1305 eV, and is close to the bonding energy of magnesium oxide. That is, when the positive electrode active material 100 contains magnesium, bonding other than bonding of magnesium fluoride is preferable.

### [EDX]

The concentrations of the elements in the inner portion of the particle, in the surface portion of the particle, and in the vicinity of a crystal grain boundary can be evaluated using energy dispersive X-ray spectroscopy (EDX), for example. In the EDX measurement, to measure a region while scanning the region and evaluate the region two-dimensionally is referred to as EDX planar analysis in some cases. In addition, to extract data of a linear region from EDX planar analysis and evaluate the atomic concentration distribution in a positive electrode active material particle is referred to as linear analysis in some cases.

The concentrations of magnesium and fluorine in the inner portion of the particle, the surface portion of the particle, and the vicinity of the crystal grain boundary can be quantitatively analyzed by the EDX planar analysis (e.g., element mapping). In addition, peaks of the concentrations of magnesium and fluorine can be analyzed by the EDX linear analysis.

When the positive electrode active material 100 is analyzed by the EDX linear analysis, a peak of the magnesium concentration in the surface portion of the particle preferably exists in a region from the surface of the positive electrode active material 100 to a depth of 3 nm toward the center, further preferably to a depth of 1 nm, still further preferably to a depth of 0.5 nm.

A distribution of fluorine in the positive electrode active material 100 preferably overlaps with a distribution of magnesium. Thus, when the EDX linear analysis is performed, a peak of the fluorine concentration in the surface portion of the particle preferably exists in a region from the surface of the positive electrode active material 100 to a depth of 3 nm toward the center, further preferably to a depth of 1 nm, still further preferably to a depth of 0.5 nm.

When the linear analysis or the planar analysis is performed on the positive electrode active material 100, the ratio of the number of magnesium atoms to the number of cobalt atoms (Mg/Co) in the vicinity of the crystal grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

[dQ/dV Vs V Curve]

When the positive electrode active material of one embodiment of the present invention is discharged at a low rate of, for example, 0.2 C or less after high-voltage charge, a characteristic change in voltage appears just before the end of discharge, in some cases. This change can be clearly observed by the fact that at least one peak appears within the range of 3.5 V to 3.9 V in a dQ/dV vs V curve calculated from a discharge curve.

### [Charging Method]

Whether or not a composite oxide is the positive electrode active material 100 of one embodiment of the present invention can be determined by, for example, fabricating a coin cell (CR2032 type with a diameter of 20 mm and a height of 3.2 mm) with a lithium counter electrode and performing high-voltage charge on the coin cell.

More specifically, a positive electrode current collector made of aluminum foil that is coated with slurry in which a positive electrode active material, a conductive additive, and a binder are mixed can be used as a positive electrode.

A lithium metal can be used for the counter electrode. Note that when a material other than the lithium metal is used for the counter electrode, the potential of a secondary battery differs from the potential of the positive electrode. Unless otherwise specified, voltages and potentials in this specification and the like refer to the potentials of a positive electrode.

As an electrolyte contained in an electrolyte solution, 1 mol/L lithium hexafluorophosphate (LiPF₆) can be used, and as an electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

A positive electrode can and a negative electrode can that are formed using stainless steel (SUS) can be used as a positive electrode can and a negative electrode can.

The coin cell formed under the above conditions is charged with constant current at 4.6 V and 0.5 C and then charged with constant voltage until the current value reaches 0.01 C. Note that here, 1 C is set to 137 mA/g. The temperature is set to 25° C. After the charge is performed in this manner, the coin cell is disassembled in a glove box with an argon atmosphere and the positive electrode is taken out, whereby the high-voltage charged positive electrode active material can be obtained. In order to inhibit reaction with components in the external world, the positive electrode active material is preferably hermetically sealed in an argon atmosphere when performing various analyses later. For example, XRD can be performed on the positive electrode active material enclosed in an airtight container with an argon atmosphere.

### <Positive Electrode Active Material as Comparative Example>

As described in Non-Patent Document 1, Non-Patent Document 2, and the like, the crystal structure of lithium cobalt oxide LiCoO₂, which is one of the positive electrode active materials as comparative examples, changes depending on the charge depth. FIG. 5 illustrates typical crystal structures of lithium cobalt oxide.

As illustrated in FIG. 5, lithium cobalt oxide with a charge depth of 0 (the discharged state) includes a region having the crystal structure of the space group R-3m, and includes three CoO₂ layers in a unit cell. Thus, this crystal structure is referred to as an O3-type crystal structure in some cases. Note that the CoO₂ layer has a structure in which octahedral geometry with oxygen atoms hexacoordinated to cobalt continues on a plane in the edge-sharing state.

When the charge depth is 1, lithium cobalt oxide has the crystal structure of the space group P-3m1, and one CoO₂ layer exists in a unit cell. Thus, this crystal structure is referred to as an O1-type crystal structure in some cases.

Lithium cobalt oxide when the charge depth is approximately 0.88 has the crystal structure of the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 5, the c-axis of the H1-3 type crystal structure is described half that of the unit cell for easy comparison with the other structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that 01 and 02 are each an oxygen atom. In this manner, the H1-3 type crystal structure is represented by a unit cell including one cobalt and two oxygen. Meanwhile, the pseudo-spinel crystal structure of one embodiment of the present invention is preferably represented by a unit cell including one cobalt and one oxygen, as described later. This means that the symmetry of cobalt and oxygen differs between the pseudo-spinel structure and the H1-3 type structure, and the amount of change from the O3 structure is smaller in the pseudo-spinel structure than in the H1-3 type structure. A preferred unit cell for representing a crystal structure of a positive electrode active material is selected such that the value of GOF (Goodness of Fitness) is smaller in the Rietveld analysis of XRD, for example.

When high-voltage charge with a charge depth of approximately 0.88 or more and discharge are repeated, the crystal structure of lithium cobalt oxide repeatedly changes between the H1-3 type crystal structure and the R-3m (O3) structure in the discharged state (i.e., an unbalanced phase change).

However, there is a large deviation in the position of the CoO₂ layer between these two crystal structures. As indicated by a dotted line and a two-headed arrow in FIG. 5, the CoO₂ layer in the H1-3 type crystal structure largely deviates from that in R-3m(O3). Such a dynamic structure change might adversely affect the stability of the crystal structure.

Furthermore, there is a big difference in volume between the H1-3 type crystal structure and the O3-type crystal structure. The difference in volume per the same number of cobalt atoms between the H1-3 type crystal structure and the O3-type crystal structure in the discharged state is 3.5% or more.

In addition, a structure in which CoO₂ layers are arranged in a successive manner, such as P-3m1 (O1), included in the H1-3 type crystal structure is highly likely to be unstable.

Thus, the repeated high-voltage charge and discharge break the crystal structure of lithium cobalt oxide. The breakage of the crystal structure degrades the cycle performance. This is probably because the breakage of the crystal structure reduces sites where lithium can stably exist and makes it difficult to insert and extract lithium.

### <First-Principles Calculation>

Next, stability of a crystal structure in the case where a different element is substituted for part of lithium cobalt oxide is estimated by calculation.

As shown in FIG. 5, the lithium cobalt oxide as the comparative example has an O1 structure belonging to the space group P-3m1 when having a charge depth close to 1. However, a dynamic structure change might adversely affect the stability of the crystal structure. It is thus preferable that lithium cobalt oxide have the pseudo-spinel structure belonging to the space group R-3m even when having a charge depth close to 1.

Thus, various kinds of elements are placed in some lithium sites and some cobalt sites of lithium cobalt oxide, and calculation is performed to find out which element should be placed to stabilize the pseudo-spinel structure belonging to the space group R-3m.

The following two kinds of calculation models are prepared, each of which includes a layer formed by a shared plane of CoO₂ octahedra and does not include lithium. Each of the calculation models can be regarded as a model in the case where the charge depth is 1.

(1) A model belonging to the space group R-3m, which is also referred to as a pseudo-spinel structure.
(2) A model belonging to the space group P-3m1, which is also referred to as an O1 structure.

Other calculation conditions are listed in Table 1. The U potential is set to U=2 according to Non-Patent Document 6.

TABLE 1

| | |
|---|---|
| Software | VASP |
| Functional | GGA |
| Pseudopotential | PAW (PBE.52) |
| Calculation method | GGA + U method |
| | (Bond strength between transition metal and O is |
| | corrected with U potential) |
| | U = 2 |
| | optB88 method (van der Waals forces are corrected) |
| Crystal structure | Pseudo-spinel structure or O1 structure |
| The number of atoms | Co: 12, O: 24, doping element: 1 |
| | or |
| | Co: 11, Ni: 1, O: 24, doping element: 1 |
| Target of calculation | Lattice and atom position are optimized |

### [Place Various Kinds of Elements in Li Site]

First, a stabilization energy difference between the case where no element is placed in one lithium site and the case where a doping element 110 is placed in one lithium site is calculated. The doping element is lithium, magnesium, cobalt, nickel, or manganese.

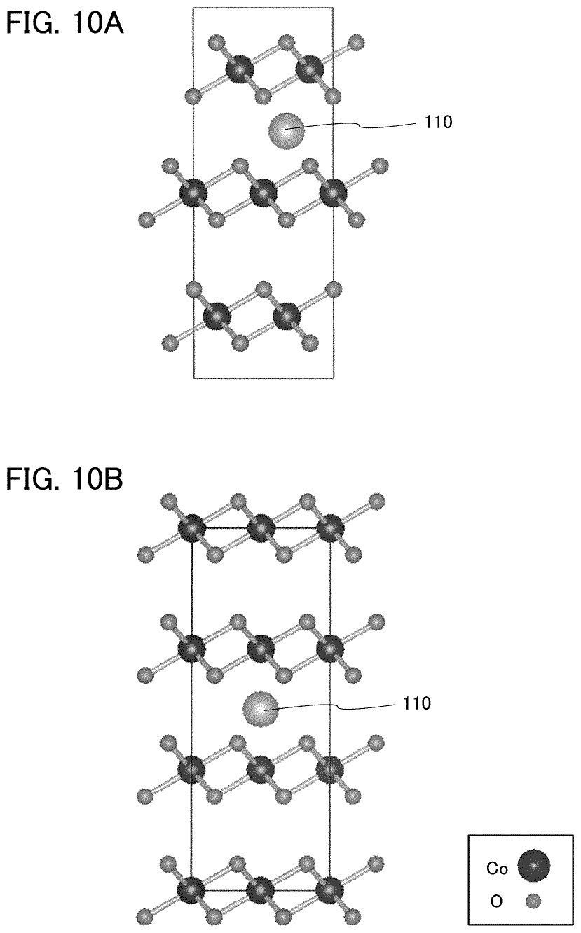

In FIG. 10A, the doping element 110 is placed in a lithium site of the pseudo-spinel structure belonging to the space group R-3m. In FIG. 10B, the doping element 110 is placed in a lithium site of the O1 structure belonging to the space group P-3m1.

A stabilization energy difference ΔE is as shown in Formula (1) below.

[Formula 1]

ΔE=E_{P-3m1}−E_{R-3m} (1)

Table 2 lists the results of calculating the stabilization energy difference ΔE under the above conditions.

TABLE 2

| | E (eV) | | ΔE |
|---|---|---|---|
| Li site | P-3m1 (O1) | R-3 m (O3) | (meV/atom) |
| — | −129.695 | −129.646 | −1.359 |
| Li | −134.963 | −135.048 | 2.295 |
| Mg | −135.059 | −135.335 | 7.472 |
| Co | −134.355 | −133.868 | −13.161 |
| Ni | −132.232 | −131.964 | −7.222 |
| Mn | −139.101 | −138.621 | −12.975 |

ΔE for lithium and magnesium is a positive value. It is thus shown that the presence of any of these in a lithium site stabilizes the pseudo-spinel structure belonging to the space group R-3m. In particular, magnesium existing in a lithium site significantly contributes to stabilization.

### [Place Ni in Co Site and Various Kinds of Elements in Li Site]

Next, a stabilization energy difference in the case where cobalt in one cobalt site is replaced with nickel 111 and the doping element 110 which is the same as the above is placed in a lithium site in the proximity thereto is calculated.

There are two kinds of positional relationships between nickel, the doping element, and oxygen in the proximity to these, where interaction differs. Thus, calculation is performed for two kinds of models, which are a model in the case where the angle formed by nickel, oxygen, and the doping element is 90° (Arrangement 1) and a model in the case where the angle formed by nickel, oxygen, and the doping element is 180° (Arrangement 2), and a more stable one (one with lower energy) is adopted.

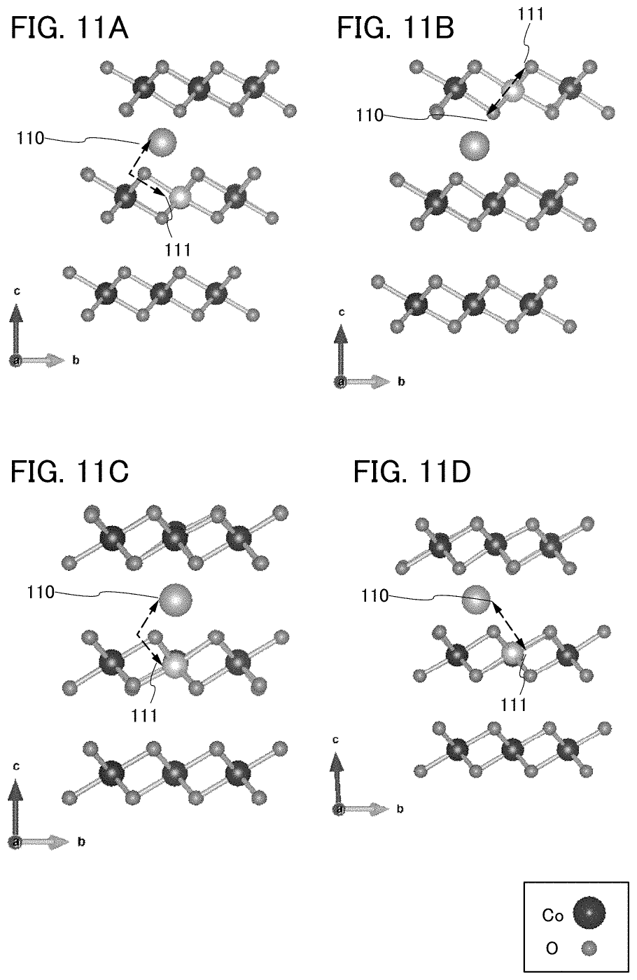

In FIG. 11A and FIG. 11B, the nickel 111 is placed in a cobalt site of the pseudo-spinel structure belonging to the space group R-3m, and the doping element 110 is placed in a lithium site thereof. FIG. 11A shows Arrangement 1 in which the angle formed by nickel, oxygen, and the doping element is 90° as denoted by the dotted arrow in the diagram. FIG. 11B shows Arrangement 2 in which the angle formed by nickel, oxygen, and the doping element is 180°.

In FIG. 11C and FIG. 11D, the nickel 111 is placed in a cobalt site of the O1 structure belonging to the space group P-3m1, and the doping element 110 is placed in a lithium site thereof. FIG. 11C shows Arrangement 1 in which the angle formed by nickel, oxygen, and the doping element is 90°. FIG. 11D shows Arrangement 2 in which the angle formed by nickel, oxygen, and the doping element is 180°.

The stabilization energy difference ΔE is as shown in Formula (2) below.

[Formula 2]

ΔE=E_{P-3m1(Lower)}−E_{R-3m(Lower)} (2)

Table 3 lists the results of calculating the stabilization energy difference ΔE under the above conditions.

TABLE 3

| | | E (eV) | | ΔE |
|---|---|---|---|---|
| Li site | | P-3m1 | R-3 m | (meV/atom) |
| | — | −127.878 | −127.943 | 1.786 |
| Li | Arrangement 1 | −133.116 | −133.345 | 3.981 |
| | Arrangement 2 | −133.213 | −133.360 | |
| Mg | Arrangement 1 | −133.387 | −133.704 | 8.574 |
| | Arrangement 2 | −133.198 | −133.356 | |
| Co | Arrangement 1 | −132.742 | −131.969 | −12.065 |
| | Arrangement 2 | −131.997 | −132.296 | |
| Ni | Arrangement 1 | −130.849 | −130.909 | 1.603 |
| | Arrangement 2 | −130.699 | −130.646 | |
| Mn | Arrangement 1 | −137.269 | −137.100 | −4.567 |
| | Arrangement 2 | −136.846 | −136.772 | |

As shown in Table 3, when there is no doping element and when the doping element is lithium, magnesium, or nickel, ΔE has a positive value. ΔE in the case where nickel is substituted in a cobalt site, which is listed in Table 3, is large as a whole as compared to ΔE in the case where nothing is substituted in a cobalt site, which is listed in Table 2. That is, a positive electrode active material in which some cobalt sites have nickel easily maintains the pseudo-spinel structure belonging to R-3m.

In particular, substitution of nickel in a cobalt site and the presence of magnesium in a lithium site in the proximity thereto significantly contribute to stabilization of the pseudo-spinel structure belonging to the space group R-3m.

As described above, a positive electrode active material containing nickel and magnesium as well as lithium, cobalt, and oxygen like the positive electrode active material 100 of one embodiment of the present invention easily maintains the crystal structure of R-3m. Therefore, the crystal structure is not easily broken even when being subjected to repeated high-voltage charge and discharge which would make the positive electrode active material as the comparative example have the crystal structure of P-3m1. Thus, a secondary battery having excellent cycle performance and rate characteristics can be provided.

This embodiment can be used in appropriate combination with any of the other embodiments.

### Embodiment 2

An example of a method for forming the positive electrode active material of one embodiment of the present invention is described.

### <Formation Method 1>

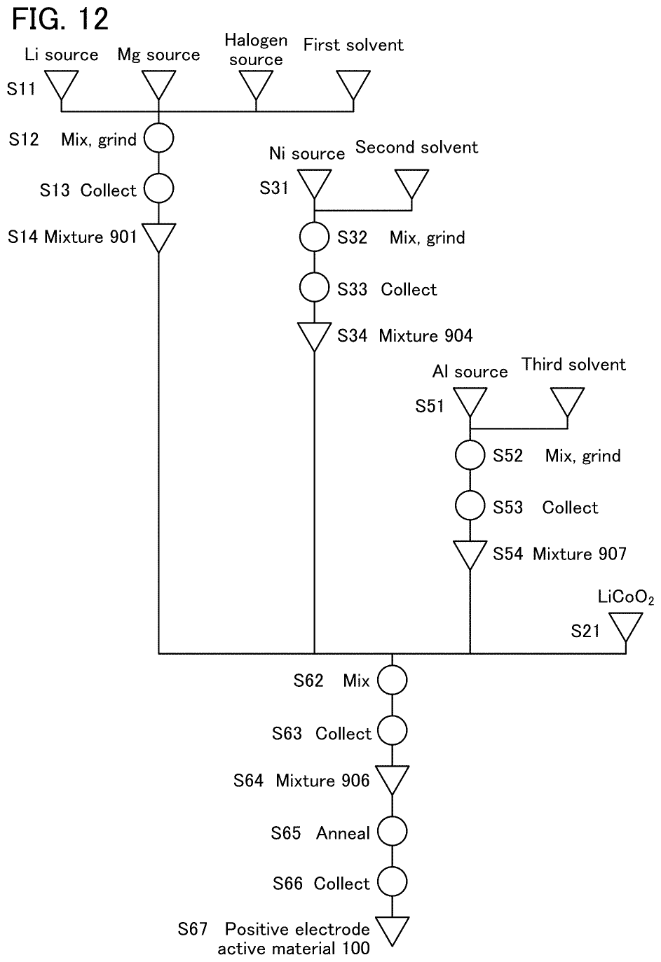

An example of a formation method of a positive electrode active material of one embodiment of the present invention is described with reference to FIG. 12.

### [Step S11]

First, as materials for a mixture 901, a lithium source, a magnesium source, and a halogen source are prepared (Step S11 in FIG. 12). Note that in FIG. 12, the lithium source is denoted by “Li source” and the magnesium source is denoted by “Mg source”. In addition, in the case where the following mixing and grinding steps are performed by a wet process, a first solvent is prepared.

As the lithium source, a material containing lithium can be used. As the lithium source, for example, lithium fluoride or lithium carbonate can be used.

As the magnesium source, a material containing magnesium can be used. As the magnesium source, for example, magnesium fluoride, magnesium oxide, magnesium hydroxide, or magnesium carbonate can be used.

As the halogen source, a material containing halogen such as fluorine or chlorine can be used. The halogen source may also serve as the lithium source, and a material containing lithium and halogen can be used as the lithium source and the halogen source. As the lithium source and the halogen source, for example, lithium fluoride, lithium chloride, or the like can be used. Lithium fluoride can be suitably used as the lithium source and the halogen source because it has a relatively low melting point of 848° C. and thus is easily melted in an annealing step described later. The halogen source may also serve as the magnesium source, and a material containing magnesium and halogen can be used as the magnesium source and the halogen source. As the magnesium source and the halogen source, for example, magnesium fluoride, magnesium chloride, or the like can be used.

As the first solvent, a ketone such as acetone; an alcohol such as ethanol or isopropanol; an ether; dioxane; acetonitrile; N-methyl-2-pyrrolidone (NMP); or the like can be used. An aprotic solvent that does not easily react with lithium is preferably used, and acetone can be suitably used, for example.

The case where lithium fluoride (LiF) is used as the lithium source and the halogen source and magnesium fluoride (MgF₂) is used as the magnesium source and the halogen source is specifically described as an example.

When lithium fluoride and magnesium fluoride are mixed at approximately LiF: MgF₂=65:35 (molar ratio), the effect of reducing the melting point becomes the highest (Non-Patent Document 4). On the other hand, when the amount of lithium fluoride increases, cycle performance might deteriorate because of an excessive amount of lithium. Therefore, the molar ratio of lithium fluoride LiF to magnesium fluoride MgF₂ is preferably LiF: MgF₂=x:1 (0≤x≤1.9), further preferably LiF: MgF₂=x:1 (0.1≤x≤0.5), still further preferably LiF: MgF₂=x:1 (x=the neighborhood of 0.33). In the case where the following mixing and grinding steps are performed by a wet process, acetone can be suitably used.

### [Step S12]

Next, the materials prepared in Step S11 are mixed and ground (Step S12 in FIG. 12). Although the mixing can be performed by a dry process or a wet process, the wet process is preferable because it can grind materials to a smaller size. For the mixing, a ball mill, a bead mill, or the like can be used. In the case where the ball mill is used, a zirconia ball is preferably used as media, for example. The mixing and grinding steps are preferably performed sufficiently to pulverize the materials. As a mixing means, mixing by a blender, a mixer, or a ball mill can be suitably employed.

### [Step S13 and Step S14]

Next, the materials mixed and ground in Step S12 are collected (Step S13 in FIG. 12), whereby the mixture 901 is obtained (Step S14 in FIG. 12).

For example, the mixture 901 preferably has a D50 of greater than or equal to 600 nm and less than or equal to 20 pm, further preferably greater than or equal to 1 pm and less than or equal to 10 pm. When mixed with a composite oxide containing lithium and a transition metal in a later step, the mixture 901 thus pulverized is easily attached to surfaces of composite oxide particles uniformly. The mixture 901 is preferably attached to the surfaces of the composite oxide particles uniformly, in which case halogen and magnesium are easily distributed to the surface portion of the composite oxide particles thoroughly after heating. When there is a region containing neither halogen nor magnesium in the surface portion, the above-described pseudo-spinel crystal structure might be unlikely to be obtained in a charged state.

### [Step S31]

As a material for a mixture 904, a nickel source is prepared (Step S31 in FIG. 12). Note that in FIG. 12, the nickel source is denoted by “Ni source”. In addition, in the case where the following mixing and grinding steps are performed by a wet process, a second solvent is prepared.

As the nickel source, a material containing nickel can be used. As the nickel source, for example, nickel hydroxide, nickel oxide, nickel acetate, nickel nitrate, nickel carbonate, or nickel sulfate can be used.

As the second solvent, a ketone such as acetone; an alcohol such as ethanol or isopropanol; an ether; dioxane; acetonitrile; N-methyl-2-pyrrolidone (NMP); or the like can be used. An aprotic solvent that does not easily react with lithium is preferably used, and acetone can be suitably used, for example.

### [Step S32]

Next, the materials prepared in Step S31 are mixed and ground (Step S32 in FIG. 12). Although the mixing can be performed by a dry process or a wet process, the wet process is preferable because it can grind materials to a smaller size. For the mixing, a ball mill, a bead mill, or the like can be used. In the case where the ball mill is used, a zirconia ball is preferably used as media, for example. The mixing and grinding steps are preferably performed sufficiently to pulverize the materials. As a mixing means, mixing by a blender, a mixer, or a ball mill can be suitably employed.

### [Step S33 and Step S34]

Next, the materials mixed and ground in Step S32 are collected (Step S33 in FIG. 12), whereby the mixture 904 is obtained (Step S34 in FIG. 12).

### [Step S51]

As a material for a mixture 907, an aluminum source is prepared (Step S51 in FIG. 12). Note that in FIG. 12, the aluminum source is denoted by “Al source”. In addition, in the case where the following mixing and grinding steps are performed by a wet process, a third solvent is prepared.

As the aluminum source, a material containing aluminum can be used. As the aluminum source, for example, aluminum hydroxide, aluminum oxide, aluminum isopropoxide, aluminum carbonate, aluminum nitrate, aluminum acetate, or aluminum sulfate can be used.

As the third solvent, a ketone such as acetone; an alcohol such as ethanol or isopropanol; an ether; dioxane; acetonitrile; N-methyl-2-pyrrolidone (NMP); or the like can be used. An aprotic solvent that does not easily react with lithium is preferably used, and acetone can be suitably used, for example.

### [Step S52]

Next, the materials prepared in Step S51 are mixed and ground (Step S52 in FIG. 12). Although the mixing can be performed by a dry process or a wet process, the wet process is preferable because it can grind materials to a smaller size. For the mixing, a ball mill, a bead mill, or the like can be used. In the case where the ball mill is used, a zirconia ball is preferably used as media, for example. The mixing and grinding steps are preferably performed sufficiently to pulverize the materials. As a mixing means, mixing by a blender, a mixer, or a ball mill can be suitably employed.

### [Step S53 and Step S54]

Next, the materials mixed and ground in Step S52 are collected (Step S53 in FIG. 12), whereby the mixture 907 is obtained (Step S54 in FIG. 12).

### [Step S21]

A composite oxide containing lithium and a transition metal is prepared (Step S21 in FIG. 12). As the composite oxide containing lithium and the transition metal, for example, lithium cobalt oxide (LiCoO₂) can be used.

In Step S21, a composite oxide containing lithium and a transition metal that is synthesized in advance may be used. In that case, it is preferable to use a composite oxide containing lithium and a transition metal with few impurities. In this specification and the like, lithium, cobalt, nickel, manganese, aluminum, and oxygen are the main components of the composite oxide containing lithium and the transition metal and the positive electrode active material, and elements other than the main components are regarded as impurities. For example, when analyzed by glow discharge mass spectrometry, the total impurity concentration is preferably less than or equal to 10,000 ppm (weight), further preferably less than or equal to 5000 ppm (weight). In particular, the total impurity concentration of metals such as titanium and arsenic is preferably less than or equal to 3000 ppm (weight), further preferably less than or equal to 1500 ppm (weight).

For example, as lithium cobalt oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the average particle diameter (D50) is approximately 12 pm, and in the impurity analysis by glow discharge mass spectrometry (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

The composite oxide containing lithium and the transition metal in Step S21 preferably has a layered rock-salt crystal structure with few defects and distortions. Therefore, the composite oxide is preferably a composite oxide with few impurities. In the case where the composite oxide containing lithium and the transition metal includes a lot of impurities, the crystal structure is highly likely to have a lot of defects or distortions.

### [Step S62]

Next, the mixture 901 obtained in Step S14, the mixture 904 obtained in Step S34, the mixture 907 obtained in Step S54, and the composite oxide containing lithium and the transition metal that has been prepared in Step S21 are mixed (Step S62 in FIG. 12). The ratio of the number TM of the transition metal atoms in the composite oxide containing lithium and the transition metal to the number Mg_{Mix1} of magnesium atoms contained in the mixture 901 is preferably TM: Mg_{Mix1}=1:y (0.005≤y≤0.05), further preferably TM: Mg_{Mix1}=1:y (0.007≤y≤0.04), still further preferably approximately TM: Mg_{Mix1}=1:0.02.

The condition of the mixing in Step S62 is preferably milder than that of the mixing in Step S12 not to damage the particles of the composite oxide. For example, a condition with a lower rotation frequency or shorter time than the mixing in Step S12 is preferable. In addition, it can be said that the dry process has a milder condition than the wet process. For the mixing, a ball mill, a bead mill, or the like can be used. In the case where the ball mill is used, a zirconia ball is preferably used as media, for example.

### [Step S63 and Step S64]

Next, the materials mixed in Step S62 are collected (Step S63 in FIG. 12), whereby the mixture 906 is obtained (Step S64 in FIG. 12).

### [Step S65]

Then, the mixture 906 is heated (Step S65 in FIG. 12). This step is referred to as annealing or baking in some cases.

The annealing is preferably performed at an appropriate temperature for an appropriate time. The appropriate temperature and time vary depending on the conditions such as the particle size and the composition of the composite oxide containing lithium and the transition metal that has been prepared in Step S21. In the case where the particle size is small, the annealing is preferably performed at a lower temperature or for a shorter time than the case where the particle size is large, in some cases.

In the case where the average particle diameter (D50) of the particles of the composite oxide containing lithium and the transition metal that has been prepared in Step S21 is approximately 12 pm, for example, the annealing temperature is preferably higher than or equal to 700° C. and lower than or equal to 950° C., for example. The annealing time is preferably longer than or equal to 3 hours, further preferably longer than or equal to 10 hours, still further preferably longer than or equal to 60 hours, for example.

The temperature decreasing time after the annealing is, for example, preferably longer than or equal to 10 hours and shorter than or equal to 50 hours.

It is considered that when the mixture 906 is annealed, a material having a low melting point (e.g., lithium fluoride, which has a melting point of 848° C.) in the mixture 906 is melted first and distributed to the surface portion of the composite oxide particle. Next, the existence of the melted material decreases the melting points of other materials, presumably resulting in melting of the other materials. For example, magnesium fluoride (melting point: 1263° C.) is presumably melted and distributed to the surface portion of the composite oxide particle.

The elements included in the mixture 906 are diffused faster in the surface portion and the vicinity of the grain boundary than inside the composite oxide particles. Therefore, the concentrations of magnesium and halogen in the surface portion and the vicinity of the grain boundary are higher than those of magnesium and halogen inside the composite oxide particles. As described later, the higher the magnesium concentration in the surface portion and the vicinity of the grain boundary is, the more effectively the change in the crystal structure can be inhibited.

### [Step S66 and Step S67]

Next, the material annealed in Step S65 is collected (Step S66 in FIG. 12), so that the positive electrode active material 100 of one embodiment of the present invention is obtained (Step S67 in FIG. 12). Moreover, the particles are preferably made to pass through a sieve.

Through the above process, the positive electrode active material 100 of one embodiment of the present invention can be formed.

### <Formation Method 2>

A formation method which is different from the formation method of the positive electrode active material of one embodiment of the present invention described as Formation Method 1 above is described. Note that description of the portions overlapping with the above description is omitted and different portions are described.

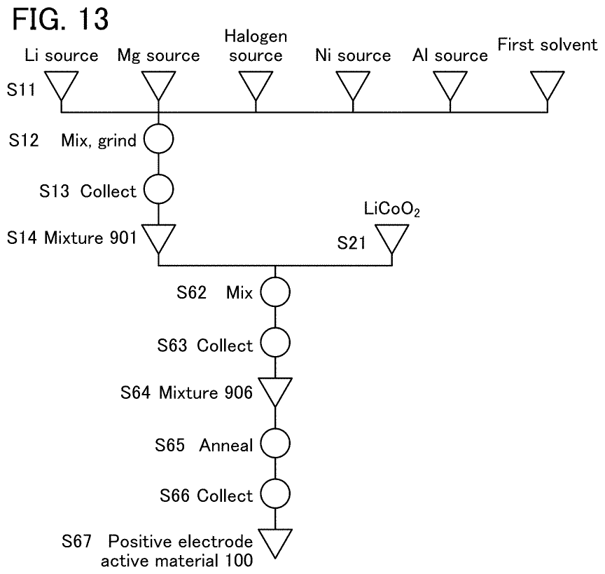

An example of a formation method of a positive electrode active material of one embodiment of the present invention is described with reference to FIG. 13.

### [Step S11]

First, as materials for the mixture 901, a lithium source, a magnesium source, a halogen source, a nickel source, and an aluminum source are prepared (Step S11 in FIG. 13). In addition, in the case where the following mixing and grinding steps are performed by a wet process, the first solvent is prepared. Detailed description of the lithium source, the magnesium source, the halogen source, the nickel source, the aluminum source, and the first solvent is omitted because the description of Formation Method 1 can be referred to for them.

### [Step S12]

Next, the materials prepared in Step S11 are mixed and ground (Step S12 in FIG. 13). Although the mixing can be performed by a dry process or a wet process, the wet process is preferable because it can grind materials to a smaller size. For the mixing, a ball mill, a bead mill, or the like can be used. In the case where the ball mill is used, a zirconia ball is preferably used as media, for example. The mixing and grinding steps are preferably performed sufficiently to pulverize the materials. As a mixing means, mixing by a blender, a mixer, or a ball mill can be suitably employed. The mixing and grinding steps are preferably performed sufficiently to pulverize the materials.

### [Step S13 and Step S14]

Next, the materials mixed and ground in Step S12 are collected (Step S13 in FIG. 13), whereby the mixture 901 is obtained (Step S14 in FIG. 13).

### [Step S21]

A composite oxide containing lithium and a transition metal is prepared (Step S21 in FIG. 13). As the composite oxide containing lithium and the transition metal, for example, lithium cobalt oxide (LiCoO₂) can be used. Detailed description of Step S21 is omitted because the description of Formation Method 1 can be referred to for the step.

### [Step S62]

Next, the mixture 901 obtained in Step S14 and the composite oxide containing lithium and the transition metal that has been prepared in Step S21 are mixed (Step S62 in FIG. 13). The ratio of the number TM of the transition metal atoms in the composite oxide containing lithium and the transition metal to the number Mg_{Mix1} of magnesium atoms contained in the mixture 901 is preferably TM: Mg_{Mix1}=1:y (0.005≤y≤0.05), further preferably TM: Mg_{Mix1}=1:y (0.007≤y≤0.04), still further preferably approximately TM: Mg_{Mix1}=1:0.02.

Step S63 and the subsequent steps are the same as those in Formation Method 1 and thus, detailed description thereof is omitted. By following Step S63 and the subsequent formation steps, the positive electrode active material 100 of one embodiment of the present invention can be obtained in Step S67. Moreover, the particles are preferably made to pass through a sieve.

Through the above process, the positive electrode active material 100 of one embodiment of the present invention can be formed.

### <Formation Method 3>

A formation method which is different from the formation methods of the positive electrode active material of one embodiment of the present invention described as Formation Method 1 and Formation Method 2 above is described. Note that description of the portions overlapping with the above description is omitted and different portions are described.

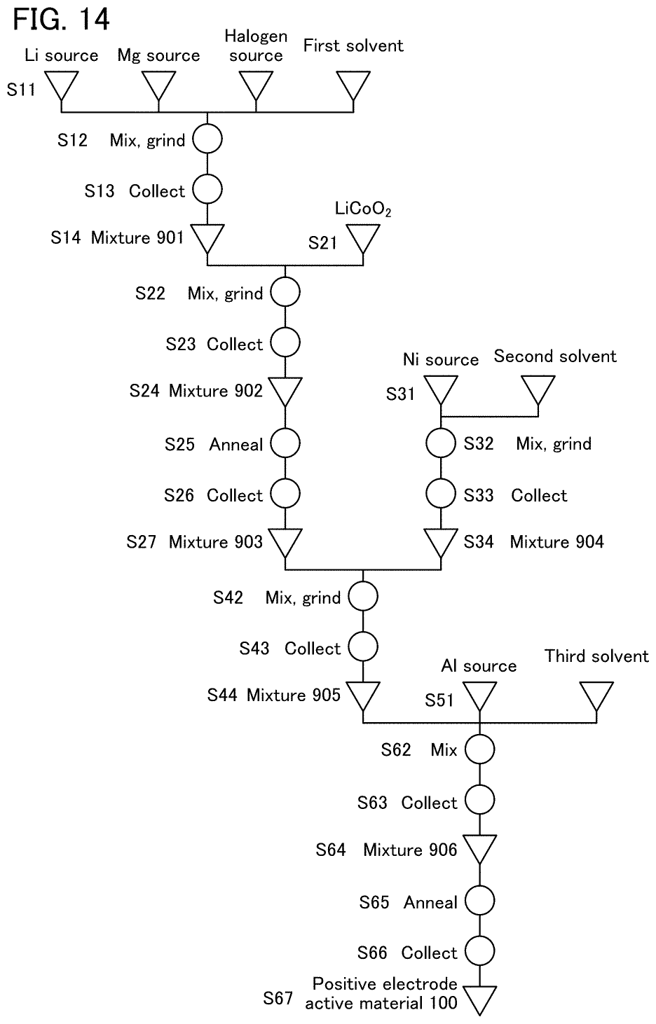

An example of a formation method of a positive electrode active material of one embodiment of the present invention is described with reference to FIG. 14.

### [Step S11]

First, as materials for the mixture 901, a lithium source, a magnesium source, and a halogen source are prepared (Step S11 in FIG. 14). In addition, in the case where the following mixing and grinding steps are performed by a wet process, the first solvent is prepared. Detailed description of the lithium source, the magnesium source, the halogen source, and the first solvent is omitted because the description of Formation Method 1 can be referred to for them.

### [Step S12]

Next, the materials prepared in Step S11 are mixed and ground (Step S12 in FIG. 14). Detailed description of Step S12 is omitted because the description of Formation Method 1 can be referred to for the step.

### [Step S13 and Step S14]

Next, the materials mixed and ground in Step S12 are collected (Step S13 in FIG. 14), whereby the mixture 901 is obtained (Step S14 in FIG. 14).

### [Step S21]

A composite oxide containing lithium and a transition metal is prepared (Step S21 in FIG. 14). As the composite oxide containing lithium and the transition metal, for example, lithium cobalt oxide (LiCoO₂) can be used. Detailed description of Step S21 is omitted because the description of Formation Method 1 can be referred to for the step.

### [Step S22]

Next, the mixture 901 obtained in Step S14 and the composite oxide containing lithium and the transition metal that has been prepared in Step S21 are mixed and ground (Step S22 in FIG. 14). The ratio of the number TM of the transition metal atoms in the composite oxide containing lithium and the transition metal to the number Mg_{Mix1} of magnesium atoms contained in the mixture 901 is preferably TM: Mg_{Mix1}=1:y (0.005≤y≤0.05), further preferably TM: Mg_{Mix1}=1:y (0.007≤y≤0.04), still further preferably approximately TM: Mg_{Mix1}=1:0.02.

The condition of the mixing in Step S22 is preferably milder than that of the mixing in Step S12 not to damage the particles of the composite oxide. For example, a condition with a lower rotation frequency or shorter time than the mixing in Step S12 is preferable. In addition, it can be said that the dry process has a milder condition than the wet process. For the mixing, a ball mill, a bead mill, or the like can be used. In the case where the ball mill is used, a zirconia ball is preferably used as media, for example.

### [Step S23 and Step S24]

Next, the materials mixed and ground in Step S22 are collected (Step S23 in FIG. 14), whereby the mixture 902 is obtained (Step S24 in FIG. 14).

For example, the mixture 902 preferably has a D50 of greater than or equal to 600 nm and less than or equal to 20 pm, further preferably greater than or equal to 1 pm and less than or equal to 10 pm. When mixed with a composite oxide containing lithium and a transition metal in a later step, the mixture 902 thus pulverized is easily attached to surfaces of composite oxide particles uniformly. The mixture 902 is preferably attached to the surfaces of the composite oxide particles uniformly, in which case halogen and magnesium are easily distributed to the surface portion of the composite oxide particles thoroughly after heating. When there is a region containing neither halogen nor magnesium in the surface portion, the above-described pseudo-spinel crystal structure might be unlikely to be obtained in a charged state.

### [Step S25]

Then, the mixture 902 is heated (Step S25 in FIG. 14). This step is referred to as annealing or baking in some cases.

The annealing is preferably performed at an appropriate temperature for an appropriate time. The appropriate temperature and time vary depending on the conditions such as the particle size and the composition of the composite oxide containing lithium and the transition metal that has been prepared in Step S21. In the case where the particle size is small, the annealing is preferably performed at a lower temperature or for a shorter time than the case where the particle size is large, in some cases.

In the case where the average particle diameter (D50) of the particles that have been prepared in Step S21 is approximately 12 pm, for example, the annealing temperature is preferably higher than or equal to 600° C. and lower than or equal to 950° C., for example. The annealing time is preferably longer than or equal to 3 hours, further preferably longer than or equal to 10 hours, still further preferably longer than or equal to 60 hours, for example.

On the other hand, in the case where the average particle diameter (D50) of the particles that have been prepared in Step S21 is approximately 5 μm, the annealing temperature is preferably higher than or equal to 600° C. and lower than or equal to 950° C., for example. The annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

It is considered that when the mixture 902 is annealed, a material having a low melting point (e.g., lithium fluoride, which has a melting point of 848° C.) in the mixture 902 is melted first and distributed to the surface portion of the composite oxide particle. Next, the existence of the melted material decreases the melting points of other materials, presumably resulting in melting of the other materials. For example, magnesium fluoride (melting point: 1263° C.) is presumably melted and distributed to the surface portion of the composite oxide particle.

The elements included in the mixture 902 are diffused faster in the surface portion and the vicinity of the grain boundary than inside the composite oxide particles. Therefore, the concentrations of magnesium and halogen in the surface portion and the vicinity of the grain boundary are higher than those of magnesium and halogen inside the composite oxide particles. As described later, the higher the magnesium concentration in the surface portion and the vicinity of the grain boundary is, the more effectively the change in the crystal structure can be inhibited.

### [Step S26 and Step S27]

Next, the material annealed in Step S25 is collected (Step S26 in FIG. 14), so that a mixture 903 is obtained (Step S27 in FIG. 14). Moreover, the particles are preferably made to pass through a sieve.

### [Step S31]

As a material for the mixture 904, a nickel source is prepared (Step S31 in FIG. 14). In addition, in the case where the following mixing and grinding steps are performed by a wet process, the second solvent is prepared. Detailed description of the nickel source and the second solvent is omitted because the description of Formation Method 1 can be referred to for them.

### [Step S32]

Next, the materials prepared in Step S31 are mixed and ground (Step S32 in FIG. 14). Detailed description of Step S32 is omitted because the description of Formation Method 1 can be referred to for the step.

### [Step S33 and Step S34]

Next, the materials mixed and ground in Step S32 are collected (Step S33 in FIG. 14), whereby the mixture 904 is obtained (Step S34 in FIG. 14).

### [Step S42]

Next, the mixture 903 obtained in Step S27 and the mixture 904 obtained in Step S34 are mixed and ground (Step S42 in FIG. 14). Although the mixing can be performed by a dry process or a wet process, the wet process is preferable because it can grind materials to a smaller size. For the mixing, a ball mill, a bead mill, or the like can be used. In the case where the ball mill is used, a zirconia ball is preferably used as media, for example. The mixing and grinding steps are preferably performed sufficiently to pulverize the materials. As a mixing means, mixing by a blender, a mixer, or a ball mill can be suitably employed.

### [Step S43 and Step S44]

Next, the materials mixed and ground in Step S42 are collected (Step S43 in FIG. 14), whereby a mixture 905 is obtained (Step S44 in FIG. 14).

Next, Step S51 to Step S65 are performed to add aluminum to the mixture 905. Examples of the method that can be employed for the addition of aluminum include a liquid phase method such as a sol-gel method, a solid phase method, a sputtering method, an evaporation method, a CVD (chemical vapor deposition) method, and a PLD (pulsed laser deposition) method.

### [Step S51]

An aluminum source is prepared (Step S51 in FIG. 14). As the aluminum source, aluminum alkoxide, a hydroxide of aluminum, an oxide of aluminum, or the like can be used. In the case of employing a sol-gel method for the addition of aluminum, the third solvent used for the sol-gel method is prepared.

It is preferable to prepare the aluminum source in an amount that makes the number of aluminum atoms contained in the aluminum source be greater than or equal to 0.001 times and less than or equal to 0.02 times the number of cobalt atoms contained in the lithium cobalt oxide. In addition, it is preferable to prepare the nickel source in an amount that makes the number of nickel atoms contained in the nickel source be greater than or equal to 0.001 times and less than or equal to 0.02 times the number of cobalt atoms contained in the lithium cobalt oxide.

### [Step S62]

Next, the aluminum source is dissolved in the third solvent, the mixture 905 obtained in Step S44 is further added, and mixing is performed (Step S62 in FIG. 14).

In the case of employing a sol-gel method as a method for adding aluminum, a solvent in which the solubility of the aluminum source is high is preferably used as the third solvent When a solvent in which the solubility of the aluminum source is high is used as the third solvent, the reactivity in a sol-gel method can be increased. In the case where aluminum alkoxide is used as the aluminum source, an alcohol can be used as the third solvent. It is further preferable that a conjugate base (alkoxide) of the alcohol be an anion of aluminum alkoxide. When an alcohol of the same kind as an anion of aluminum alkoxide is used as the third solvent, the solubility of aluminum alkoxide in the third solvent can be increased.

Here, an example in which a sol-gel method is employed as a method for adding aluminum and aluminum isopropoxide is used as the aluminum source is specifically described. In the case where aluminum isopropoxide is used as the aluminum source, isopropanol, which is an alcohol of the same kind as an anion of aluminum isopropoxide, can be suitably used as the third solvent. In Step S62, aluminum alkoxide is dissolved in isopropanol, and then lithium cobalt oxide particles are mixed. In the case where the grain diameter (D50) of the lithium cobalt oxide is approximately 20 pm, it is preferable to add aluminum isopropoxide in an amount that makes the number of aluminum atoms contained in the aluminum isopropoxide be greater than or equal to 0.001 times and less than or equal to 0.02 times the number of cobalt atoms contained in the lithium cobalt oxide.

For the mixing in Step S62, stirring with a magnetic stirrer can be employed. The mixing is preferably performed in an atmosphere containing moisture. The moisture in the atmosphere promotes hydrolysis and a polycondensation reaction of the metal alkoxide in the solution. The mixing time is long enough to cause hydrolysis and a polycondensation reaction of the moisture in the atmosphere and the metal alkoxide. Note that the higher the humidity of the atmosphere is, the shorter the reaction time can be. For example, the mixing can be performed at 25° C. in an atmosphere at a humidity of 90% RH (relative humidity) for 4 hours. The reaction time, i.e., the mixing time, may be controlled by adjustment of the moisture amount in the solution by adding water dropwise to the solution. In the case where water is added dropwise, water containing few impurities is preferably used. For example, pure water can be suitably used as the water to be added dropwise. The stirring may be performed under an atmosphere where the humidity and temperature are not adjusted, e.g., an air atmosphere in a draft chamber. In such a case, the stirring time is preferably set longer and can be 12 hours or longer at room temperature, for example.

Reaction between moisture in the atmosphere and the metal alkoxide enables a sol-gel reaction to proceed more slowly than in the case where liquid water is added. Reaction between the metal alkoxide and water at normal temperature enables a sol-gel reaction to proceed more slowly than in the case where heating is performed at a temperature higher than the boiling point of the alcohol serving as a solvent, for example. A sol-gel reaction that proceeds slowly enables formation of a high-quality coating layer with a uniform thickness.

### [Step S63]

Next, a precipitate is collected from the mixture that has undergone Step S62 (Step S63 in FIG. 14), whereby the mixture 906 is obtained (Step S64 in FIG. 14).

As a collection method, filtration, centrifugation, evaporation to dryness, and the like can be used. The precipitate can be washed with an alcohol that is the same as the solvent in which the metal alkoxide is dissolved. The precipitate is further dried. As a drying method, vacuum or ventilation drying at 80° C. for longer than or equal to 1 hour and shorter than or equal to 4 hours can be employed, for example. Note that in the case of employing evaporation to dryness, the solvent and the precipitate are not separated but the precipitate is collected in the drying step.

### [Step S65]

Then, the mixture 906 is heated (Step S65 in FIG. 14). This step is referred to as second annealing or second baking in some cases.

The heating temperature is preferably lower than 1000° C., further preferably higher than or equal to 700° C. and lower than or equal to 950° C., still further preferably approximately 850° C. The heating temperature in Step S65 is preferably lower than the heating temperature in Step S25. As for the heating time, the time for keeping the heating temperature within a predetermined range is preferably longer than or equal to 1 hour and shorter than or equal to 80 hours. The heating is preferably performed in an atmosphere containing oxygen. When an atmosphere containing oxygen is used, cobalt can be inhibited from being reduced.

### [Step S66 and Step S67]

Next, the material annealed in Step S65 is collected (Step S66 in FIG. 14), so that the positive electrode active material 100 of one embodiment of the present invention is obtained (Step S67 in FIG. 14). Moreover, the particles are preferably made to pass through a sieve.

Through the above process, the positive electrode active material 100 of one embodiment of the present invention can be formed.

This embodiment can be used in appropriate combination with any of the other embodiments.

### Embodiment 3

In this embodiment, examples of materials that can be used for a secondary battery containing the positive electrode active material 100 and the mixture 904 described in the above embodiment are described.

### <Structure Example 1 of Secondary Battery>

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector.

### [Positive Electrode Active Material Layer]

The positive electrode active material layer contains at least a positive electrode active material. The positive electrode active material layer may contain, in addition to the positive electrode active material, other materials such as a coating film of the active material surface, a conductive additive, and a binder.

As the positive electrode active material, the positive electrode active material 100 described in the above embodiment can be used. A secondary battery including the positive electrode active material 100 described in the above embodiment can have high capacity and excellent cycle performance.

As the conductive additive, a carbon material, a metal material, or a conductive ceramic material can be used, for example. Alternatively, a fiber material may be used as the conductive additive. The content of the conductive additive to the total amount of the active material layer is preferably greater than or equal to 1 wt % and less than or equal to 10 wt %, further preferably greater than or equal to 1 wt % and less than or equal to 5 wt %.

A network for electric conduction can be formed in the active material layer by the conductive additive. The conductive additive also allows the maintenance of a path for electric conduction between the positive electrode active materials. The addition of the conductive additive to the active material layer increases the electric conductivity of the active material layer.

As the conductive additive, natural graphite, artificial graphite such as mesocarbon microbeads, or carbon fiber can be used, for example. As carbon fiber, carbon fiber such as mesophase pitch-based carbon fiber or isotropic pitch-based carbon fiber can be used, for example. Furthermore, as carbon fiber, carbon nanofiber, carbon nanotube, or the like can be used. Carbon nanotube can be formed by, for example, a vapor deposition method. Alternatively, a carbon material such as carbon black (acetylene black (AB) or the like), graphite (black lead) particles, graphene, or fullerene can be used as the conductive additive, for example. Alternatively, metal powder or metal fibers of copper, nickel, aluminum, silver, gold, or the like, a conductive ceramic material, or the like can be used.

Alternatively, a graphene compound may be used as the conductive additive.

A graphene compound has excellent electrical characteristics of high conductivity and excellent physical properties of high flexibility and high mechanical strength in some cases. Furthermore, a graphene compound has a planar shape. A graphene compound enables low-contact-resistance surface contact Furthermore, a graphene compound has extremely high conductivity even with a small thickness in some cases and thus allows a conductive path to be formed in an active material layer efficiently even with a small amount. Thus, a graphene compound is preferably used as the conductive additive, in which case the area where the active material and the conductive additive are in contact with each other can be increased. The graphene compound serving as the conductive additive is preferably formed with a spray dry apparatus as a coating film to cover the entire surface of the active material, in which case the electric resistance can be reduced in some cases. Here, it is particularly preferable to use, for example, graphene, multilayer graphene, or RGO as a graphene compound. Note that RGO refers to a compound obtained by reducing graphene oxide (GO), for example.

In the case where an active material with a small particle size (e.g., 1 μm or less) is used, the specific surface area of the active material is large and thus more conductive paths for connecting the active materials are needed. Thus, the amount of conductive additive tends to increase and the loaded amount of active material tends to decrease relatively. When the loaded amount of active material decreases, the capacity of the secondary battery also decreases. In such a case, a graphene compound that can efficiently form a conductive path even with a small amount is particularly preferably used as the conductive additive because the loaded amount of active material does not decrease.

A cross-sectional structure example of an active material layer 200 containing a graphene compound as a conductive additive is described below.

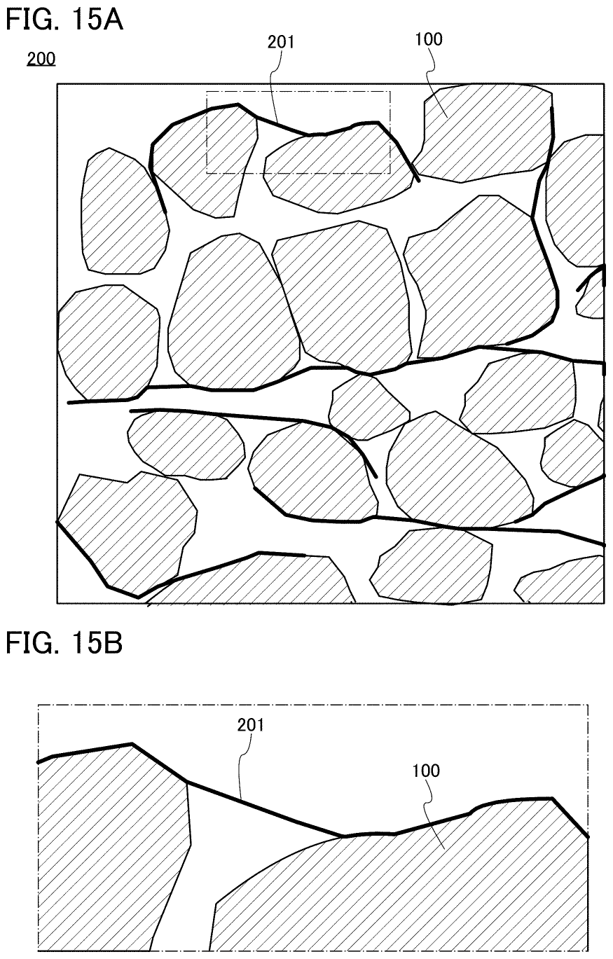

FIG. 15A is a longitudinal cross-sectional view of the active material layer 200. The active material layer 200 includes particles of the positive electrode active material 100, a graphene compound 201 serving as a conductive additive, and a binder (not illustrated). Here, graphene or multilayer graphene may be used as the graphene compound 201, for example. The graphene compound 201 preferably has a sheet-like shape. The graphene compound 201 may have a sheet-like shape formed of a plurality of sheets of multilayer graphene and/or a plurality of sheets of graphene that partly overlap with each other.

The longitudinal cross section of the active material layer 200 in FIG. 15B shows substantially uniform dispersion of the sheet-like graphene compounds 201 in the particles of the active material layer 200. The graphene compound 201 is schematically shown by a thick line in FIG. 15B but is actually a thin film having a thickness corresponding to the thickness of a single layer or a multi-layer of carbon molecules. The plurality of graphene compounds 201 are formed to partly coat or adhere to the surfaces of the plurality of particles of the positive electrode active material 100, so that the graphene compounds 201 make surface contact with the particles of the positive electrode active material 100.

Here, the plurality of graphene compounds are bonded to each other to form a net-like graphene compound sheet (hereinafter, referred to as a graphene compound net or a graphene net). The graphene net covering the active material can function as a binder for bonding active materials. The amount of binder can thus be reduced, or the binder does not have to be used. This can increase the proportion of the active material in the electrode volume or the electrode weight. That is to say, the capacity of the secondary battery can be increased.

Here, it is preferable to perform reduction after a layer to be the active material layer 200 is formed in such a manner that graphene oxide is used as the graphene compound 201 and mixed with an active material. When graphene oxide with extremely high dispersibility in a polar solvent is used for the formation of the graphene compounds 201, the graphene compounds 201 can be substantially uniformly dispersed in the particles of the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conduction path. Note that graphene oxide can be reduced either by heat treatment or with the use of a reducing agent, for example.

Unlike conductive additive particles that make point contact with an active material, such as acetylene black, the graphene compound 201 is capable of making low-contact-resistance surface contact; accordingly, the electric conduction between the particles of the positive electrode active material 100 and the graphene compounds 201 can be improved with a smaller amount of the graphene compound 201 than that of a normal conductive additive. This increases the proportion of the positive electrode active material 100 in the active material layer 200, resulting in increased discharge capacity of the secondary battery.

A graphene compound serving as a conductive additive can be formed in advance with a spray dry apparatus as a coating film to cover the entire surface of the active material, and a conductive path between the active materials can be formed using the graphene compound.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

For the binder, for example, water-soluble polymers are preferably used. As the water-soluble polymers, for example, a polysaccharide can be used. As the polysaccharide, for example, a cellulose derivative such as carboxymethyl cellulose (CMC), methyl cellulose, ethyl cellulose, hydroxypropyl cellulose, diacetyl cellulose, or regenerated cellulose or starch can be used. It is further preferred that such water-soluble polymers be used in combination with any of the above rubber materials.

Alternatively, as the binder, a material such as polystyrene, polymethyl acrylate, polymethyl methacrylate (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having an especially significant viscosity modifying effect and another material may be used in combination. For example, a rubber material or the like has high adhesion or high elasticity but may have difficulty in viscosity modification when mixed in a solvent In such a case, a rubber material or the like is preferably mixed with a material having an especially significant viscosity modifying effect, for example. As a material having an especially significant viscosity modifying effect, for example, a water-soluble polymer is preferably used. An example of a water-soluble polymer having an especially significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

The water-soluble polymers stabilize viscosity by being dissolved in water and allow stable dispersion of the active material and another material combined as a binder, such as styrene-butadiene rubber, in an aqueous solution. Furthermore, a water-soluble polymer is expected to be easily and stably adsorbed to an active material surface because it has a functional group. Many cellulose derivatives such as carboxymethyl cellulose have functional groups such as a hydroxyl group and a carboxyl group. Because of functional groups, polymers are expected to interact with each other and cover an active material surface in a large area.

In the case where the binder covering or being in contact with the active material surface forms a film, the film is expected to serve as a passivation film to suppress the decomposition of an electrolyte solution. Here, the passivation film refers to a film without electronic conductivity or a film with extremely low electric conductivity, and can suppress the decomposition of an electrolyte solution at a potential at which a battery reaction occurs in the case where the passivation film is formed on the active material surface, for example. It is preferred that the passivation film can conduct lithium ions while suppressing electric conduction.

### [Positive Electrode Current Collector]

The positive electrode current collector can be formed using a material that has high conductivity, such as a metal like stainless steel, gold, platinum, aluminum, and titanium, or an alloy thereof. It is preferred that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. Still alternatively, the positive electrode current collector may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 pm and less than or equal to 30 μm.

### [Negative Electrode]

The negative electrode includes a negative electrode active material layer and a negative electrode current collector. The negative electrode active material layer may contain a conductive additive and a binder.

### [Negative Electrode Active Material]

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium and a compound containing the element, for example, may be referred to as an alloy-based material.

In this specification and the like, SiO refers to, for example, silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

Alternatively, for the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

For the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### [Negative Electrode Current Collector]

For the negative electrode current collector, a material similar to that of the positive electrode current collector can be used. Note that a material which is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

The use of one or more ionic liquids (room temperature molten salts) that are unlikely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains small numbers of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of a material to be added in the whole solvent is, for example, greater than or equal to 0.1 wt % and less than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

As the polymer, for example, a polymer having a polyalkylene oxide structure, such as polyethylene oxide (PEO); PVDF; polyacrylonitrile; or a copolymer containing any of them can be used. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator and a spacer need not be provided. Furthermore, the battery can be entirely solidified; therefore, there is no possibility of liquid leakage and thus the safety of the battery is dramatically increased.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. As the ceramic-based material, aluminum oxide particles or silicon oxide particles can be used, for example. As the fluorine-based material, PVDF or polytetrafluoroethylene can be used, for example. As the polyamide-based material, nylon or aramid (meta-based aramid or para-based aramid) can be used, for example.

When the separator is coated with the ceramic-based material, the oxidation resistance is improved; hence, deterioration of the separator in high-voltage charge and discharge can be suppressed and thus the reliability of the secondary battery can be improved. In addition, when the separator is coated with the fluorine-based material, the separator is easily brought into close contact with an electrode, resulting in high output characteristics. When the separator is coated with the polyamide-based material, in particular, aramid, heat resistance is improved to increase the safety of the secondary battery.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, a film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

### <Structure Example 2 of Secondary Battery>

A structure of a secondary battery using a solid electrolyte layer is described below as a structure example of a secondary battery.

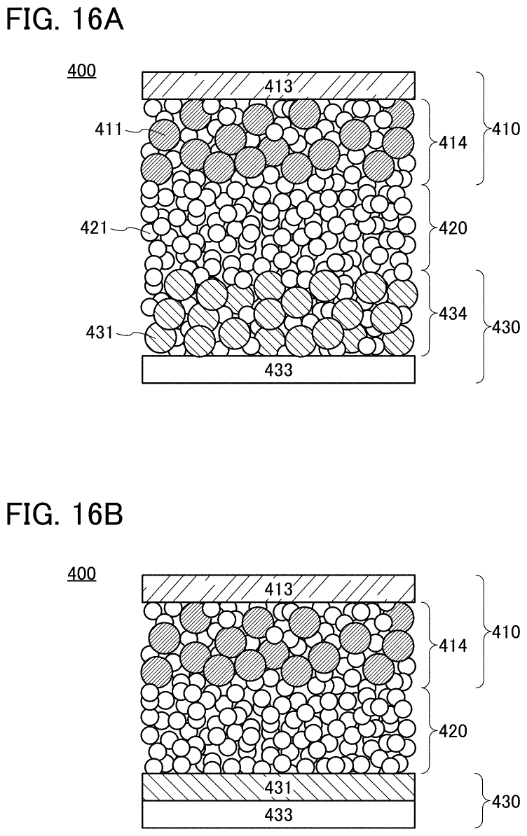

As illustrated in FIG. 16A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material layer 414 may contain a conductive additive and a binder.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, it is possible that the negative electrode 430 does not include the solid electrolyte 421 as illustrated in FIG. 16B. The use of metal lithium for the negative electrode 430 is preferable because the energy density of the secondary battery 400 can be increased.

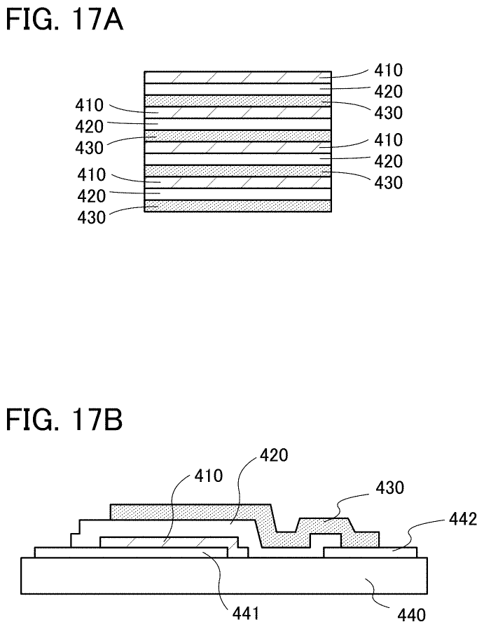

As illustrated in FIG. 17A, the secondary battery may have a structure in which a combination of the positive electrode 410, the solid electrolyte layer 420, and the negative electrode 430 is repeatedly stacked. Stacking the positive electrodes 410, the solid electrolyte layers 420, and the negative electrodes 430 can increase the voltage of the secondary battery. FIG. 17A is a schematic view illustrating the case where four layers of the combination of the positive electrode 410, the solid electrolyte layer 420, and the negative electrode 430 are stacked.

The secondary battery 400 of one embodiment of the present invention may be a thin-film all-solid-state battery. A thin-film all-solid-state battery can be manufactured by depositing a positive electrode, a solid electrolyte, a negative electrode, a wiring electrode, and the like by a vapor phase method (a vacuum deposition method, a pulsed laser deposition method, an aerosol deposition method, or a sputtering method). As illustrated in FIG. 17B, for example, after a wiring electrode 441 and a wiring electrode 442 are formed over a substrate 440, the positive electrode 410 is formed over the wiring electrode 441, the solid electrolyte layer 420 is formed over the positive electrode 410, and the negative electrode 430 is formed over the solid electrolyte layer 420 and the wiring electrode 442, whereby the secondary battery 400 can be manufactured. As the substrate 440, a ceramic substrate, a glass substrate, a plastic substrate, a metal substrate, or the like can be used.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂Si₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₊ₓAlₓTi₂₋ₓ(PO₄)₃), a material with a gamet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄-Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used as the solid electrolyte 421.

In particular, Li₁₊ₓAlₓTi₂₋ₓ(PO₄)₃ (0<x<1) with a NASICON crystal structure (hereinafter LATP) is preferable because LATP contains aluminum and titanium, each of which is the element the positive electrode active material used in the secondary battery 400 of one embodiment of the present invention may contain, and thus a synergistic effect of improving the cycle performance is expected. Moreover, higher productivity due to the reduction in the number of steps is expected. Note that in this specification and the like, a NASICON crystal structure is a compound represented by M₂(XO₄)₃(M: transition metal; X: S, P, As, Mo, W, or the like) and having a structure in which MO₆ octahedra and XO₄ tetrahedra that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

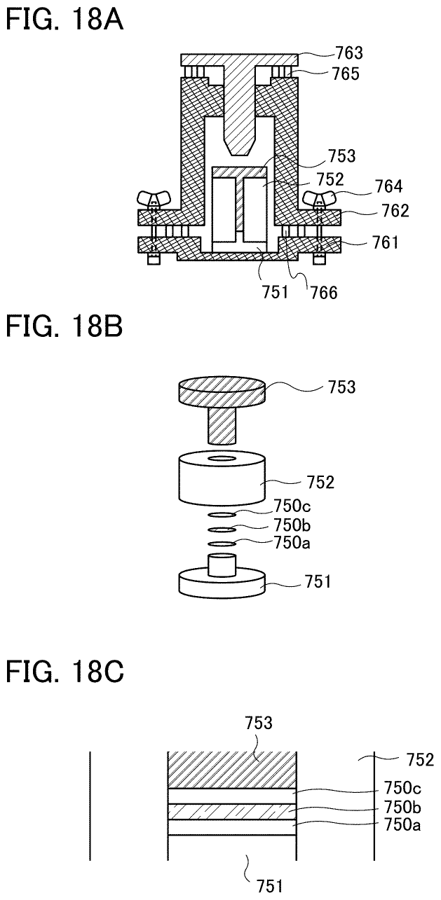

FIG. 18 shows an example of a cell for evaluating materials of an all-solid-state battery, for example.

FIG. 18A is a schematic cross-sectional view of an evaluation cell, the evaluation cell includes a lower component 761, an upper component 762, and a fixation screw and a butterfly nut 764 for fixing them, and by rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 18B is an enlarged perspective view of the evaluation material and its vicinity.

A stack of a positive electrode 750a, a solid electrolyte layer 750b, and a negative electrode 750c is shown as an example of the evaluation material, and its cross section is shown in FIG. 18C. Note that the same portions in FIG. 18A, FIG. 18B, and FIG. 18C are denoted by the same reference numerals.

The electrode plate 751 and the lower component 761 that are electrically connected to the positive electrode 750a can be said to correspond to a positive electrode terminal. The electrode plate 753 and the upper component 762 that are electrically connected to the negative electrode 750c can be said to correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. Sealing of the exterior body is preferably performed in a closed atmosphere, for example, in a glove box, in which air is blocked.

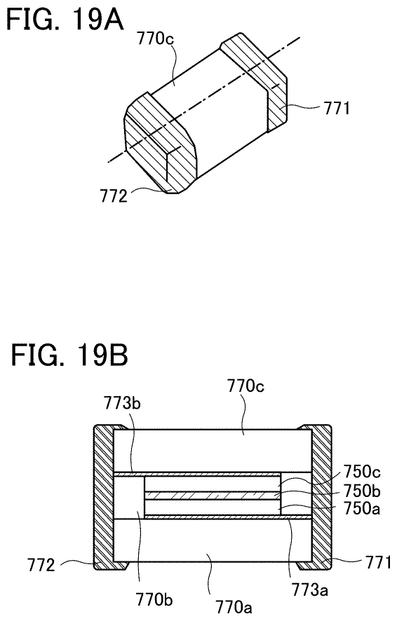

FIG. 19A is a perspective view of a secondary battery of one embodiment of the present invention that has an exterior body and a shape different from those in FIG. 18. The secondary battery in FIG. 19A includes external electrodes 771 and 772 and is sealed with an exterior body including a plurality of package components.

FIG. 19B shows an example of a cross section along the dashed-dotted line in FIG. 19A. A stacked body including the positive electrode 750a, the solid electrolyte layer 750b, and the negative electrode 750c is surrounded and sealed by a package component 770a in which an electrode layer 773a is provided on a flat plate, a frame-like package component 770b, and a package component 770c in which an electrode layer 773b is provided on a flat plate. For the package components 770a, 770b, and 770c, an insulating material such as a resin material or ceramics can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 4

In this embodiment, examples of a shape of a secondary battery containing the positive electrode active material 100 described in the above embodiment are described. For the materials used for the secondary battery described in this embodiment, the description of the above embodiment can be referred to.

### <Coin-Type Secondary Battery>

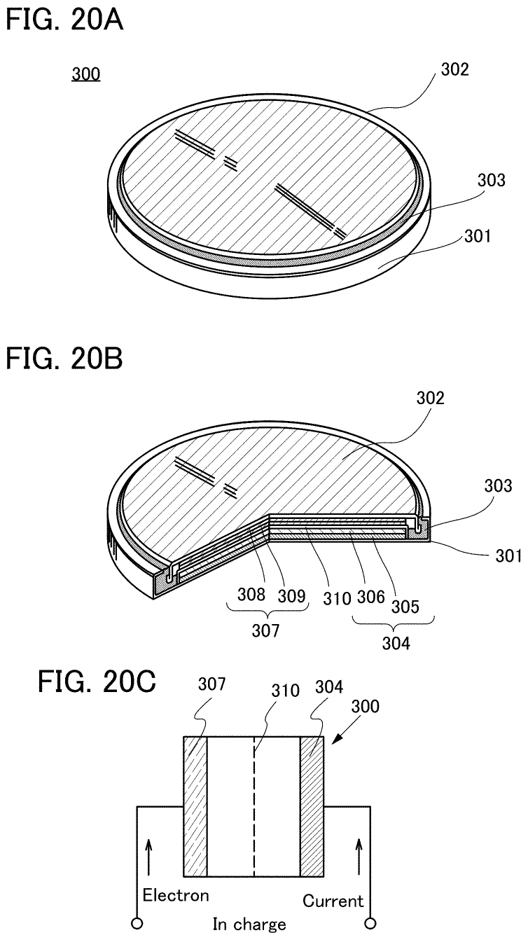

First, an example of a coin-type secondary battery is described. FIG. 20A is an external view of a coin-type (single-layer flat type) secondary battery, and FIG. 20B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte solution. Then, as illustrated in FIG. 20B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high capacity and excellent cycle performance can be obtained.

Here, a current flow in charging a secondary battery is described with reference to FIG. 20C. When a secondary battery using lithium is regarded as a closed circuit, movement of lithium ions and the current flow are in the same direction. Note that in the secondary battery using lithium, the anode and the cathode interchange in charge and discharge, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode interchange in charge and discharge. Thus, the terms “anode” and “cathode” are not used in this specification. If the term “anode” or “cathode” is used, it should be mentioned that the anode or the cathode is which of the one at the time of charge or the one at the time of discharge and corresponds to which of a positive (plus) electrode or a negative (minus) electrode.

Two terminals illustrated in FIG. 20C are connected to a charger, and the secondary battery 300 is charged. As the charge of the secondary battery 300 proceeds, a potential difference between electrodes increases.

### <Cylindrical Secondary Battery>

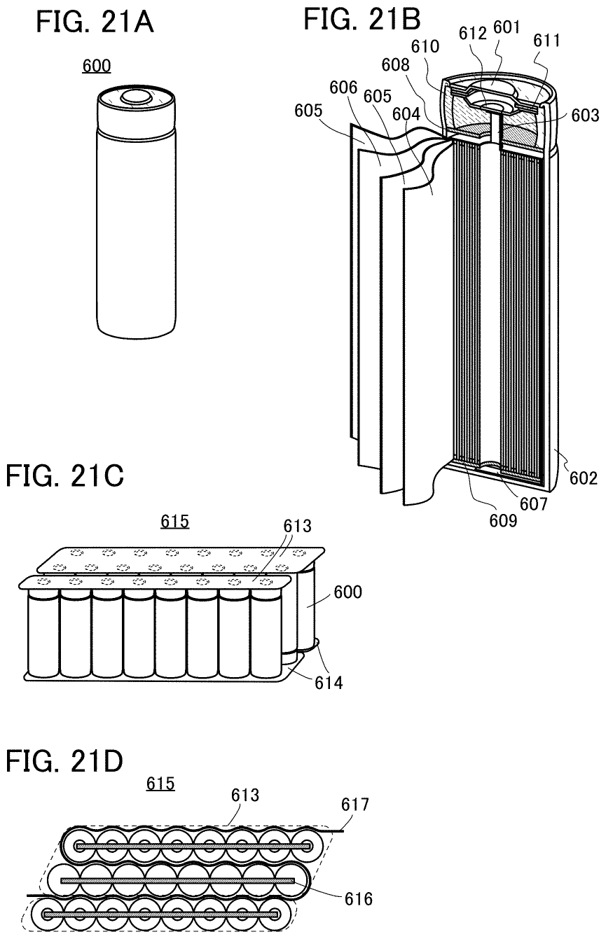

Next, an example of a cylindrical secondary battery is described with reference to FIG. 21. FIG. 21A shows an external view of a cylindrical secondary battery 600. FIG. 21B is a schematic cross-sectional view of the cylindrical secondary battery 600. The cylindrical secondary battery 600 includes, as illustrated in FIG. 21B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element

As illustrated in FIG. 21(C), a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 21D is a top view of the module 615. The conductive plate 613 is shown by a dotted line for clarity of the diagram. As illustrated in FIG. 21D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### <Structure Examples of Secondary Battery>

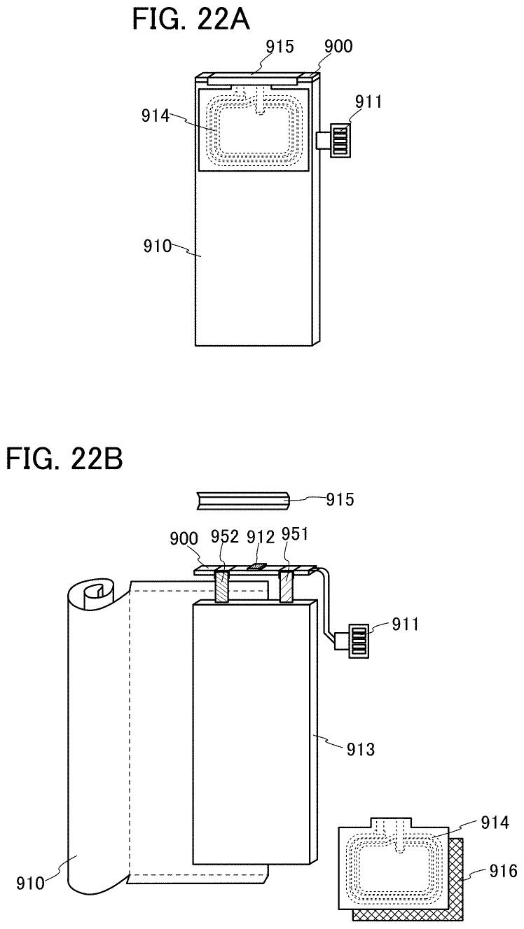

Other structure examples of secondary batteries are described with reference to FIG. 22 to FIG. 26.

FIG. 22A and FIG. 22B are external views of a battery pack. The battery pack includes a secondary battery 913 and a circuit board 900. A secondary battery 913 is connected to an antenna 914 through a circuit board 900. A label 910 is attached to the secondary battery 913. The circuit board 900 is fixed to the label 910 with a seal 915. In addition, as illustrated in FIG. 22B, the secondary battery 913 is connected to a terminal 951 and a terminal 952.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 22.

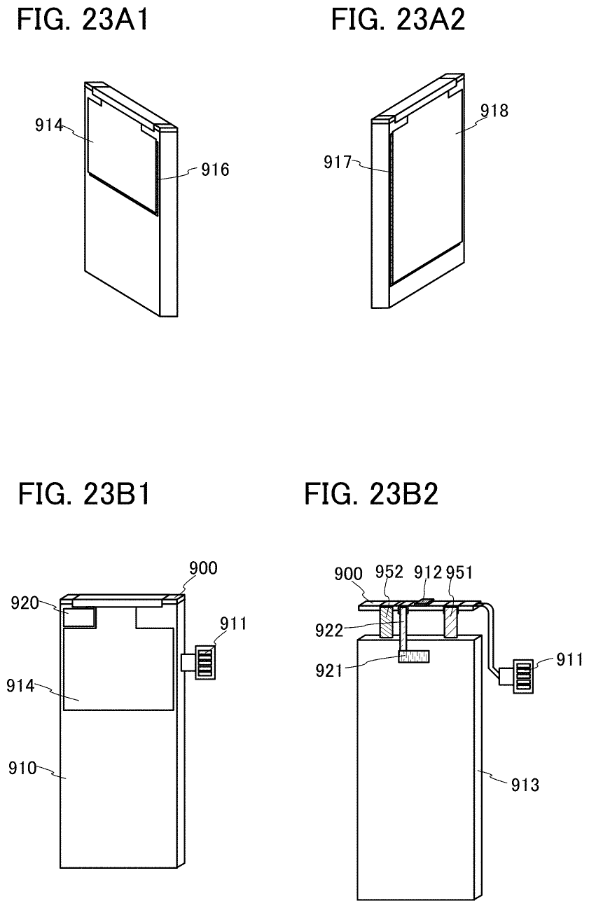

For example, as illustrated in FIG. 23A1 and FIG. 23A2, two opposite surfaces of the secondary battery 913 illustrated in FIG. 22A and FIG. 22B may be provided with respective antennas. FIG. 23A1 is an external view seen from one side of the opposite surfaces, and FIG. 23A2 is an external view seen from the other side of the opposite surfaces. Note that for portions similar to those of the secondary battery illustrated in FIG. 22A and FIG. 22B, the description of the secondary battery illustrated in FIG. 22A and FIG. 22B can be appropriately referred to.

As illustrated in FIG. 23A1, the antenna 914 is provided on one of the opposite surfaces of the secondary battery 913 with the layer 916 located therebetween, and as illustrated in FIG. 23A2, an antenna 918 is provided on the other of the opposite surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 23B1, the secondary battery 913 illustrated in FIG. 22A and FIG. 22B may be provided with a display device 920. The display device 920 is electrically connected to the terminal 911. Note that the label 910 is not necessarily provided in a portion where the display device 920 is provided. Note that for portions similar to those of the secondary battery illustrated in FIG. 22A and FIG. 22B, the description of the secondary battery illustrated in FIG. 22A and FIG. 22B can be appropriately referred to.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 23B2, the secondary battery 913 illustrated in FIG. 22A and FIG. 22B may be provided with a sensor 921. The sensor 921 is electrically connected to the terminal 911 via a terminal 922. Note that for portions similar to those of the secondary battery illustrated in FIG. 22A and FIG. 22B, the description of the secondary battery illustrated in FIG. 22A and FIG. 22B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

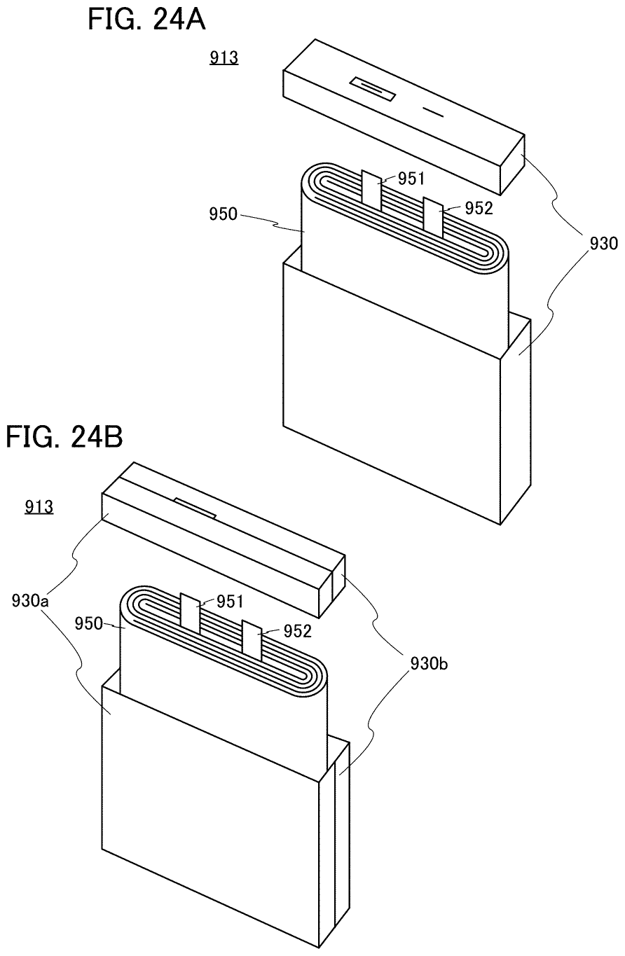

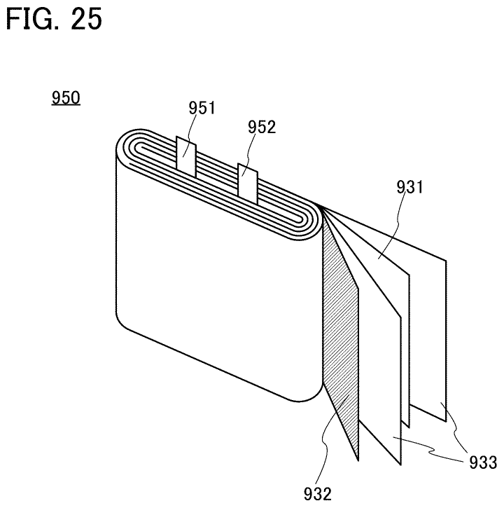

Furthermore, structure examples of the secondary battery 913 are described with reference to FIG. 24 and FIG. 25.

The secondary battery 913 illustrated in FIG. 24A includes a wound body 950 provided with the terminal 951 and the terminal 952 inside a housing 930. The wound body 950 is soaked in an electrolyte solution inside the housing 930. The terminal 952 is in contact with the housing 930. The use of an insulator or the like prevents contact between the terminal 951 and the housing 930. Note that in FIG. 24A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 24B, the housing 930 illustrated in FIG. 24A may be formed using a plurality of materials. For example, in the secondary battery 913 illustrated in FIG. 24B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 25 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 22 via one of the terminal 951 and the terminal 952. The positive electrode 932 is connected to the terminal 911 illustrated in FIG. 22 via the other of the terminal 951 and the terminal 952.

When the positive electrode active material described in the above embodiment is used in the positive electrode 932, the secondary battery 913 with high capacity and excellent cycle performance can be obtained.

### <Laminated Secondary Battery>

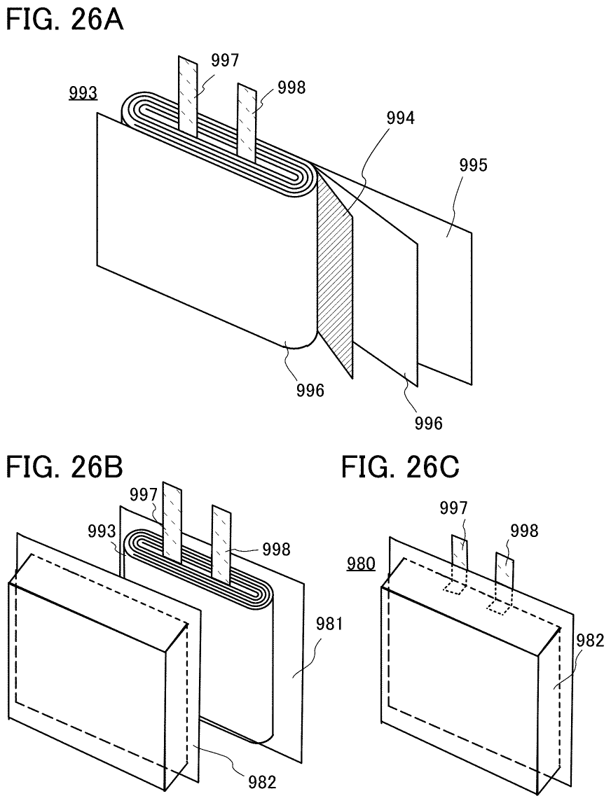

Next, an example of a laminated secondary battery is described with reference to FIG. 26 to FIG. 33. When the laminated secondary battery has flexibility and is used in an electronic device at least part of which is flexible, the secondary battery can be bent as the electronic device is bent.

A laminated secondary battery 980 is described with reference to FIG. 26. The laminated secondary battery 980 includes a wound body 993 illustrated in FIG. 26A. The wound body 993 includes a negative electrode 994, a positive electrode 995, and separators 996. The wound body 993 is, like the wound body 950 illustrated in FIG. 25, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be designed as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 26B, the above-described wound body 993 is packed in a space formed by bonding a film 981 and a film 982 having a depressed portion that serve as exterior bodies by thermocompression bonding or the like, whereby the secondary battery 980 as illustrated in FIG. 26C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 26B and FIG. 26C show an example of using two films, the wound body 993 may be placed in a space formed by bending one film.

When the positive electrode active material described in the above embodiment is used in the positive electrode 995, the secondary battery 980 with high capacity and excellent cycle performance can be obtained.

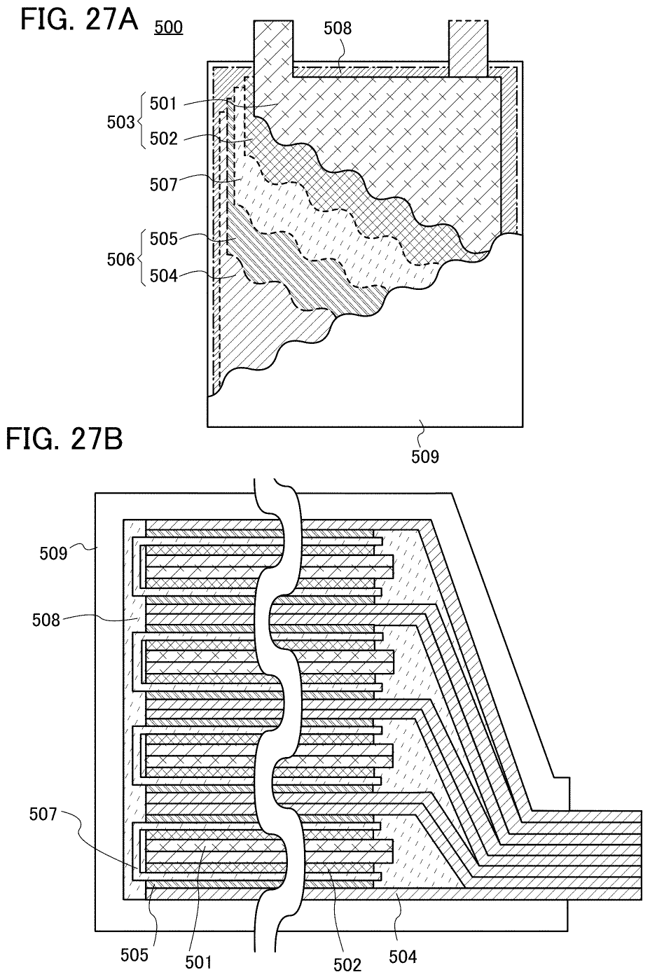

In FIG. 26, an example in which the secondary battery 980 includes a wound body in a space formed by films serving as exterior bodies is described; however, as illustrated in FIG. 27, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 27A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 illustrated in FIG. 27A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 27B shows an example of a cross-sectional structure of the laminated secondary battery 500. FIG. 27A shows an example in which only two current collectors are included for simplicity, but actually, a plurality of electrode layers are included as illustrated in FIG. 27B.

In FIG. 27B, the number of electrode layers is 16, for example. Note that the secondary battery 500 has flexibility even though the number of electrode layers is set to 16. FIG. 27B illustrates a structure including 8 layers of negative electrode current collectors 504 and 8 layers of positive electrode current collectors 501, i.e., 16 layers in total. Note that FIG. 27B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high capacity. In contrast, with a small number of electrode layers, the secondary battery can have small thickness and high flexibility.

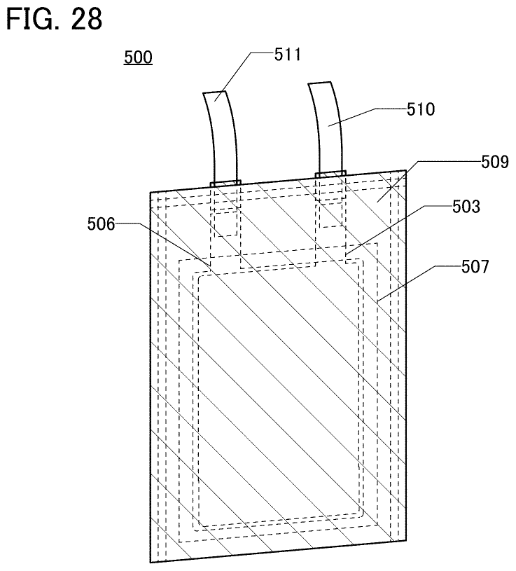

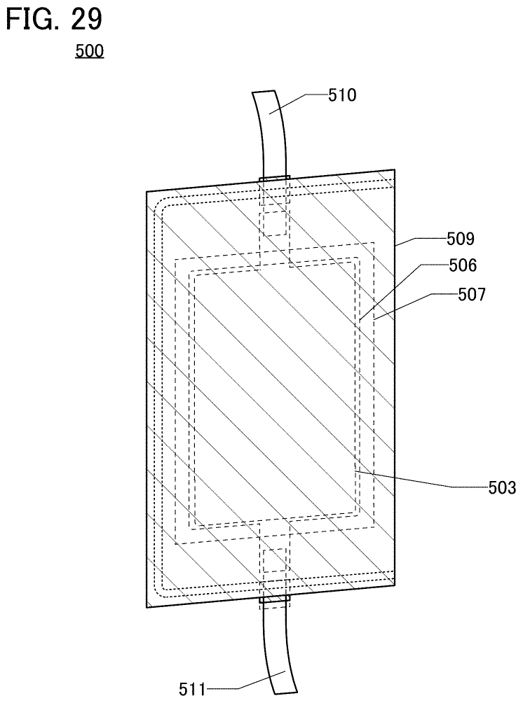

FIG. 28 and FIG. 29 each show an example of the external view of the laminated secondary battery 500. In FIG. 28 and FIG. 29, the positive electrode 503, the negative electrode 506, the separator 507, the exterior body 509, a positive electrode lead electrode 510, and a negative electrode lead electrode 511 are included.

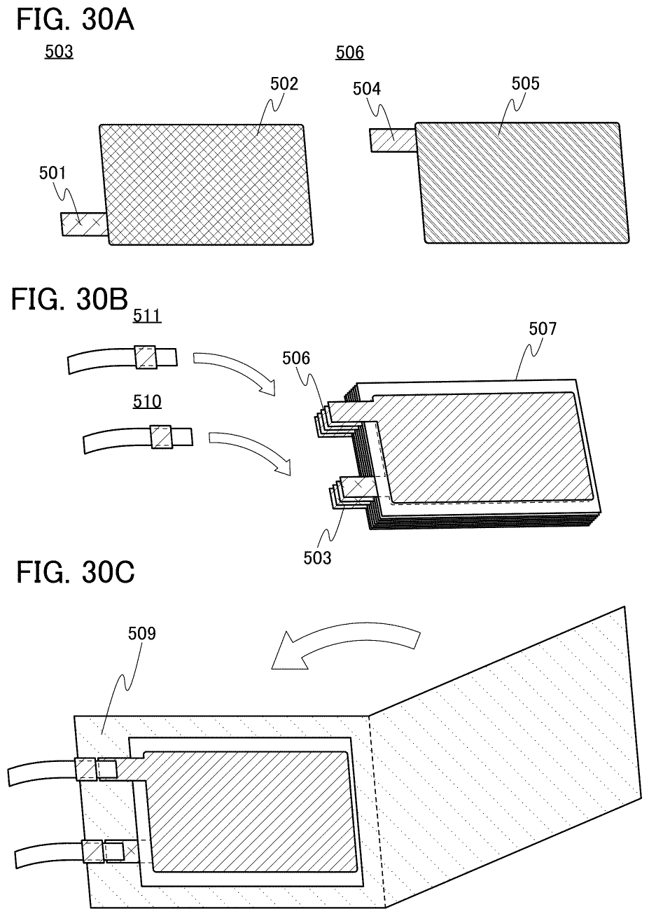

FIG. 30A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 30A.

### <Method for Manufacturing Laminated Secondary Battery>

Here, an example of a method for manufacturing the laminated secondary battery whose external view is illustrated in FIG. 28 is described with reference to FIG. 30B and FIG. 30C.

First, the negative electrode 506, the separator 507, and the positive electrode 503 are stacked. FIG. 30B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 30C. Then, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated secondary battery 500 can be manufactured.

When the positive electrode active material described in the above embodiment is used in the positive electrode 503, the secondary battery 500 with high capacity and excellent cycle performance can be obtained.

### <Bendable Secondary Battery>

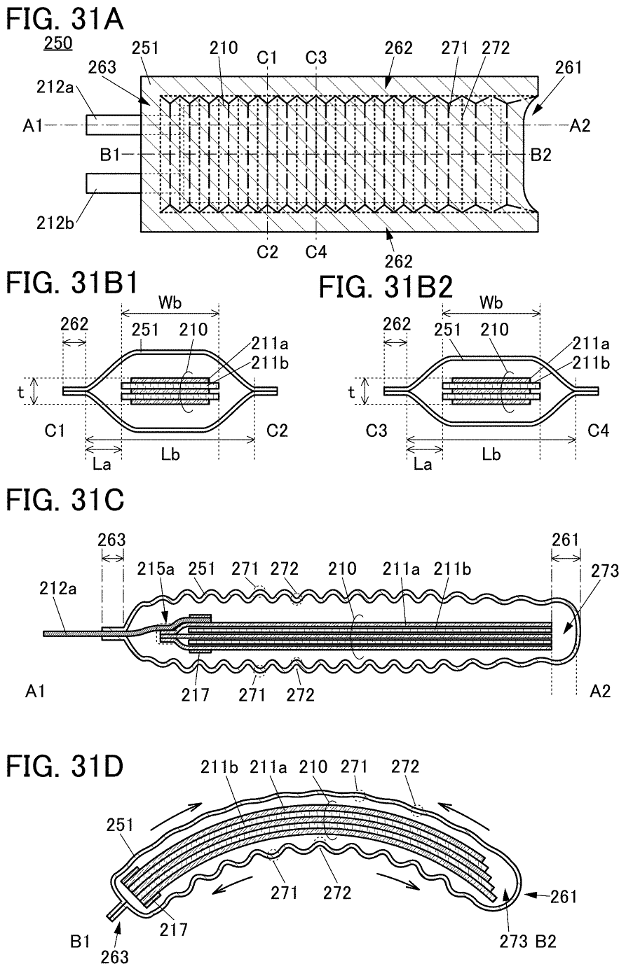

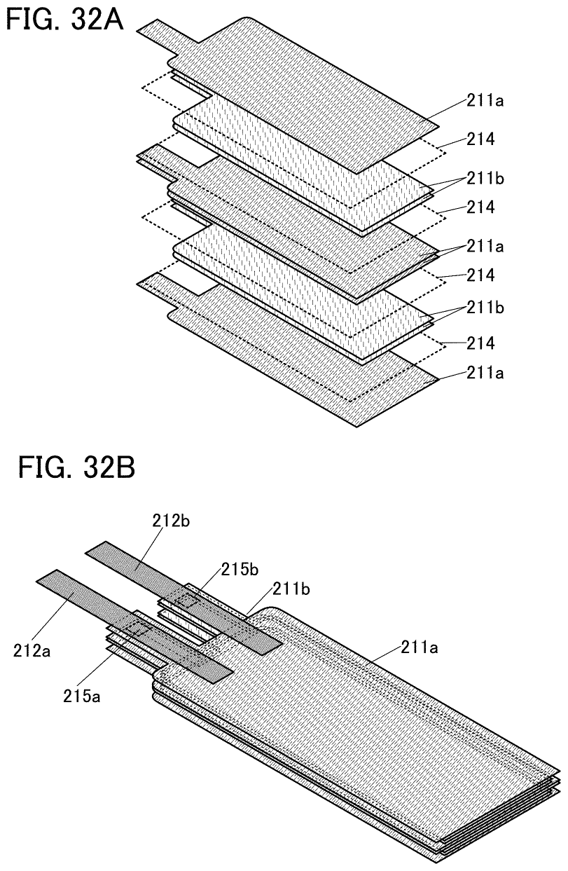

Next, an example of a bendable secondary battery is described with reference to FIG. 31 and FIG. 32.

FIG. 31A is a schematic top view of a bendable secondary battery 250. FIG. 31B1, FIG. 31B2, and FIG. 31C are schematic cross-sectional views taken along the cutting line C1-C2, the cutting line C3-C4, and the cutting line A1-A2, respectively, in FIG. 31A. The secondary battery 250 includes an exterior body 251 and an electrode member 210 held in the exterior body 251. The electrode member 210 has a structure in which a plurality of positive electrodes 211a and a plurality of negative electrodes 211b are stacked. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

The positive electrode 211a and the negative electrode 211b included in the secondary battery 250 are described with reference to FIG. 32. FIG. 32A is a perspective view illustrating the stacking order of the positive electrode 211a, the negative electrode 211b, and a separator 214. FIG. 32B is a perspective view illustrating the lead 212a and the lead 212b in addition to the positive electrode 211a and the negative electrode 211b.

As illustrated in FIG. 32A, the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab. A positive electrode active material layer is formed on one surface of the positive electrode 211a other than the tab, and a negative electrode active material layer is formed on one surface of the negative electrode 211b other than the tab.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material is not formed are in contact with each other.

The separator 214 is provided between the surface of the positive electrode 211a on which the positive electrode active material is formed and the surface of the negative electrode 211b on which the negative electrode active material is formed. In FIG. 32, the separator 214 is shown by a dotted line for easy viewing.

As illustrated in FIG. 32(B), the plurality of positive electrodes 211a are electrically connected to the lead 212a in a bonding portion 215a. The plurality of negative electrodes 211b are electrically connected to the lead 212b in a bonding portion 215b.

Next, the exterior body 251 is described with reference to FIG. 31B1, FIG. 31B2, FIG. 31C, and FIG. 31D.

The exterior body 251 has a film-like shape and is folded in half so as to sandwich the positive electrodes 211a and the negative electrodes 211b. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 31B1 shows across section along the part overlapping with the crest line 271. FIG. 31B2 shows across section along the part overlapping with the trough line 272. FIG. 31B1 and FIG. 31B2 correspond to cross sections of the secondary battery 250, the positive electrodes 211a, and the negative electrodes 211b in the width direction.

Here, the distance between end portions of the positive electrode 211a and the negative electrode 211b in the width direction and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte solution. Therefore, the distance La is preferably set as long as possible. However, if the distance La is too long, the volume of the secondary battery 250 is increased.

The distance La between the positive electrode 211a and the negative electrode 211b, and the seal portion 262 is preferably increased as the total thickness of the positive electrode 211a and the negative electrode 211b that are stacked is increased.

Specifically, when the total thickness of the stacked positive electrodes 211a, negative electrodes 211b, and separators 214 (not illustrated) is t, the distance La is preferably 0.8 times or more and 3.0 times or less, further preferably 0.9 times or more and 2.5 times or less, and still further preferably 1.0 times or more and 2.0 times or less as large as the thickness t. When the distance La is in the above range, a compact battery highly reliable for bending can be obtained.

When the distance between the pair of seal portions 262 is referred to as a distance Lb, it is preferred that the distance Lb be sufficiently longer than the widths of the positive electrode 211a and the negative electrode 211b (here, a width Wb of the negative electrode 211b). Thus, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; thus, the positive electrode 211a and the negative electrode 211b can be effectively prevented from being rubbed against the exterior body 251.

For example, the difference between the distance Lb, which is the distance between the pair of seal portions 262, and the width Wb of the negative electrode 211b is preferably 1.6 times or more and 6.0 times or less, further preferably 1.8 times or more and 5.0 times or less, and still further preferably 2.0 times or more and 4.0 times or less as large as the thickness t of the positive electrode 211a and the negative electrode 211b.

In other words, the distance Lb, the width Wb, and the thickness t preferably satisfy the relationship of Formula 3 below.

$$\begin{matrix}[ Formula 3 ] & \\ \frac{Lb - Wb}{2 t} \geq a & ( Formula 3 )\end{matrix}$$

Here, a satisfies 0.8 or more and 3.0 or less, preferably 0.9 or more and 2.5 or less, further preferably 1.0 or more and 2.0 or less.

FIG. 31C illustrates a cross-sectional view including the lead 212a and corresponds to a cross section of the secondary battery 250, the positive electrode 211a, and the negative electrode 211b in the length direction. As illustrated in FIG. 31C, a space 273 is preferably provided between the end portions of the positive electrode 211a and the negative electrode 211b in the length direction and the exterior body 251 in the folded portion 261.

FIG. 31D is a schematic cross-sectional view of the secondary battery 250 in a state of being bent. FIG. 31D corresponds to across section along the cutting line B1-B2 in FIG. 31A.

When the secondary battery 250 is bent, a part of the exterior body 251 positioned on the outer side in bending is unbent and the other part positioned on the inner side changes its shape as it shrinks. More specifically, the part of the exterior body 251 positioned on the outer side changes its shape such that the wave amplitude becomes smaller and the length of the wave period becomes larger. In contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand or contract. Thus, the secondary battery 250 can be bent with weak force without damage to the exterior body 251.

As illustrated in FIG. 31(D), when the secondary battery 250 is bent, the positive electrode 211a and the negative electrode 211b are shifted relatively. At this time, ends of the stacked positive electrodes 211a and negative electrodes 211b on the seal portion 263 side are fixed by a fixing member 217. Thus, the positive electrodes 211a and the negative electrodes 211b are shifted so that the shift amount becomes larger at a position closer to the bent portion 261. Therefore, stress applied to the positive electrode 211a and the negative electrode 211b is relieved, and the positive electrode 211a and the negative electrode 211b themselves do not need to expand or contract. Consequently, the secondary battery 250 can be bent without damage to the positive electrode 211a and the negative electrode 211b.

The space 273 is included between the positive electrode 211a and the negative electrode 211b, and the exterior body 251, whereby the positive electrode 211a and the negative electrode 211b can be shifted relatively while the positive electrode 211a and the negative electrode 211b located on an inner side in bending do not come into contact with the exterior body 251.

In the secondary battery 250 illustrated in FIG. 31 and FIG. 32, the exterior body is unlikely to be damaged and the positive electrode 211a and the negative electrode 211b are unlikely to be damaged, for example, and the battery characteristics are unlikely to deteriorate even when the secondary battery 250 is repeatedly bent and unbent. When the positive electrode active material described in the above embodiment is used in the positive electrode 211a included in the secondary battery 250, a battery with better cycle performance can be obtained.

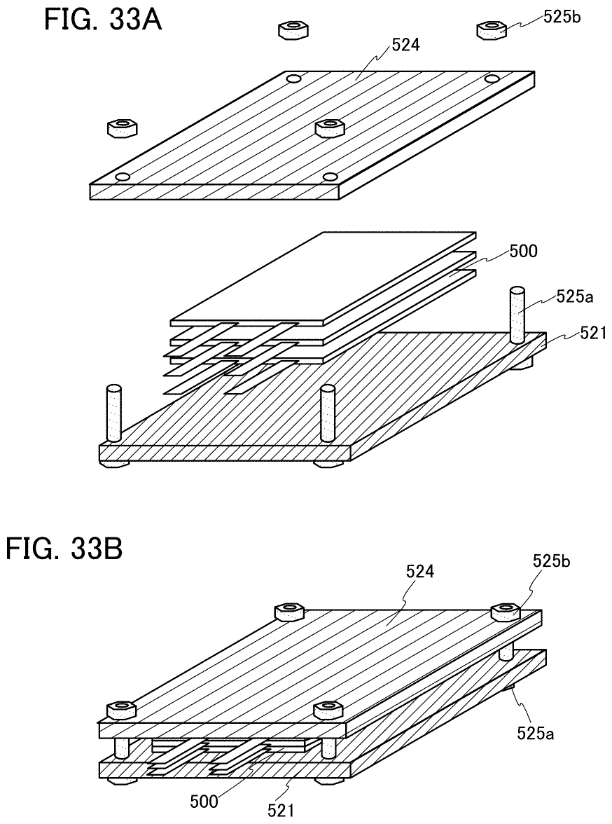

FIG. 33A is a perspective view showing three laminated secondary batteries 500 sandwiched and fixed between a first plate 521 and a second plate 524. The distance between the first plate 521 and the second plate 524 is fixed using a fixation tool 525a and a fixation tool 525b as illustrated in FIG. 33B, whereby stress can be applied to the three secondary batteries 500.

Although FIG. 33A and FIG. 33B show an example of using the three laminated secondary batteries 500, the number of secondary batteries 500 is not particularly limited and four or more secondary batteries 500 can be used. A set of ten or more secondary batteries 500 can be used as a power source for a compact vehicle, and a set of 100 or more secondary batteries 500 can be used as an in-vehicle large power source. In order to prevent overcharge, the laminated secondary battery 500 may be provided with a protection circuit or a temperature sensor for monitoring the temperature rise.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charge and discharge of the all-solid-state battery can be suppressed, and the reliability of the all-solid-state battery can be improved.

This embodiment can be implemented in appropriate combination with any of the other embodiments.

### Embodiment 5

In this embodiment, examples of electronic devices each including the secondary battery of one embodiment of the present invention are described.

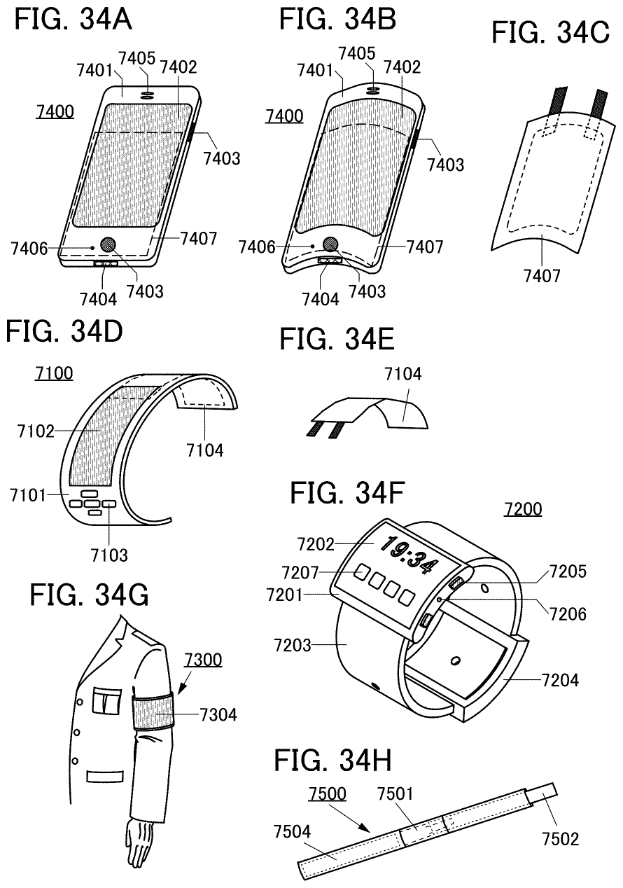

First, FIG. 34A to FIG. 34G show examples of electronic devices including the bendable secondary battery described in the above embodiment. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

A flexible secondary battery can be incorporated along a curved inside/outside wall surface of a house or a building or a curved interior/exterior surface of an automobile.

FIG. 34A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 34B illustrates the mobile phone 7400 that is curved. When the whole mobile phone 7400 is curved by external force, the secondary battery 7407 provided therein is also curved. FIG. 34C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 34D shows an example of a bangle display device. A portable display device 7100 includes a housing 7101, a display portion 7102, operation buttons 7103, and a secondary battery 7104. FIG. 34E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 34F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 34E that is in the state of being curved can be provided in the housing 7201. Alternatively, the secondary battery 7104 illustrated in FIG. 34E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 34G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

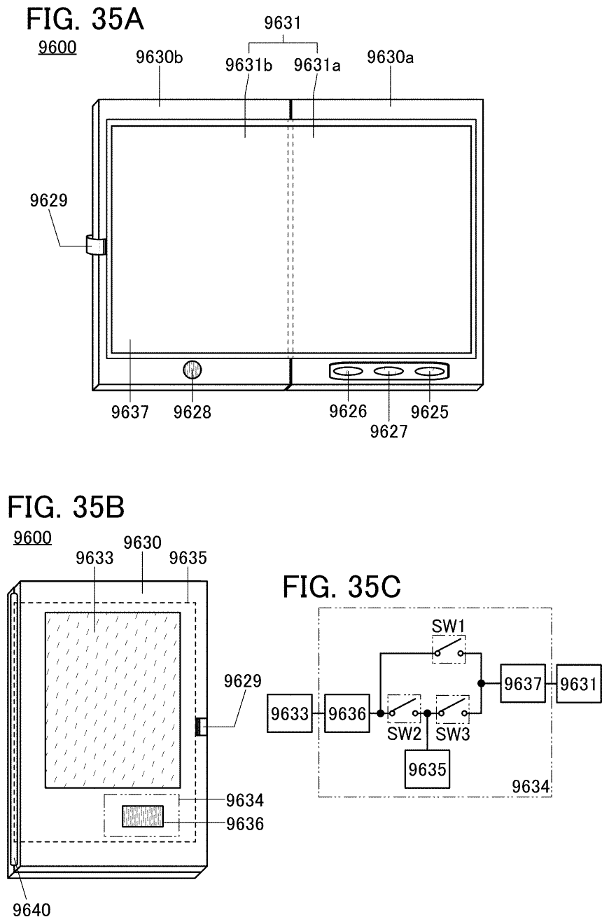

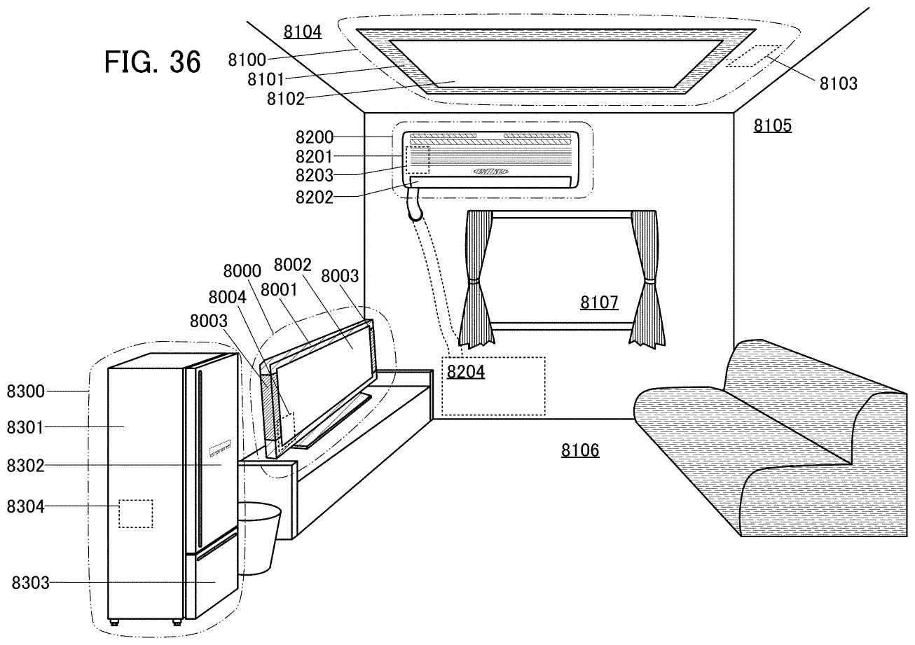

Examples of electronic devices each including the secondary battery with excellent cycle performance described in the above embodiment are described with reference to FIG. 34H, FIG. 35, and FIG. 36.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 34H is a perspective view of a device called a cigarette smoking device (electronic cigarette). In FIG. 34H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 illustrated in FIG. 34H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIG. 35A and FIG. 35B show an example of a tablet terminal that can be folded in half. A tablet terminal 9600 illustrated in FIG. 35A and FIG. 35B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 35A illustrates the tablet terminal 9600 that is opened, and FIG. 35B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 35A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-definition images than the other.

The tablet terminal 9600 is folded in half in FIG. 35B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high capacity and excellent cycle performance, the tablet terminal 9600 that can be used for a long time over a long period can be provided.

The tablet terminal 9600 illustrated in FIG. 35A and FIG. 35B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 35B are described with reference to a block diagram in FIG. 35C. The solar cell 9633, the power storage unit 9635, the DCDC converter 9636, a converter 9637, switches SW1 to SW3, and the display portion 9631 are illustrated in FIG. 35C, and the power storage unit 9635, the DCDC converter 9636, the converter 9637, and the switches SW1 to SW3 correspond to the charge and discharge control circuit 9634 illustrated in FIG. 35B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charge may be performed with a non-contact power transmission module that performs charge by transmitting and receiving power wirelessly (without contact), or with a combination of other charge units.

FIG. 36 illustrates other examples of electronic devices. In FIG. 36, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 36, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 36 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 36 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 36, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 36 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 36 as an example, the secondary battery of one embodiment of the present invention can be used in an air conditioner in which the function of an indoor unit and the function of an outdoor unit are integrated in one housing.

In FIG. 36, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 36. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with the other embodiments.

### Embodiment 6

In this embodiment, examples of vehicles each including the secondary battery of one embodiment of the present invention are described.

The use of secondary batteries in vehicles enables production of next-generation clean energy automobiles such as hybrid electric vehicles (HEVs), electric vehicles (EVs), and plug-in hybrid electric vehicles (PHEVs).

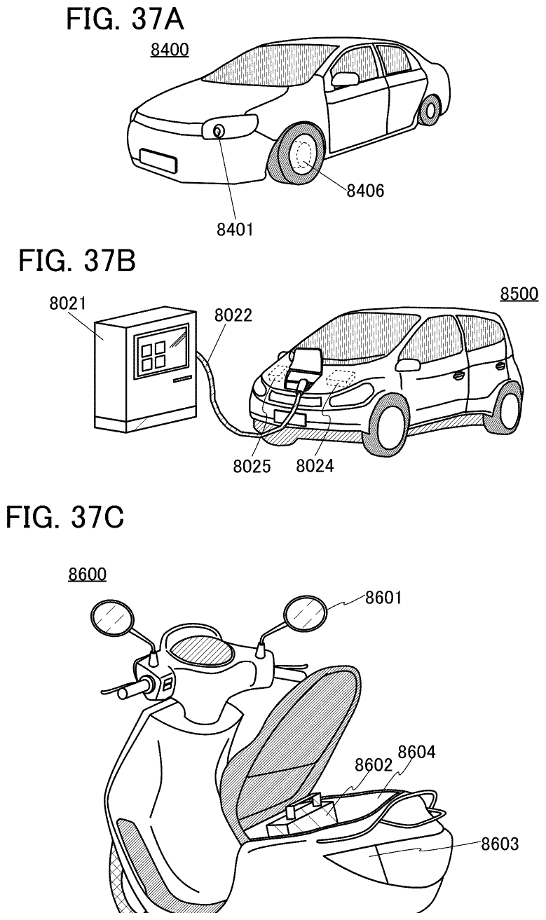

FIG. 37 illustrates examples of a vehicle including the secondary battery of one embodiment of the present invention. An automobile 8400 illustrated in FIG. 37A is an electric vehicle that runs on the power of an electric motor. Alternatively, the automobile 8400 is a hybrid electric vehicle capable of running on the power of either an electric motor or an engine as appropriate. The use of one embodiment of the present invention allows fabrication of a high-mileage vehicle. The automobile 8400 includes the secondary battery. As the secondary battery, the modules of the secondary batteries illustrated in FIG. 21C and FIG. 21D may be arranged to be used in a floor portion in the automobile. Alternatively, a battery pack in which a plurality of secondary batteries each of which is illustrated in FIG. 24 are combined may be placed in the floor portion in the automobile. The secondary battery is used not only for driving an electric motor 8406, but also for supplying electric power to a light-emitting device such as a headlight 8401 or a room light (not illustrated).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 37B can be charged when the secondary battery included in the automobile 8500 is supplied with electric power through external charge equipment by a plug-in system, a contactless power feeding system, or the like. FIG. 37B illustrates a state where a secondary battery 8024 included in the automobile 8500 is charged with the use of a ground-based charge apparatus 8021 through a cable 8022. In charge, a given method such as CHAdeMO (registered trademark) or Combined Charging System may be employed as a charging method, the standard of a connector, or the like as appropriate. The charge apparatus 8021 may be a charge station provided in a commerce facility or a power source in a house. For example, with the use of a plug-in technique, the secondary battery 8024 and a secondary battery 8025 included in the automobile 8500 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 37C shows an example of a motorcycle including the secondary battery of one embodiment of the present invention. A motor scooter 8600 illustrated in FIG. 37C includes a secondary battery 8602, side mirrors 8601, and direction indicators 8603. The secondary battery 8602 can supply electric power to the direction indicators 8603.

In the motor scooter 8600 illustrated in FIG. 37C, the secondary battery 8602 can be held in a storage unit under seat 8604. The secondary battery 8602 can be held in the storage unit under seat 8604 even when the storage unit under seat 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In this case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with any of the other embodiments.

### Example

In this example, lithium cobalt oxides (a sample A1 to a sample A6) were formed as positive electrode active materials of embodiments of the present invention, and ESR analysis was performed thereon. Here, the addition amounts of magnesium, nickel, and aluminum were different among the sample A1 to the sample A6. As a comparative example, a commercial lithium cobalt oxide (a sample B) was used. Furthermore, secondary batteries using these lithium cobalt oxides were fabricated, and the cycle performance in high-voltage charge was evaluated.

Table 4 lists the addition amounts of magnesium, nickel, and aluminum of the sample A1 to the sample A6 and the sample B.

Note that in this specification and the like, the addition amount of magnesium means the ratio of the number of magnesium atoms contained in a magnesium source to the number of cobalt atoms in a starting material. The addition amount of nickel means the ratio of the number of nickel atoms contained in a nickel source to the number of cobalt atoms in a starting material. The addition amount of aluminum means the ratio of the number of aluminum atoms contained in an aluminum source to the number of cobalt atoms in a starting material. In this example, a starting material means lithium cobalt oxide (LiCoO₂) that was used as a composite oxide containing a transition metal (see Step S21 in FIG. 12, Step S21 in FIG. 13, and Step S21 in FIG. 14).

TABLE 4

| | Addition amount [atomic %] | | |
|---|---|---|---|
| | Mg | Ni | Al |
| sample A1 | 0.50 | 0.50 | 0.50 |
| sample A2 | 1.0 | 0.25 | 0.25 |
| sample A3 | 1.0 | 0.50 | 0.50 |
| sample A4 | 1.0 | 1.0 | 0.50 |
| sample A5 | 1.5 | 0.50 | 0.50 |
| sample A6 | 2.0 | 0.50 | 0.50 |
| sample B | — | — | — |

### <Formation Method of Positive Electrode Active Material>

### [Sample A1 to Sample A6]

The sample A1 to the sample A6 were formed according to the flowchart in FIG. 14.

First, in Step S11, a lithium source, a magnesium source, a halogen source, and the first solvent were weighed. Lithium fluoride (LiF) was used as the lithium source and magnesium fluoride (MgF₂) was used as the magnesium source. Each of lithium fluoride (LiF) and magnesium fluoride (MgF₂) also serves as a halogen source. Weighing was performed so that the molar ratio of LiF to MgF₂ was LiF: MgF₂=1:3. As the first solvent, acetone was used.

Next, in Step S12, the lithium fluoride, the magnesium fluoride, and the acetone were mixed and ground. The mixing and grinding were performed in a ball mill using a zirconia ball at a rotation frequency of 400 rpm for 12 hours.

Next, in Step S13 and Step S14, the material after the mixing and grinding was collected to give the mixture 901.

Next, in Step S21, a composite oxide containing lithium and a transition metal was weighed. As the composite oxide containing lithium and the transition metal, CELLSEED C-10N manufactured by NIPPON CHEMICAL INDUSTRIAL CO., LTD., which is lithium cobalt oxide (LiCoO₂), was used. CELLSEED C-10N is lithium cobalt oxide having D50 of approximately 12 pm and few impurities.

For the sample A1, CELLSEED C-10N (LiCoO₂) was weighed to have an amount such that the ratio of the number of Mg atoms of the mixture 902 to the number of cobalt atoms of CELLSEED C-10N was 0.5 atomic %. For each of the sample A2 to the sample A4, CELLSEED C-10N (LiCoO₂) was weighed to have an amount such that the ratio of the number of Mg atoms of the mixture 902 to the number of cobalt atoms of CELLSEED C-10N was 1.0 atomic %. For the sample A5, CELLSEED C-10N (LiCoO₂) was weighed to have an amount such that the ratio of the number of Mg atoms of the mixture 902 to the number of cobalt atoms of CELLSEED C-10N was 1.5 atomic %. For the sample A6, CELLSEED C-10N (LiCoO₂) was weighed to have an amount such that the ratio of the number of Mg atoms of the mixture 902 to the number of cobalt atoms of CELLSEED C-10N was 2.0 atomic %.

Next, in Step S22, the mixture 901 and the composite oxide were mixed and ground. For the mixing, a dry process was used. The mixing was performed in a ball mill using a zirconia ball at a rotation frequency of 150 rpm for 1 hour.

Next, in Step S23 and Step S24, the material after the mixing and grinding was collected to give the mixture 902.

Next, in Step S25, the mixture 902 was annealed. The mixture 902 was put in an alumina crucible and treated at 850° C. using a muffle furnace in an oxygen atmosphere for 60 hours. At the time of the annealing, the alumina crucible was covered with a lid. The flow rate of oxygen was 10 L/min. The temperature was raised at 200° C./hr. After the annealing, the temperature was lowered to room temperature in longer than or equal to 10 hours.

Next, in Step S26 and Step S27, the material after the annealing was collected to give the mixture 903.

Next, in Step S31, a nickel source and the second solvent were weighed. As the nickel source, nickel hydroxide (Ni(OH)₂) was used. As the second solvent, acetone was used.

For each of the sample A1, the sample A3, and the sample A5 to the sample A6, nickel hydroxide was weighed to have an amount such that the ratio of the number of Ni atoms to the number of cobalt atoms of CELLSEED C-10N (LiCoO₂) was 0.5 atomic %. For the sample A2, nickel hydroxide was weighed to have an amount such that the ratio of the number of Ni atoms to the number of cobalt atoms of CELLSEED C-10N (LiCoO₂) was 0.25 atomic %. For the sample A4, nickel hydroxide was weighed to have an amount such that the ratio of the number of Ni atoms to the number of cobalt atoms of CELLSEED C-10N (LiCoO₂) was 1.0 atomic %.

Next, in Step S32, the nickel hydroxide and the acetone were mixed and the nickel hydroxide was ground. The mixing and grinding were performed in a ball mill using a zirconia ball at a rotation frequency of 400 rpm for 12 hours.

Next, in Step S33 and Step S34, the material after the mixing and grinding was collected to give the mixture 904.

Next, in Step S42, the mixture 903 and the mixture 904 were mixed and ground. The mixing and grinding were performed in a ball mill using a zirconia ball at a rotation frequency of 150 rpm for 1 hour.

Next, in Step S43 and Step S44, the material after the mixing and grinding was collected to give the mixture 905.

Next, in Step S51, an aluminum source and the third solvent were weighed. As the aluminum source, aluminum isopropoxide (Al[OCH(CH₃)₂]₃) was used. As the third solvent, isopropanol ((CH₃)₂CHOH) was used.

For each of the sample A1 and the sample A3 to the sample A6, aluminum isopropoxide was weighed to have an amount such that the ratio of the number of aluminum atoms to the number of cobalt atoms of CELLSEED C-10N (LiCoO₂) was 0.5 atomic %. For the sample A2, aluminum isopropoxide was weighed to have an amount such that the ratio of the number of aluminum atoms to the number of cobalt atoms of CELLSEED C-10N (LiCoO₂) was 0.25 atomic %.

Next, in Step S62, the aluminum isopropoxide was dissolved in the isopropanol, followed by mixing the mixture 905. The mixing was performed through stirring by a magnetic stirrer in an air atmosphere. The stirring promoted hydrolysis and a polycondensation reaction between the aluminum isopropoxide in the solution and moisture in the air atmosphere to precipitate aluminum compounds such as aluminum hydroxide and aluminum oxide.

Next, in Step S63 and Step S64, the material after the mixing was collected to give the mixture 906.

Next, in Step S65, the mixture 906 was annealed. The mixture 906 was put in an alumina crucible and treated at 850° C. using a muffle furnace in an oxygen atmosphere for 60 hours. At the time of the annealing, the alumina crucible was covered with a lid. The flow rate of oxygen was 10 L/min. The temperature was raised at 200° C./hr. After the annealing, the temperature was lowered to room temperature in longer than or equal to 10 hours.

Next, in Step S66 and Step S67, the material after the annealing was collected to give the sample A1 to the sample A6 of embodiments of the present invention.

### [Sample B]

Commercial lithium cobalt oxide (CELLSEED C-10N) not subjected to any treatment was used as the sample B (the comparative example).

### <ESR Analysis>

Next, ESR analysis was performed on the sample A1 to the sample A6 and the sample B. In the ESR analysis, a high frequency power (microwave power) of 9.15 GHz was set as 1 mW, and a magnetic field was swept from 0 mT to 800 mT. For the sample A1 to the sample A6, the measurement temperature was set to 300 K (approximately 27° C.), 250 K (approximately −23° C.), 200 K (approximately −73° C.), 150 K (approximately −123° C.), and 113 K (approximately −160° C.). For the sample B, the measurement temperature was set to 300 K (approximately 27° C.), 200 K (approximately −73° C.), and 113 K (approximately −160° C.). The weights of the samples used for the ESR analysis were each approximately 0.005 g. In addition, magnetic field correction and detection sensitivity correction were performed using Mn²⁺ marker. The number of spins was calculated using TEMPOL (4-Hydroxy-2,2,6,6-tetramniethylpiperidine-1-oxyl) as a reference sample.

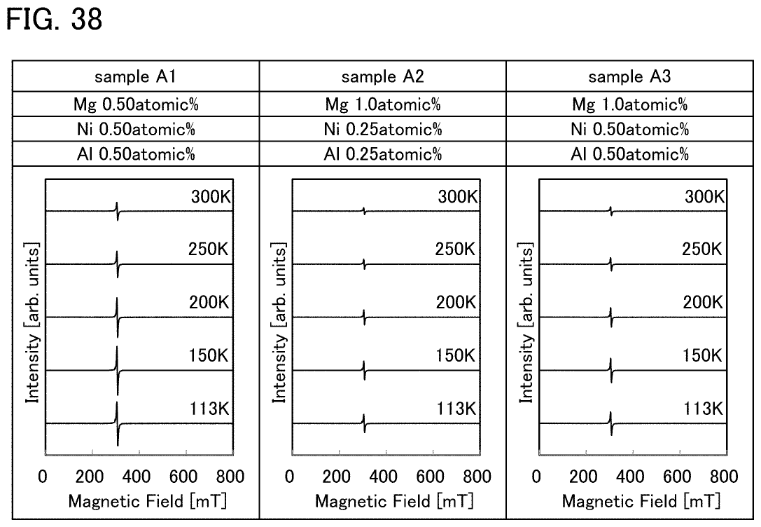

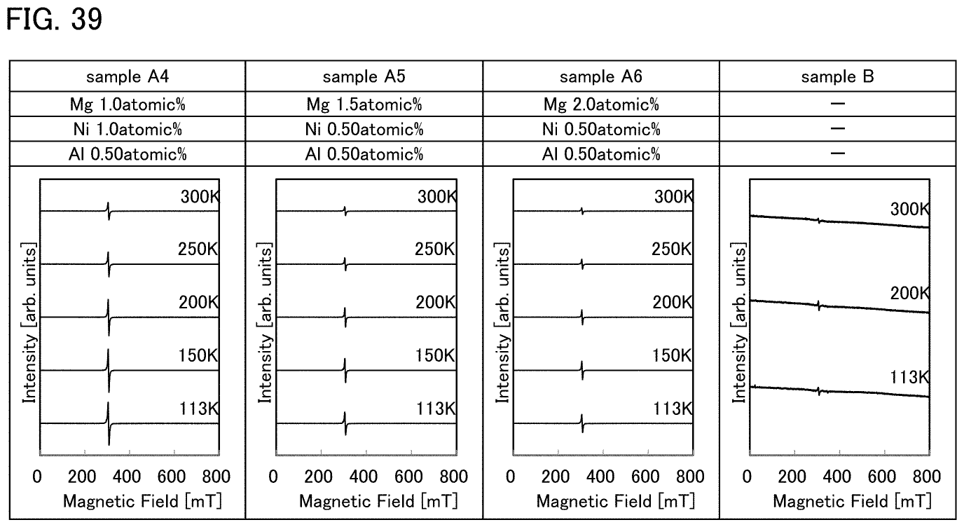

FIG. 38 shows the ESR analysis results of the sample A1 to the sample A3, and FIG. 39 shows the ESR analysis results of the sample A4 to the sample A6 and the sample B. In FIG. 38 and FIG. 39, the horizontal axis represents the magnetic field and the vertical axis represents the intensity of an ESR signal. Note that the signal intensity indicates a first derivative value of the absorption amount of microwaves.

Next, ESR analysis was performed while the magnetic field was swept from 200 mT to 400 mT.

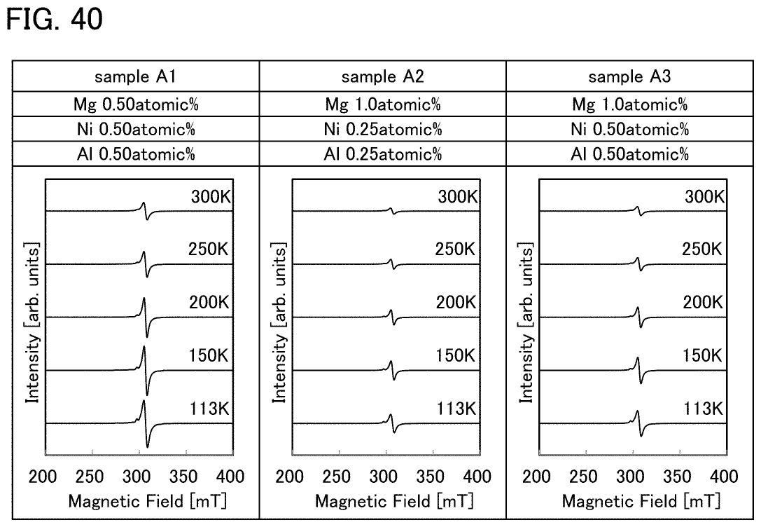

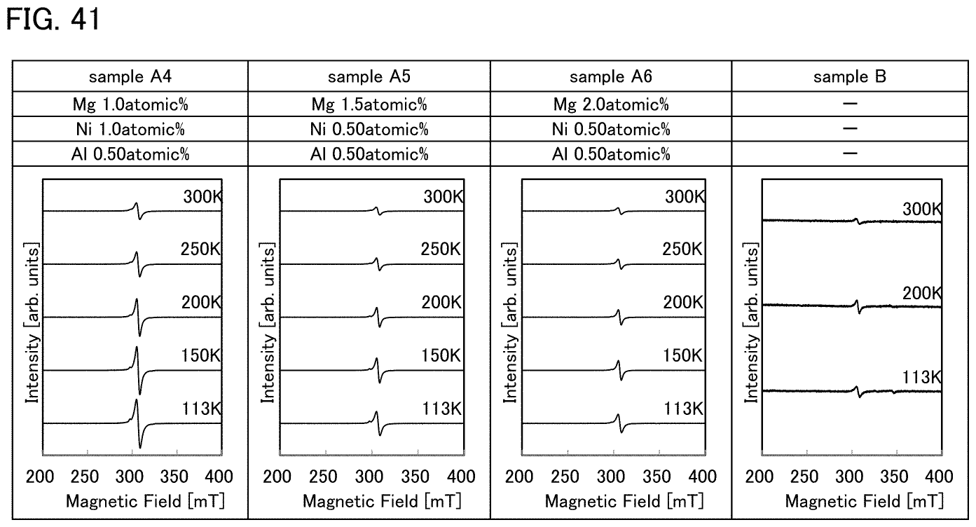

FIG. 40 shows the ESR analysis results of the sample A1 to the sample A3, and FIG. 41 shows the ESR analysis results of the sample A4 to the sample A6 and the sample B. In FIG. 40 and FIG. 41, the horizontal axis represents the magnetic field and the vertical axis represents the intensity of an ESR signal. Note that the signal intensity indicates a first derivative value of the absorption amount of microwaves.

As shown in FIG. 38 to FIG. 41, sharp signals were observed at around 305 mT (g=2.15) in all the samples. The signals at around 305 mT (g=2.15) are attributed to one or more of Ni²⁺, Ni³⁺, Co²⁺, and Co⁴⁺. The line widths ΔHpp of the signals at around 305 mT (g=2.15) were each approximately 4 mT. Here, the line width ΔHpp represents a difference in magnetic field between the maximum signal value and the minimum signal value. Furthermore, no signal at around 130 mT (g=5.1) attributed to Co₃O₄ was observed. It was found that the sample A1 to the sample A6 of embodiments of the present invention each contained no Co₃O₄ or an extremely small amount of Co₃O₄.

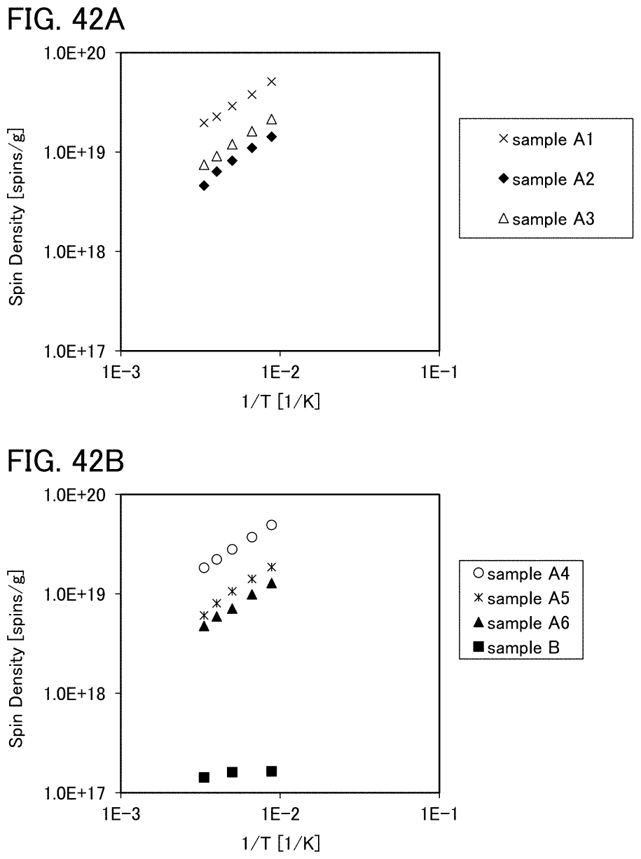

FIG. 42A shows the dependence of spin densities of the sample A1 to the sample A3 on the measurement temperature of the ESR analysis. FIG. 42B shows the dependence of spin densities of the sample A4 to the sample A6 and the sample B on the measurement temperature of the ESR analysis. In FIG. 42A and FIG. 42B, the horizontal axis represents an inverse 1/T of the measurement temperature of the ESR analysis, whereas the vertical axis represents the spin density. Note that the spin density is a value obtained by dividing the number of spins which was obtained in the ESR analysis by the weight of the sample subjected to the ESR analysis.

As shown in FIG. 42A and FIG. 42B, the sample A1 to the sample A6 of embodiments of the present invention were found to have a higher spin density at a lower measurement temperature of the ESR analysis and to show paramagnetism, in accordance with the Curie-Weiss law. In contrast, the sample B as the comparative example was found to have small dependence of the spin density on the measurement temperature and to show different behavior from paramagnetism.

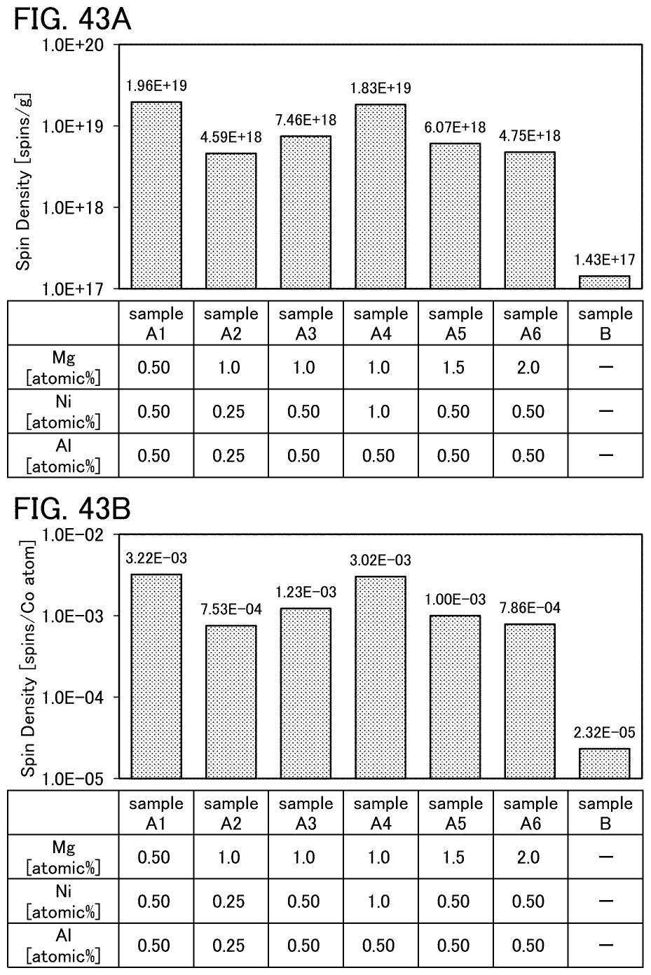

FIG. 43A shows the number of spins calculated from the signal intensity at around 305 mT (g=2.15) at 300 K (approximately 27° C.). In FIG. 43A, the horizontal axis represents the addition amount of magnesium, the addition amount of nickel, and the addition amount of aluminum in each sample, whereas the vertical axis represents the spin density. Note that the spin density is a value obtained by dividing the number of spins which was obtained in the ESR analysis by the weight of the sample subjected to the ESR analysis.

As shown in FIG. 43, in the sample B in which none of magnesium, nickel, and aluminum was added, the spin density attributed to one or more of Ni²⁺, Ni³⁺, Co²⁺, and Co⁴⁺ per weight of the positive electrode active material was 1.43×10¹⁷ spins/g. In contrast, the spin densities of the sample A1 to the sample A6 in which magnesium, nickel, and aluminum were added were greater than or equal to 2.0×10¹⁷ spins/g. It was found that when magnesium, nickel, and aluminum are added, the spin density attributed to one or more of Ni²⁺, Ni³⁺, Co²⁺, and Co⁴⁺ becomes greater than or equal to 2.0×10¹⁷ spins/g.

FIG. 43B shows the number of spins calculated from the signal intensity at around 305 mT (g=2.15) at 300 K (approximately 27° C.). In FIG. 43B, the horizontal axis represents the addition amount of magnesium, the addition amount of nickel, and the addition amount of aluminum in each sample, whereas the vertical axis represents the spin density. Note that the spin density is a value obtained in the following manner: on the assumption that the composition of each sample was LiCoO₂, the number of cobalt atoms in the sample subjected to the ESR analysis was calculated from a molecular weight of 97.87 of LiCoO₂, and then the number of spins was divided by the number of cobalt atoms.

As shown in FIG. 43B, in the sample B in which none of magnesium, nickel, and aluminum was added, the spin density attributed to one or more of Ni²⁺, Ni³⁺, Co²⁺, and Co⁴⁺ per weight of the positive electrode active material was 2.32×10⁻⁵ spins/Co atom. In contrast, the spin densities of the sample A1 to the sample A6 in which magnesium, nickel, and aluminum were added were greater than or equal to 3.5×10⁻⁵ spins/Co atom. It was found that when magnesium, nickel, and aluminum are added, the spin density attributed to one or more of Ni²⁺, Ni³⁺, Co²⁺, and Co⁴⁺ becomes greater than or equal to 3.5×10⁻⁵ spins/Co atom.

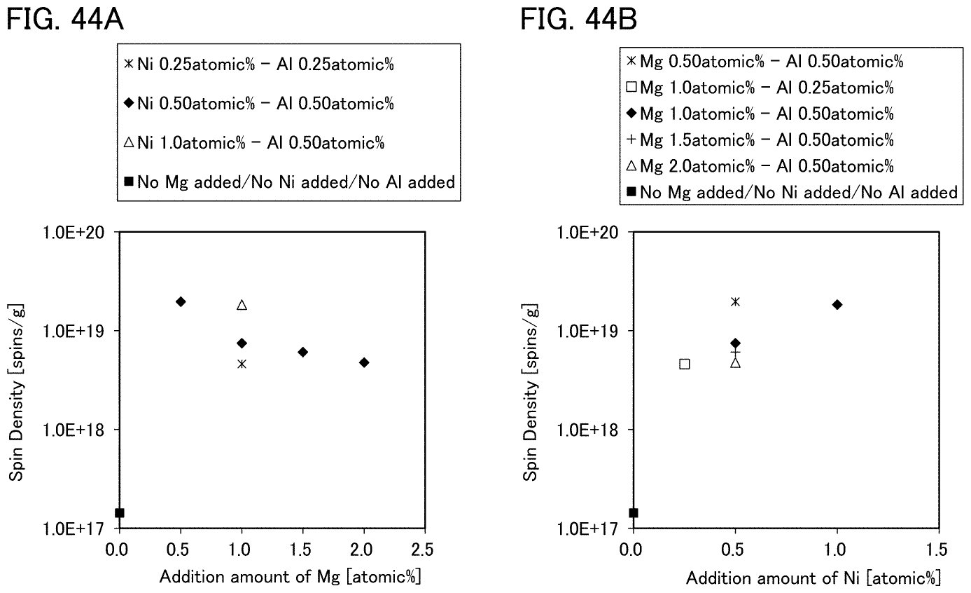

FIG. 44A shows the dependence of the spin density on the addition amount of magnesium. In FIG. 44A, the horizontal axis represents the addition amount of magnesium, whereas the vertical axis represents (Spin Density). FIG. 44B shows the dependence of the spin density on the addition amount of nickel. In FIG. 44B, the horizontal axis represents the addition amount of nickel, whereas the vertical axis represents (Spin Density).

As shown in FIG. 44A, it was confirmed that a larger addition amount of magnesium tends to result in a lower spin density. In contrast, as shown in FIG. 44B, it was confirmed that a larger addition amount of nickel tends to result in a higher spin density. It can be deemed that nickel was substituted for the constituent element (e.g., cobalt) of the lithium cobalt oxide without damaging the crystal structure of the lithium cobalt oxide and accordingly the spin density attributed to one or more of Ni²⁺ and Ni³⁺ increased. It can also be deemed that a large addition amount of magnesium increased the amount of magnesium existing at the surface of the positive electrode active material particle, and reaction between the magnesium and nickel prevented nickel from being added into the positive electrode active material and accordingly decreased the spin density.

Next, secondary batteries were fabricated using the sample A1 to the sample A5 and the sample B and the cycle performance was evaluated.

### <Fabrication Method of Secondary Battery>

Positive electrodes were fabricated using the sample A1 to the sample A5 and the sample B as the positive electrode materials.

### <Cycle Performance>

Then, the cycle performance of the sample A1 to the sample A4 was evaluated at room temperature (25° C.). The loaded amount of the positive electrode was set to 7 mg/cm² and the upper limit voltage in charge was set to 4.6 V. Note that two secondary batteries were fabricated using each of the sample A1 to the sample A5 and the sample B.

The CCCV charge (at a rate of 0.5 C, 4.6 V, a termination current of 0.05 C) and the CC discharge (0.5 C, 3.0 V) were repeatedly performed at 25° C., and then the cycle performance was evaluated.

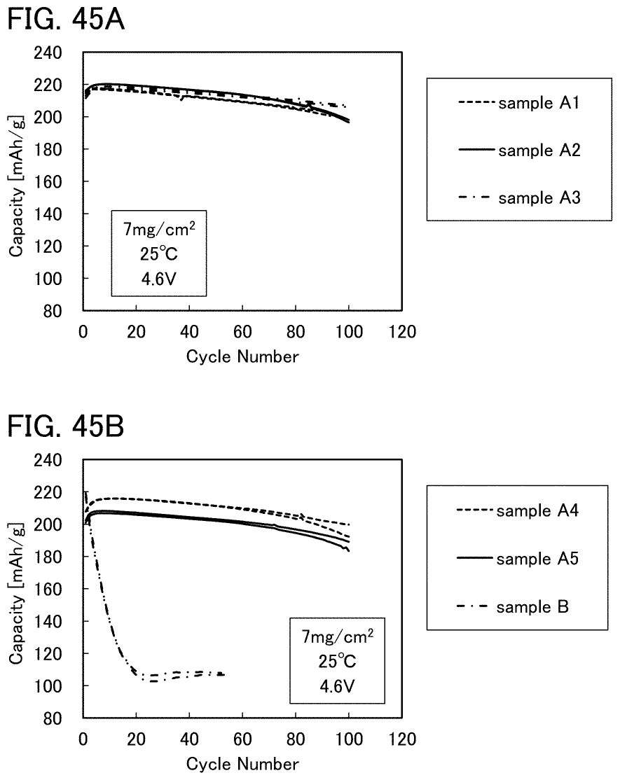

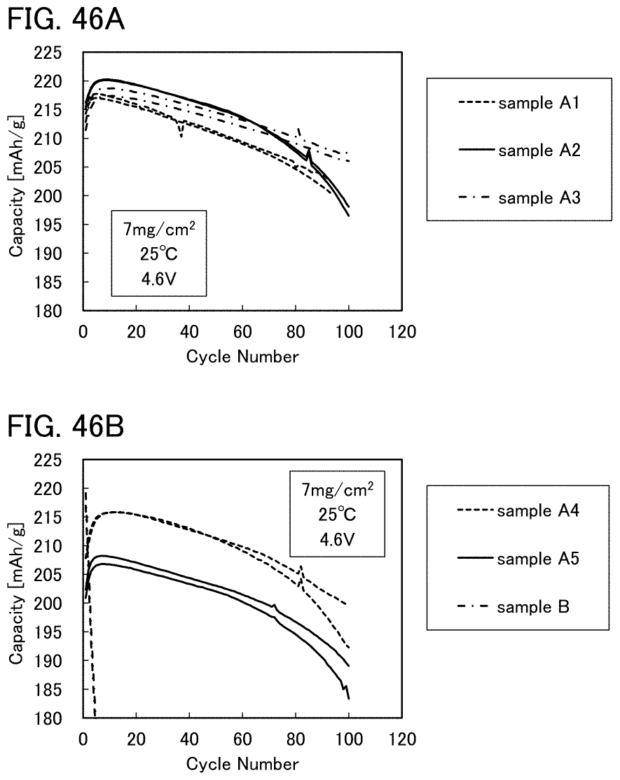

FIG. 45A shows the cycle performance of the sample A1 to the sample A3 and FIG. 45B shows that of the sample A4, the sample A5, and the sample B. FIG. 46A shows an enlarged view of FIG. 45A and FIG. 46B shows that of FIG. 45B. In FIG. 45A to FIG. 46B, the horizontal axis represents the cycle number and the vertical axis represents the capacity at the time of discharge.

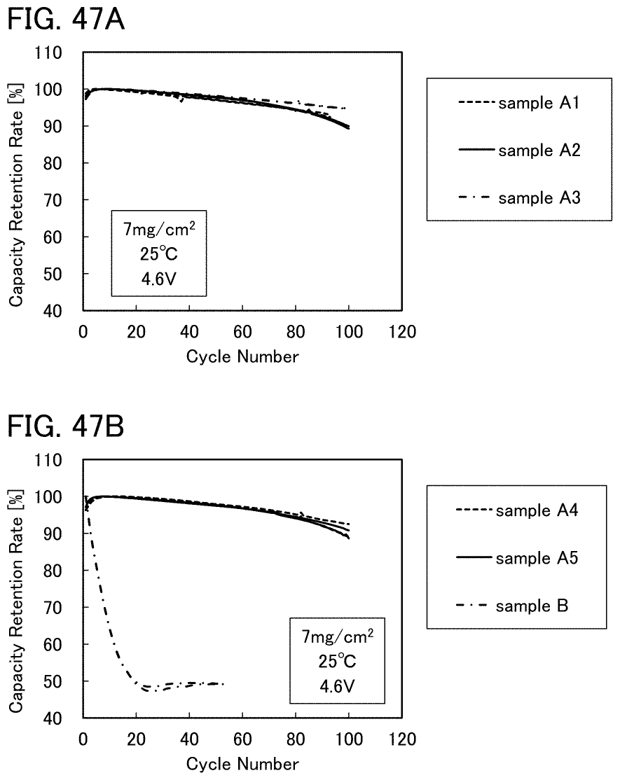

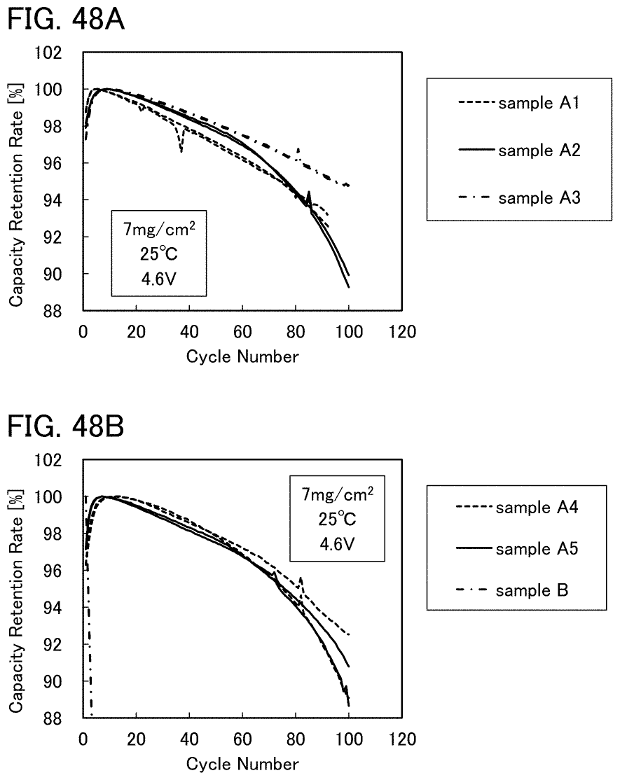

FIG. 47A shows the cycle performance of the sample A1 to the sample A3 and FIG. 47B shows that of the sample A4, the sample A5, and the sample B. FIG. 48A shows an enlarged view of FIG. 47A and FIG. 48B shows that of FIG. 47B. In FIG. 47A to FIG. 48B, the horizontal axis represents the cycle number and the vertical axis represents the capacity retention rate at the time of discharge. The capacity retention rate at the time of discharge is a percentage of a capacity in each cycle to the maximum capacity value at the time of discharge.

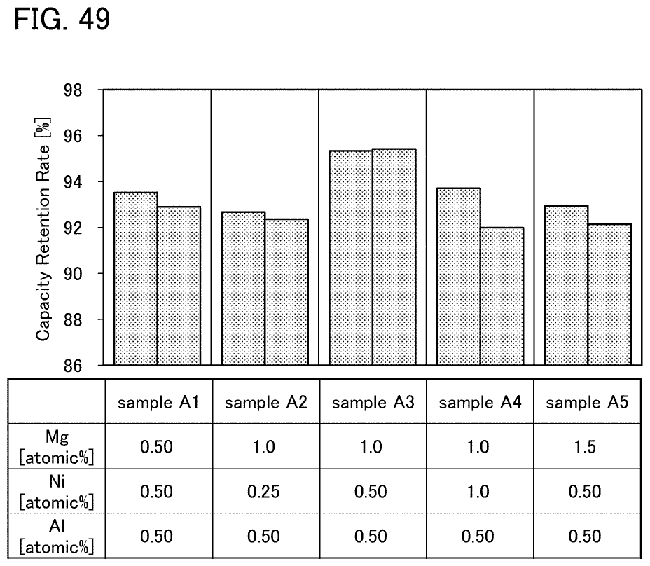

FIG. 49 shows the capacity retention rate of the sample A1 to the sample A5. In FIG. 49, the horizontal axis represents the addition amount of magnesium, the addition amount of nickel, and the addition amount of aluminum in each sample, the vertical axis represents the capacity retention rate at the time of discharge. The capacity retention rate at the time of discharge is a percentage of a capacity in the 90th cycle to the maximum capacity value at the time of discharge.

As shown in FIG. 45A to FIG. 49, the sample A1 to the sample A5 in which magnesium was added were found to have more favorable cycle performance than the sample B in which none of magnesium, nickel, and aluminum was added. In particular, the sample A1 to the sample A4 were found to have high capacity and excellent cycle performance.

### REFERENCE NUMERALS

100: positive electrode active material, 200: active material layer, 201: graphene compound, 211a: positive electrode, 211b: negative electrode, 212a: lead, 212b: lead, 214: separator, 215a: bonding portion, 215b: bonding portion, 217: fixing member, 250: secondary battery, 251: exterior body, 261: portion, 262: seal portion, 263: seal portion, 271: ridge, 272: crest line, 273: space, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 440: substrate, 441: wiring electrode, 442: wiring electrode, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 510: positive electrode lead electrode, 511: negative electrode lead electrode, 521: plate, 524: plate, 525a: fixation tool, 525b: fixation tool, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module, 616: wiring, 617: temperature control device, 750a: positive electrode, 750b: solid electrolyte layer, 750c: negative electrode, 751: electrode plate, 752: insulating tube, 753: electrode plate, 761: lower component, 762: upper component, 764: butterfly nut, 765: O ring, 766: insulator, 770a: package component, 770b: package component, 770c: package component, 771: external electrode, 772: external electrode, 773a: electrode layer, 773b: electrode layer, 900: circuit board, 901: mixture, 902: mixture, 903: mixture, 904: mixture, 905: mixture, 906: mixture, 907: mixture, 910: label, 911: terminal, 912: circuit, 913: secondary battery, 914: antenna, 915: seal, 916: layer, 917: layer, 918: antenna, 920: display device, 921: sensor, 922: terminal, 930: housing, 930a: housing, 930b: housing, 931: negative electrode, 932: positive electrode, 933: separator, 950: wound body, 951: terminal, 952: terminal, 980: secondary battery, 981: film, 982: film, 993: wound body, 994: negative electrode, 995: positive electrode, 996: separator, 997: lead electrode, 998: lead electrode, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8000: display device, 8001: housing, 8002: display portion, 8003: speaker portion, 8004: secondary battery, 8021: charge apparatus, 8022: cable, 8024: secondary battery, 8025: secondary battery, 8100: lighting device, 8101: housing, 8102: light source, 8103: secondary battery, 8104: ceiling, 8105: side wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: door for refrigerator, 8303: door for freezer, 8304: secondary battery, 8400: automobile, 8401: headlight, 8406: electric motor, 8500: automobile, 8600: motor scooter, 8601: side mirror, 8602: secondary battery, 8603: direction indicator, 8604: storage unit under seat, 9600: tablet terminal, 9625: switch, 9627: switch, 9628: operation switch, 9629: fastener, 9630: housing, 9630a: housing, 9630b: housing, 9631: display portion, 9631a: display portion, 9631b: display portion, 9633: solar cell, 9634: charge and discharge control circuit, 9635: power storage unit, 9636: DCDC converter, 9637: converter, 9640: movable portion

1. A positive electrode active material comprising lithium, cobalt, nickel, aluminum, and oxygen,
wherein a spin density attributed to one or more of a divalent nickel ion, a trivalent nickel ion, a divalent cobalt ion, and a tetravalent cobalt ion is greater than or equal to 2.0×10¹⁷ spins/g and less than or equal to 1.0×10²¹ spins/g.

2. The positive electrode active material according to claim 1,
wherein a concentration of the nickel with respect to the number of atoms of the cobalt is greater than or equal to 0.01 atomic % and less than or equal to 10 atomic %.

3. The positive electrode active material according to claim 1,
wherein a concentration of the aluminum with respect to the number of atoms of the cobalt is greater than or equal to 0.01 atomic % and less than or equal to 10 atomic %.

4. The positive electrode active material according to claim 1, further comprising magnesium,
wherein a concentration of the magnesium with respect to the number of atoms of the cobalt is greater than or equal to 0.1 atomic % and less than or equal to 6.0 atomic %.

5. The positive electrode active material according to claim 1, further comprising fluorine.

6. The positive electrode active material according to claim 1,
wherein a lattice constant of an a-axis is greater than or equal to 2.8155×10⁻¹⁰ m and less than or equal to 2.8175×10⁻¹⁰ m, and
wherein a lattice constant of a c-axis is greater than or equal to 14.045×10⁻¹⁰ m and less than or equal to 14.065×10⁻¹⁰ m.

7. A secondary battery comprising:
a positive electrode comprising the positive electrode active material according to claim 1, and
a negative electrode.
